(19) United States
(12) Patent Application Publication
(10) Pub. No.: US 2025/0202654 A1
(43) Pub. Date: Jun. 19, 2025

(54) METHOD AND APPARATUS FOR TRANSMITTING/RECEIVING UPLINK REFERENCE SIGNAL IN WIRELESS COMMUNICATION SYSTEM

(71) Applicant: Samsung Electronics Co., Ltd., Suwon-si (KR)

(72) Inventors: Youngrok JANG, Suwon-si (KR); Ameha Tsegaye ABEBE, Suwon-si (KR); Seongmok LIM, Suwon-si (KR); Hyoungju JI, Suwon-si (KR); Kyungjun CHOI, Suwon-si (KR)

(21) Appl. No.: 18/968,647

(22) Filed: Dec. 4, 2024

(30) Foreign Application Priority Data
Dec. 19, 2023 (KR) 10-2023-0186237
Feb. 16, 2024 (KR) 10-2024-0022732
Apr. 16, 2024 (KR) 10-2024-0050960

(51) Int. Cl. H04L 5/00; H04B 7/06; H04W 72/231

(52) U.S. Cl. CPC H04L 5/0051; H04B 7/063; H04B 7/0639; H04W 72/231

(57) ABSTRACT

A method performed by a terminal in a wireless communication system is provided. The method includes receiving, from a base station, configuration information related to a sounding reference signal (SRS) transmission related to a codebook-based uplink transmission, the configuration information including an SRS resource set comprising an SRS resource configured by four ports, and transmitting, to the base station, an SRS by using three ports on the SRS resource, wherein the SRS transmission is not be performed with regard to a port having the largest port index among the four ports configuring the SRS resource.

### CROSS-REFERENCE TO RELATED APPLICATION(S)

This application is based on and claims priority under 35 U.S.C. § 119 (a) of a Korean patent application number 10-2023-0186237, filed on Dec. 19, 2023, in the Korean Intellectual Property Office, of a Korean patent application number 10-2024-0022732, filed on Feb. 16, 2024, in the Korean Intellectual Property Office, and of a Korean patent application number 10-2024-0050960, filed on Apr. 16, 2024, in the Korean Intellectual Property Office, the disclosure of each of which is incorporated by reference herein in its entirety.

### BACKGROUND

### 1. Field

The disclosure relates to operations of a user equipment (UE) and a base station in a wireless communication system. More particularly, the disclosure relates to a method for transmitting/receiving an uplink reference signal in a wireless communication system, and an apparatus capable of performing the same.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter-wave (mmWave) including 28 GHz and 39 GHZ. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, Layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method capable of effectively providing services in a wireless communication system.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving, from a base station, configuration information related to a sounding reference signal (SRS) transmission related to a codebook-based uplink transmission, the configuration information including an SRS resource set including an SRS resource configured by four ports, and transmitting, to the base station, an SRS by using three ports on the SRS resource, wherein the SRS transmission is not be performed with regard to a port having the largest port index among the four ports configuring the SRS resource.

In accordance with another aspect of the disclosure, a method performed by a base station in a wireless communication system is provided. The method includes transmitting, to a terminal, configuration information related to a sounding reference signal (SRS) transmission related to a codebook-based uplink transmission, the configuration information including an SRS resource set including an SRS resource configured by four ports, and receiving, from the terminal, an SRS by using three ports on the SRS resource, wherein the SRS reception is not be performed with regard to a port having the largest port index among the four ports configuring the SRS resource.

In accordance with another aspect of the disclosure, a terminal in a wireless communication system is provided. The terminal includes a transceiver, and a controller coupled to the transceiver, wherein the controller is configured to receive, from a base station, configuration information related to a sounding reference signal (SRS) transmission related to a codebook-based uplink transmission, the configuration information including an SRS resource set including an SRS resource configured by four ports, and transmit, to the base station, an SRS by using three ports on the SRS resource, and wherein the SRS transmission is not be performed with regard to a port having the largest port index among the four ports configuring the SRS resource.

In accordance with another aspect of the disclosure, a base station in a wireless communication system is provided. The base station includes a transceiver, and a controller coupled to the transceiver, wherein the controller is configured to transmit, to a terminal, configuration information related to a sounding reference signal (SRS) transmission related to a codebook-based uplink transmission, the configuration information including an SRS resource set including an SRS resource configured by four ports, and receive, from the terminal, an SRS by using three ports on the SRS resource, wherein the SRS reception is not be performed with regard to a port having the largest port index among the four ports configuring the SRS resource.

A device and a method capable of effectively providing services in a wireless communication system are provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of a bandwidth part configuration in a wireless communication system according to an embodiment of the disclosure;

FIG. 4 illustrates an example of base station beam allocation according to a transmission configuration indication (TCI) state configuration in a wireless communication system according to an embodiment of the disclosure;

FIG. 5 illustrates a beam application time which may be considered in a case where a unified TCI scheme is used in a wireless communication system according to an embodiment of the disclosure;

FIG. 6 illustrates another medium access control (MAC)-control element (CE) structure for activation and indication of a joint TCI state or a separate downlink (DL) or uplink (UL) TCI state in a wireless communication system according to an embodiment of the disclosure;

FIG. 7 illustrates an example of a control resource set configuration of a downlink control channel in a wireless communication system according to an embodiment of the disclosure;

FIG. 8 illustrates a structure of a downlink control channel in a wireless communication system according to an embodiment of the disclosure;

FIG. 9 illustrates an example of physical uplink shared channel (PUSCH) repetition type B transmission in a wireless communication system according to an embodiment of the disclosure;

FIG. 10 illustrates a method for determining an available slot during PUSCH repetition type A transmission of a UE in a 5G system according to an embodiment of the disclosure;

FIG. 11 illustrates a method for allocating a comb offset and a cyclic shift during SRS transmission according to an embodiment of the disclosure;

FIG. 12 illustrates an SRS antenna switching operation according to an embodiment of the disclosure;

FIG. 13 illustrates operations of a UE according to an embodiment of the disclosure;

FIG. 14 illustrates operations of a base station according to an embodiment of the disclosure;

FIG. 15 illustrates a structure of a UE in a wireless communication system according to an embodiment of the disclosure; and

FIG. 16 illustrates a structure of a base station in a wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the accompanying drawings, some elements may be exaggerated, omitted, or schematically illustrated. Furthermore, the size of each element does not completely reflect the actual size. Throughout the specification, the same or like reference signs indicate the same or like elements.

The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include at least one of a user equipment (UE), a mobile station (MS), a cellular phone, a smartphone, a computer, or a multimedia system capable of performing a communication function. In the disclosure, a “downlink (DL)” may refer to a radio link via which a base station transmits a signal to a terminal, and an “uplink (UL)” may refer to a radio link via which a terminal transmits a signal to a base station. Furthermore, in the following description, long term evolution (LTE) or LTE-advanced (LTE-A) systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

It will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in the disclosure may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

According to an embodiment, as a typical example of the broadband wireless communication system, an LTE system employs an orthogonal frequency division multiplexing (OFDM) scheme in a downlink (DL). In an uplink (UL), a single carrier frequency division multiple access (SC-FDMA) scheme may be employed. The uplink may refer to a radio link via which a user equipment (UE) or a mobile station (MS) transmits data or control signals to a base station (BS) or eNode B, and the downlink may refer to a radio link via which the base station transmits data or control signals to the UE. The multiple access scheme may separate data or control information of respective users by allocating and operating time-frequency resources for transmitting the data or control information for each user so as to avoid overlapping each other, that is, so as to establish orthogonality.

According to an embodiment, since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to an embodiment, e MBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, various transmission/reception technologies including a further enhanced multiple-input multiple-output (MIMO) transmission technique may be required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

According to an embodiment, the three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, the term “a/b” may be understood as at least one of a and b.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

### [NR Time-Frequency Resources]

Hereinafter, a frame structure of a 5G system will be described in more detail with reference to the accompanying drawings.

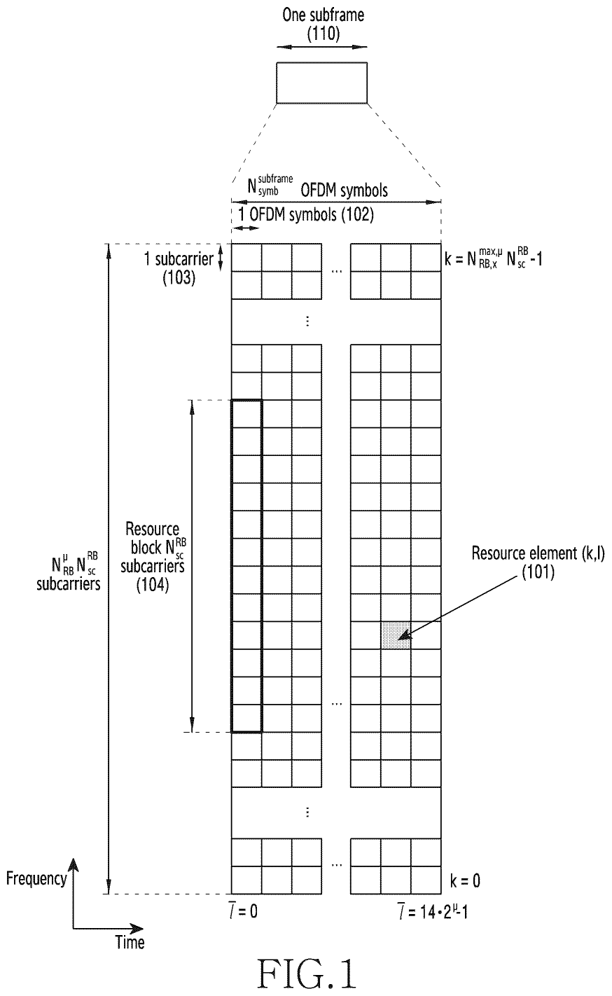

FIG. 1 illustrates a basic structure of a time-frequency domain, which is a radio resource domain used to transmit data or control channels, in a 5G system according to an embodiment of the disclosure.

Referring to FIG. 1, the horizontal axis in FIG. 1 represents a time domain, and the vertical axis in FIG. 1 represents a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (for example, 12) consecutive REs may constitute one resource block (RB) 104. In the time domain, one subframe 110 may include multiple OFDM symbols 102. For example, the length of one subframe may be 1 ms.

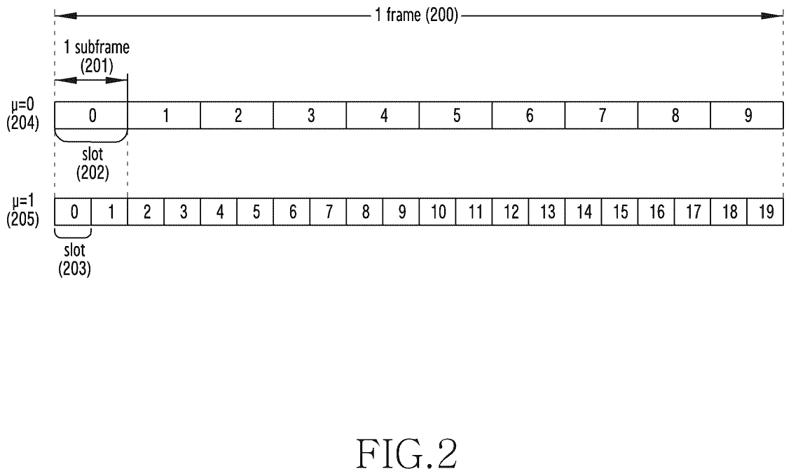

FIG. 2 illustrates a structure of a frame, a subframe, and a slot in a wireless communication system according to an embodiment of the disclosure.

Referring to FIG. 2, FIG. 2 illustrates an example of a structure of a frame 200, a subframe 201, and a slot 202. One frame 200 may be defined as 10 ms. One subframe 201 may be defined as 1 ms, and thus one frame 200 may include a total of ten subframes 201.

According to an embodiment, one slot 202 or 203 may be defined as 14 OFDM symbols. For example, N_{symb}^{slot}=14 slot may refer to the number of symbols per one slot. One subframe 201 may include one or multiple slots 202 and 203, and the number of slots 202 and 203 per one subframe 201 may vary depending on configuration values μ 204 or 205 for the subcarrier spacing.

The example of FIG. 2 shows the case of μ=0 (204) and the case of μ=1 (205) as a configuration value for a subcarrier spacing. In the case of μ=0 (204), one subframe 201 may include one slot 202, and in the case of μ=1 (205), one subframe 201 may include two slots 203. That is, the number of slots per one subframe Nₛₗₒₜ^{subframe,μ} may differ depending on the subcarrier spacing configuration value μ, and the number of slots per one frame Nₛₗₒₜ^{frame,μ} may differ accordingly. Nₛₗₒₜ^{subframe,μ} and Nₛₗₒₜ^{frame,μ} may be defined according to each subcarrier spacing configuration μ as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Hereinafter, a bandwidth part (BWP) configuration in a 5G communication system will be described in detail with reference to the drawings.

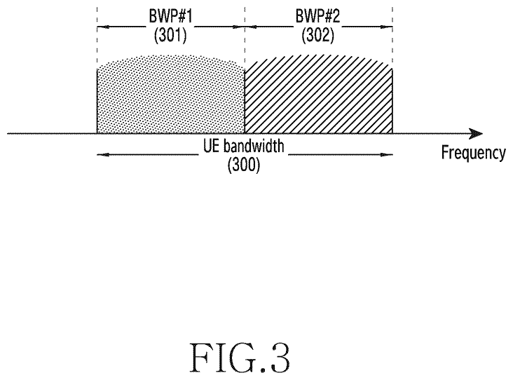

FIG. 3 illustrates an example of a bandwidth part configuration in a wireless communication system according to an embodiment of the disclosure.

Referring to FIG. 3, FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given in Table 2 below.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4 |

, n5},
(subcarrier spacing)

| | |
|---|---|
| cyclicPrefix | ENUMERATED { extended } |

(cyclic prefix)
}

The information configured for the UE is not limited to the above example, and in addition to the configuration information in Table 2, various parameters related to the bandwidth part may be configured for the UE. The base station may transfer the configuration information to the UE through upper layer signaling (for example, radio resource control (RRC) signaling). At least one of the one or more bandwidth parts configured for the UE may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). For example, the UE may receive configuration information regarding a control resource set (CORESET) and a search space which may be used to transmit a physical downlink control channel (PDCCH) for receiving system information which may correspond to remaining system information (RMSI) or system information block 1 (SIB1) necessary for initial access through the MIB in the initial access step.

According to an embodiment, each of the control resource set and the search space configured through the MIB may be considered identity (ID) 0 or identified thereby. The base station may notify the UE of configuration information, such as frequency allocation information, time allocation information, and/or numerology, regarding control resource set #0 through the MIB. In addition, the base station may notify the UE of configuration information regarding the monitoring cycle and occasion with regard to control resource set #0, that is, configuration information regarding search space #0, through the MIB. The UE may identify or consider a frequency domain configured by control resource set #0 acquired from the MIB as an initial bandwidth part for initial access. The ID of the initial bandwidth part may be considered to be 0.

According to an embodiment, the bandwidth part-related configuration supported by 5G may be used for various purposes.

According to an embodiment, if the bandwidth supported by the UE is smaller than the system bandwidth, the base station may support data communication of the UE through the bandwidth part configuration. For example, the base station may configure the frequency location of the bandwidth part (configuration information 2) for the UE, so that the UE can transmit/receive data at a specific frequency location (for example, a configured frequency location) within the system bandwidth.

According to an embodiment, the base station may configure multiple bandwidth parts for the UE for the purpose of supporting different numerologies. For example, in order to support a designated UE's data transmission/reception using both a subcarrier spacing of 15 kHz and a subcarrier spacing of 30 kHz, the base station may configure, for the designated UE, two bandwidth parts as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

According to an embodiment, the base station may configure bandwidth parts having different sizes of bandwidths for the UE for the purpose of reducing power consumed by the UE. For example, if the UE supports a substantially large bandwidth (for example, 100 MHZ) and always transmits/receives data with the supported bandwidth, a substantially large amount of power consumption may occur. Particularly, it may be substantially inefficient from the viewpoint of power consumption to unnecessarily monitor the downlink control channel with a large bandwidth of 100 MHZ in the absence of traffic. In order to reduce power consumed by the UE, the base station may configure a bandwidth part of a relatively small bandwidth (for example, a bandwidth part of 20 MHZ) for the UE. The UE may perform a monitoring operation in the 20 MHz bandwidth part in the absence of traffic, and may transmit/receive data with the 100 MHz bandwidth part as indicated by the base station if data has occurred.

According to an embodiment, in connection with the bandwidth part configuring method, UEs, before RRC-connected, may receive configuration information regarding the initial bandwidth part (initial BWP) through an MIB in the initial access step. For example, a UE may have a control resource set (i.e., CORESET) configured for a downlink control channel which may be used to transmit DCI for scheduling a system information block (SIB) from the MIB of a physical broadcast channel (PBCH). The bandwidth of the control resource set configured by the MIB may be considered the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, and/or random access.

According to an embodiment, if one or more bandwidth parts are configured for the UE, the base station may indicate, to the UE, to change (or switch or transition) the bandwidth parts by using a bandwidth part indicator field inside DCI. For example, if the currently activated bandwidth part of the UE is bandwidth part #1 301 in FIG. 3, the base station may indicate bandwidth part #2 302 with a bandwidth part indicator inside DCI, and the UE may change (or switch) the bandwidth part to bandwidth part #2 302 indicated by the bandwidth part indicator inside the received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined as given in Table 3 below, for example.

TABLE 3

| | |
|---|---|
| | BWP switch delay |
| NR Slot | T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the larger one between the SCS before BWP switch and the SCS after BWP switch.

According to an embodiment, the requirements for the bandwidth part change delay time may support type 1 or type 2, depending on the capability of the UE. The UE may report the supportable bandwidth part change delay time type to the base station. For example, the bandwidth part delay time may differ depending on the capability of the UE, and the UE may report the bandwidth part change delay time type, determined based on the capability of the UE, to the base station. The bandwidth part change delay time type may indicate a bandwidth part change delay time.

According to an embodiment, if the UE has received DCI including a bandwidth part change indicator in slot n, according to (or based on) the requirement for the bandwidth part change delay time, the UE may complete a change to the new bandwidth part indicated by the bandwidth part change indicator at a timepoint not later than slot n+T_{BWP}. and the UE may transmit and/or receive a data channel scheduled by the corresponding DCI in the changed new bandwidth part.

According to an embodiment, if the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel at a timepoint after the bandwidth part change delay time, in connection with the determination of time domain resource allocation regarding the data channel. Accordingly, the UE may not expect that the DCI indicating a bandwidth part change will indicate a slot offset (K0 or K2) value smaller than the bandwidth part change delay time (T_{BWP}).

According to an embodiment, in case that the UE has received DCI (for example, DCI format 1_1 or 0_1) indicating a bandwidth part change, the UE may perform no transmission or reception during a time interval from the third symbol of the slot used to receive a PDCCH including the corresponding DCI indicating the bandwidth part change to the start point of the slot indicated by a slot offset (K0 or K2) value. For example, the slot offset (K0 or K2) value may be indicated by a time domain resource allocation indicator field in the corresponding DCI.

For example, if the UE has received DCI indicating a bandwidth part change in slot n, and the slot offset value indicated by the corresponding DCI is K, the UE may perform no transmission or reception from the third symbol of slot n to the symbol before slot n+K (i.e., the last symbol of slot n+K−1).

### [Qcl, Tci State]

In a wireless communication system, one or more different antenna ports (which may be replaced with one or more channels, signals, and combinations thereof, but in the following description of the disclosure, will be referred to as different antenna ports, as a whole, for the sake of convenience) may be associated with each other by a quasi-co-location (QCL) configuration as in Table 4 below. A TCI state is for announcing the QCL relation between a PDCCH (or a PDCCH demodulation reference signal (DRMS)) and another RS or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations are supported in NR as in Table 10 below.

TABLE 4

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 5 below. Referring to Table 5, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) that each TCI state may include the serving cell index and the BWP index of the reference RS indicated by the corresponding QCL information, the type and ID of the reference BS, and a QCL type as in Table 5 above.

TABLE 5
TCI-State ::= SEQUENCE {

| | |
|---|---|
| tci-StateId | TCI-StateId, |
| (ID of corresponding TCI state) | |
| qcl-Type1 | QCL-Info, |

(QCL information of first reference RS of RS (target RS) referring to
corresponding TCI state ID)

| | |
|---|---|
| qcl-Type2 | QCL-Info |

```
            OPTIONAL, -- Need R
  (QCL information of second reference RS of RS (target RS) referring to
corresponding TCI state ID)
```

| | |
|---|---|
| ... | |
| } | |
| QCL-Info ::= | SEQUENCE { |
| cell | ServCellIndex |

```
      OPTIONAL, -- Need R
  (serving cell index of reference RS indicated by corresponding QCL
information)
```

| | |
|---|---|
| bwp-Id | BWP-Id |

```
        OPTIONAL, -- Cond CSI-RS-Indicated
  (BWP index of reference RS indicated by corresponding QCL
  information)
```

| | |
|---|---|
| referenceSignal | CHOICE { |
| csi-rs | NZP- |
| CSI-RS-ResourceId, | |
| ssb | |
| SSB-Index | |

(one of CSI-RS ID or SSB ID indicated by corresponding QCL

| | |
|---|---|
| information) | |
| }, | |
| qcl-Type | ENUMERATED |
| { typeA, typeB, typeC, typeD}, | |
| ... | |
| } | |

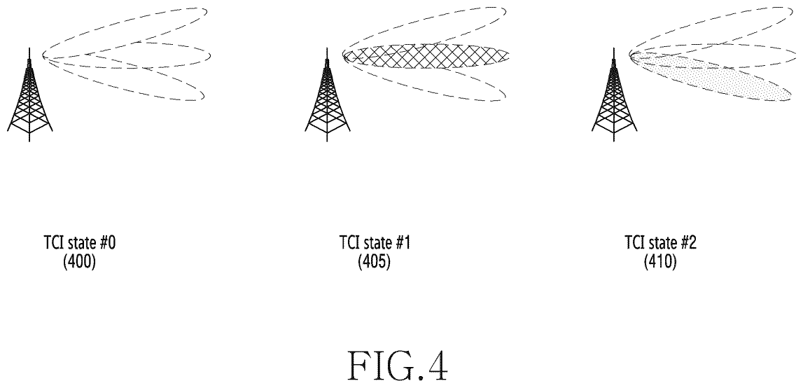

FIG. 4 illustrates an example of base station beam allocation according to TCI state configuration according to an embodiment of the disclosure.

Referring to FIG. 4, the base station may transfer information regarding N different beams to the UE through N different TCI states. For example, in the case of N=3 as in FIG. 4, the base station may configure qcl-Type2 parameters included in three TCI states 400, 405, and 410 in QCL type D while being associated with channel state information reference signals (CSI-RSs) or synchronization signal blocks (SSBs) corresponding to different beams, thereby notifying that antenna ports referring to the different TCI states 400, 405, and 410 are associated with different spatial Rx parameters (that is, different beams).

Tables 6 to 10 below enumerate valid TCI state configurations according to the target antenna port type.

Table 6 enumerates valid TCI state configurations when the target antenna port is a CSI-RS for tracking (i.e., tracking reference signal (TRS)). The TRS refers to a non-zero-power (NZP) CSI-RS which has no repetition parameter configured therefor, and trs-Info of which is configured as “true”, among CRI-RSs. In Table 6, configuration no. 3 may be used for an aperiodic TRS.

TABLE 6

| Valid TCI | | | | |
|---|---|---|---|---|
| state | | | DL RS 2 (If | qcl-Type2 (If |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS | QCL-TypeD |
| | | | (BM) | |
| 3 | TRS | QCL-TypeA | TRS (same | QCL-TypeD |
| | (periodic) | | as DL RS 1) | |

Valid TCI State Configurations when the Target Antenna Port is a CSI-RS for Tracking (TRS)

Table 7 enumerates valid TCI state configurations when the target antenna port is a CSI-RS for CSI. The CSI-RS for CSI refers to an NZP CSI-RS which has no parameter indicating repetition (for example, repetition parameter) configured therefor, and trs-Info of which is not configured as “true”, among CRI-RSs.

TABLE 7

| Valid TCI | | | | |
|---|---|---|---|---|
| state | | | DL RS 2 (If | qcl-Type2 (If |
| Configuration | DL RS 1 | qcl-Type1 | configured) | configured) |
| 1 | TRS | QCL-TypeA | SSB | QCL-TypeD |
| 2 | TRS | QCL-TypeA | CSI-RS for | QCL-TypeD |
| | | | BM | |
| 3 | TRS | QCL-TypeA | TRS (same | QCL-TypeD |
| | | | as DL RS 1) | |
| 4 | TRS | QCL-TypeB | | |

Valid TCI State Configurations when the Target Antenna Port is a CSI-RS for CSI

Table 8 enumerates valid TCI state configurations when the target antenna port is a CSI-RS for beam management (BM) (which has the same meaning as CSI-RS for L1 reference signal received power (RSRP) reporting). The CSI-RS for BM refers to an NZP CSI-RS which has a repetition parameter configured to have a value of “on” or “off”, and trs-Info of which is not configured as “true”, among CRI-RSs.

TABLE 8

| Valid TCI | | | | |
|---|---|---|---|---|
| state | | | DL RS 2 (If | qcl-Type2 (If |
| Configuration | DL RS 1 | qcl-Type1 | configured) | configured) |
| 1 | TRS | QCL-TypeA | TRS (same | QCL-TypeD |
| | | | as DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Valid TCI State Configurations when the Target Antenna Port is a CSI-RS for BM (for L1 RSRP Reporting)

Table 9 enumerates valid TCI state configurations when the target antenna port is a PDCCH DMRS.

TABLE 9

| Valid TCI | | | | |
|---|---|---|---|---|
| state | | | DL RS 2 (If | qcl-Type2 (If |
| Configuration | DL RS 1 | qcl-Type1 | configured) | configured) |
| 1 | TRS | QCL-TypeA | TRS (same | QCL-TypeD |
| | | | as DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Valid TCI State Configurations when the Target Antenna Port is a PDCCH DMRS

Table 10 enumerates valid TCI state configurations when the target antenna port is a PDSCH DMRS.

TABLE 10

| Valid TCI | | | | |
|---|---|---|---|---|
| state | | | DL RS 2 (If | qcl-Type2 (If |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS | QCL-TypeD |
| | | | (BM) | |
| 3 | CSI-RS | QCL-TypeA | CSI-RS | QCL-TypeD |
| | (CSI) | | (CSI) | |

Valid TCI State Configurations when the Target Antenna Port is a PDSCH DMRS

According to a representative QCL configuration method based on Tables 6 to 10 above, the target antenna port and reference antenna port for each step are configured and operated such as “SSB”-> “TRS”-> “CSI-RS for CSI, or CSI-RS for BM, or PDCCH DMRS, or PDSCH DMRS”. Accordingly, it is possible to help the UE's receiving operation by associating statistical characteristics that can be measured from the SSB and TRS with respective antenna ports.

### [Unified TCI State]

Hereinafter, a method for indicating and activating a single TCI state, based on a unified TCI scheme, will be described. The unified TCI scheme may refer to a scheme wherein, although existing Rel-15 and 16 have used a TCI state scheme for a UE's downlink reception and have used a spatial relation info scheme for uplink transmission (separate transmission/reception beam management scheme), the same is managed in an integrated manner by using a TCI state. Therefore, in case that a UE receives an instruction from a base station based on the unified TCI scheme, the UE may perform beam management by using a TCI state with regard to uplink transmission as well. If the base station has configured a TCI-State (higher layer signaling) having a tci-stateId-r17 (higher layer signaling) for the UE, the UE may perform an operation based on the unified TCI scheme by using the TCI-State. The TCI-State may exist in two types (joint TCI state or separate TCI state).

According to the first type (joint TCI state), the base station may indicate both TCI states to be applied to uplink transmission and downlink reception to the UE through one TCI-State. If a TCI-State based on a joint TCI state has been indicated to the UE, a parameter to be used for downlink channel estimation may be indicated to the UE by using an RS corresponding to qcl-Type1 in the TCI-State based on a joint TCI state, and a parameter to be used as a downlink reception beam or reception filter may be indicated to the UE by using an RS corresponding to qcl-Type2 therein. If a TCI-State based on a joint TCI state has been indicated to the UE, a parameter to be used as an uplink transmission beam or transmission filter may be indicated to the UE by using an RS corresponding to qcl-Type2 therein in the TCI-State based on a joint DL/UL TCI state. If a joint TCI state has been indicated to the UE, the UE may apply the same beam to both uplink transmission and downlink reception.

According to the second type (separate TCI state), the base station may individually indicate a UL TCI state to be applied to uplink transmission and a DL TCI state to be applied to downlink reception to the UE. If a UL TCI state has been indicated to the UE, a parameter to be used as an uplink transmission beam or transmission filter may be indicated to the UE by using a reference RS or source RS configured in the UL TCI state. If a DL TCI state has been indicated to the UE, a parameter to be used for downlink channel estimation may be indicated to the UE by using an RS corresponding to qcl-Type1 in the DL TCI state, and a parameter to be used as a downlink reception beam or reception filter may be indicated to the UE by using an RS corresponding to qcl-Type2 therein.

If both a DL TCI state and a UL TCI state have been indicated to the UE, a parameter to be used as an uplink transmission beam or transmission filter may be indicated to the UE by using a reference RS or source RS configured in the UL TCI state, a parameter to be used for downlink channel estimation may be indicated to the UE by using an RS corresponding to qcl-Type1 configured in the DL TCI state, and a parameter to be used as a downlink reception beam or reception filter may be indicated to the UE by using an RS corresponding to qcl-Type2 configured therein. If the DL TCI state indicated to the UE and the reference RS or source RS configured in the UL TCI state are different, the UE may apply individual beams to uplink transmission and downlink reception, respectively, based on the UL TCI state and DL TCI state indicated thereto.

A maximum of 128 joint TCI states may be configured for the UE by the base station through higher layer signaling with regard to each bandwidth part in a specific cell. Among separate TCI states, a maximum of 64 or 128 DL TCI states may be configured through higher layer signaling with regard to each bandwidth part in a specific cell, based on a UE capability report. Among separate TCI states, a DL TCI state and a joint TCI state may use the same higher layer signaling structure. As an example, if 128 joint TCI states have been configured, and if 64 DL TCI states have been configured among separate TCI states, the 64 DL TCI states may be included in the 128 joint TCI states.

Among separate TCI states, a maximum of 32 or 64 UL TCI states may be configured through higher layer signaling with regard to each bandwidth part in a specific cell, based on a UE capability report. Similarly to the relationship between a DL TCI state and a joint TCI state among separate TCI states, a UL TCI state and a joint TCI state among separate TCIs may also use the same higher layer signaling structure. A UL TCI state among separate TCIs may use a different higher layer signaling structure from a joint TCI state and a DL TCI state among separate TCI states.

Such use of different or identical higher layer signaling structures may be defined in specifications, or may be distinguished through different higher layer signaling configured by the base station, based on a UE capability report containing information regarding which is to be used among two schemes that the UE may support.

The UE may use one scheme, among a joint TCI state and a separate TCI state configured by the base station, thereby receiving an indication regarding transmission/reception beam according to a unified TCI scheme. The base station may configure, for the UE, whether or not one of the joint TCI state and the separate TCI state is to be used, through higher layer signaling.

The UE may receive an indication regarding transmission/reception beam by using a scheme selected from a joint TCI state and a separate TCI state through higher layer signaling, and the base station may indicate a transmission/reception beam in two methods (a MAC-CE-based indication method and a MAC-CE-based activation and DCI-based indication method).

If the UE receives an indication regarding transmission/reception beam by using a joint TCI state through higher layer signaling, the UE may receive a MAC-CE indicating a joint TCI state from the base station, thereby performing a transmission/reception beam application operation, and the base station may schedule reception regarding a PDSCH including the MAC-CE for the UE through a PDCCH. If the MAC-CE includes one joint TCI state, the UE may determine an uplink transmission beam or transmission filter and a downlink reception beam or reception filter by using an indicted joint TCI state 3 ms after transmission of a physical uplink control channel (PUCCH) including hybrid automatic repeat request acknowledgment (HARQ-ACK) information indicating whether or not a PDSCH including the MAC-CE is successfully received. If the MAC-CE includes two or more joint TCI states, the UE may identify that multiple joint TCI states indicated by the MAC-CE correspond to respective codepoints of the TCI state field of DCI format 1_1 or 1_2 and then activate the indicated joint TCI states, 3 ms after transmission of a PUCCH including HARQ-ACK information indicating whether or not a PDSCH including the MAC-CE is successfully received. Thereafter, the UE may receive DCI format 1_1 or 1_2 and may apply one joint TCI state indicated by the TCI state field in corresponding DCI to uplink transmission and downlink reception beams. DCI format 1_1 or 1_2 may include downlink data channel scheduling information (with DL assignment) or may not include the same (without DL assignment).

If the UE receives an indication regarding transmission/reception beam by using a separate TCI state through higher layer signaling, the UE may receive a MAC-CE indicating a separate TCI state from the base station, thereby performing a transmission/reception beam application operation, and the base station may schedule reception regarding a PDSCH including the MAC-CE for the UE through a PDCCH. If the MAC-CE includes one separate TCI state set, the UE may determine an uplink transmission beam or transmission filter and a downlink reception beam or reception filter by using separate TCI states included in the indicated separate TCI state set 3 ms after transmission of a PUCCH including HARQ-ACK information indicating whether or not the PDSCH is successfully received. The separate TCI state set may refer to a single separate TCI state or multiple separate TCI states which one codepoint of the TCI state field of DCI format 1_1 or 1_2 may have. One separate TCI state set may include one DL TCI state, may include one UL TCI state, or may include one DL TCI state and one UL TCI state. If the MAC-CE includes two or more separate TCI state sets, the UE may identify that multiple separate TCI state sets indicated by the MAC-CE correspond to respective codepoints of the TCI state field of DCI format 1_1 or 1_2 and then activate the indicated separate TCI state sets, 3 ms after transmission of a PUCCH including HARQ-ACK information indicating whether or not the PDSCH is successfully received. Each codepoint of the TCI state field of DCI format 1_1 or 1_2 may indicate one DL TCI state, may indicate one UL TCI state, or may indicate one DL TCI state and one UL TCI state. The UE may receive DCI format 1_1 or 1_2 and may apply separate TCI state sets indicated by the TCI state field in corresponding DCI to uplink transmission and downlink reception beams. DCI format 1_1 or 1_2 may include downlink data channel scheduling information (with DL assignment) or may not include the same (without DL assignment).

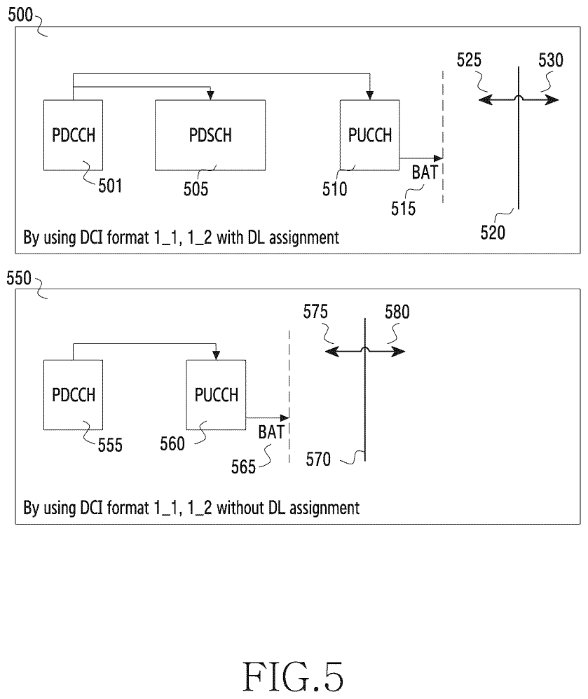

FIG. 5 illustrates a beam application time which may be considered in case that a unified TCI scheme is used in a wireless communication system according to an embodiment of the disclosure.

As described above, the UE may receive DCI format 1_1 or 1_2 including downlink data channel scheduling information (with DL assignment) or not including the same (without DL assignment) from the base station, and may apply one joint TCI state or separate TCI state set indicted by the TCI state field in corresponding DCI to uplink transmission and downlink reception beams.
DCI format 1_1 or 1_2 with DL assignment (000): if the UE receives DCI format 1_1 or 1_2 including downlink data channel scheduling information from the base station (001), thereby indicating one joint TCI state or separate TCI state set based on a unified TCI scheme, the UE may receive a PDSCH scheduled based on received DCI (005), and may transmit a PUCCH including a HARQ-ACK indicating whether or not the DCI and the PDSCH are successfully received (010). The HARQ-ACK may indicate whether or not both the DCI and the PDSCH are successfully received. In case that at least one of the DCI and the PDSCH fails to be received, the UE may transmit a negative acknowledgement (NACK). In case that both are successfully received, the UE may transmit an ACK.
DCI format 1_1 or 1_2 without DL assignment (050): if the UE receives DCI format 1_1 or 1_2 including no downlink data channel scheduling information from the base station (055), thereby indicating one joint TCI state or separate TCI state set based on a unified TCI scheme, the UE may assume a combination of at least one of the following details with regard to corresponding DCI.
A cyclic redundancy check (CRC) scrambled by using a configured scheduling (CS)-radio network temporary identifier (RNTI) is included.
All bits allocated to all fields used as a redundancy version (RV) field have a value of 1.
All bits allocated to all fields used as a modulation and coding scheme (MCS) field have a value of 1.
All bits allocated to all fields used as a new data indication (NDI) field have a value of 1.

In the case of frequency domain resource allocation (FDRA) type 0, all bits allocated to the FDRA field have a value of 0. In the case of FDRA type 1, all bits allocated to the FDRA field have a value of 1. In case that the FDRA type is dynamicSwitch, all bits allocated to the FDRA field have a value of 0.

The UE may transmit a PUCCH including a HARQ-ACK indicating whether or not DCI format 1_1 or 1_2 is successfully received, assuming the above-described details (060).
With regard to both DCI format 1_1 or 1_2 with DL assignment (000) and without DL assignment (050), if a new TCI state indicated through DCI (001, 055) is identical to the TCI state which has previously been indicated and has been applied to transmission and downlink reception beams, the UE may maintain the previously applied TCI state. If the new TCI state is different from the previously indicated TCI state, the UE may determine that the timepoint to apply a joint TCI state or separate TCI state set, which may be indicated by the TCI state field included in DCI, arrives after (030, 080) the first slot (020, 070) after a beam application time (BAT) (015, 065) since PUCCH transmission, and may use the previously indicated TCI state until (025, 075) the slot (020, 070).
With regard to both DCI format 1_1 or 1_2 with DL assignment (000) and without DL assignment (050), a BAT may be configured by higher layer signaling, based on UE capability report information, as a specific number of OFDM symbols, and the numerology regarding the BAT and the first slot after the BAT may be determined based on the smallest numerology among all cells to which a joint TCI state or separate TCI state set indicated through DCI is applied.

The UE may apply one joint TCI state indicated through a MAC-CE or DCI to reception regarding control resource sets connected to all UE-specific search spaces, reception regarding a PDSCH scheduled by a PDCCH transmitted from a corresponding control resource set, transmission regarding a PUSCH, and transmission of all PUCCH resources.

In case that one separate TCI state set indicated through a MAC-CE or DCI includes one DL TCI state, the UE may apply the one separate TCI state set to reception regarding control resource sets connected to all UE-specific search spaces and reception regarding a PDSCH scheduled by a PDCCH transmitted from a corresponding control resource set, and may apply the same to all PUSCH and PUCCH resources, based on the previously indicated UL TCI state.

In case that one separate TCI state set indicated through a MAC-CE or DCI includes one UL TCI state, the UE may apply the same, based on the previously indicated DL TCI state, to all PUSCH and PUCCH resources, and may apply the same to reception regarding control resource sets connected to all UE-specific search spaces and reception regarding a PDSCH scheduled by a PDCCH transmitted from a corresponding control resource set.

In case that one separate TCI state set indicated through a MAC-CE or DCI includes one DL TCI state and one UL TCI state, the UE may apply the DL TCI state to reception regarding control resource sets connected to all UE-specific search spaces and reception regarding a PDSCH scheduled by a PDCCH transmitted from a corresponding control resource set, and may apply the UL TCI state to all PUSCH and PUCCH resources.

### [Unified TCI State MAC-CE]

Hereinafter, a method for indicating and activating a single TCI state, based on a unified TCI scheme, will be described. The base station may configure a PDSCH including the following MAC-CE for the UE, and the UE may then interpret each codepoint of the TCI state field in DCI format 1_1 or 1_2, based on information in the MAC-CE received from the base station, after three slots used to transmit a HARQ-ACK regarding the PDSCH to the base station. That is, the UE may activate each entry of the MAC-CE received from the base station to each codepoint of the TCI state field in DCI format 1_1 or 1_2.

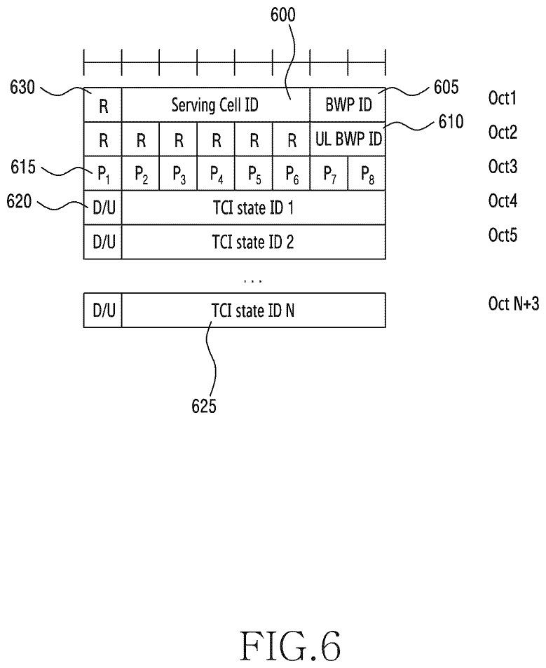

FIG. 6 illustrates another MAC-CE structure for activating and indicating a joint TCI state or a separate DL or UL TCI state in a wireless communication system according to an embodiment of the disclosure. Each field of the MAC-CE structure may have the following meaning:
Serving Cell ID (000): this field may indicate to which serving cell the MAC-CE is to be applied. This field may have a five-bit length. If the serving cell indicated by this field is included in one or more of simultaneousU-TCI-UpdateList1, simultaneousU-TCI-UpdateList2, simultaneousU-TCI-UpdateList3, or simultaneousU-TCI-UpdateList4 (higher layer signaling), the MAC-CE may be applied to all serving cells included in a list of one or more of simultaneousU-TCI-UpdateList1, simultaneousU-TCI-UpdateList2, simultaneousU-TCI-UpdateList3, and simultaneousU-TCI-UpdateList4 including the serving cell indicated by this field.
DL BWP ID (005): this field may indicate to which DL BWP the MAC-CE is to be applied, and the meaning of each codepoint of this field may correspond to each codepoint of a bandwidth part indicator in DCI. This field may have a two-bit length.
UL BWP ID (010): this field may indicate to which UL BWP the MAC-CE is to be applied, and the meaning of each codepoint of this field may correspond to each codepoint of a bandwidth part indicator in DCI. This field may have a two-bit length.
Pi (015): this field may indicate whether each codepoint of the TCI state field in DCI format 1_1 or 1_2 has multiple TCI states or has one TCI state. The value of Pi, if 1, means that the corresponding i^{th} codepoint has multiple TCI states, and this may mean that the corresponding codepoint may include a separate DL TCI state and a separate UL TCI state. The value of Pi, if 0, means that the corresponding i^{th} codepoint has a single TCI state, and this may mean that the corresponding codepoint may include one of a joint TCI state or a separate DL TCI state and a separate UL TCI state.
D/U (020): this field may indicate whether a TCI state ID field in the same octet corresponds to a joint TCI state or a separate DL TCI state or a separate UL TCI state. If this field is 1, the TCI state ID field in the same octet may correspond to a joint TCI state or a separate DL TCI state. If this field is 0, the TCI state ID field in the same octet may correspond to a separate UL TCI state.
TCI state ID (025): this field may indicate a TCI state which may be recognized by TCI-StateId (higher layer signaling). If the D/U field is configured to be 1, this field may be used to express TCI-StateId which may be expressed by 7 bits. If the D/U field is configured to be 0, the most significant bit (MSB) of this field may be regarded as a reserved bit, and the remaining 6 bits may be used to express UL-TCIState-Id (higher layer signaling). The number of TCI states which may be activated to the maximum may be 8 in the case of joint TCI states, and may be 16 in the case of separate DL or UL TCI states.
R: refers to a reserved bit, and may be configured to be 0.

Regarding the above-described MAC-CE structure in FIG. 6, the UE may include the third octet including fields P1, P2, . . . . P8 in FIG. 6 in the MAC-CE structure regardless of whether unifiedTCI-StateType-r17 in MIMOparam-r17 in ServingCellConfig (higher layer signaling) is configured as joint or configured as separate. In such a case, the UE may perform TCI state activation by using a fixed MAC-CE structure regardless of higher layer signaling configured by the base station. As another example, regarding the above-described MAC-CE structure in FIG. 6, the UE may omit the third octet including fields P1, P2, . . . . P8 in FIG. 6 in case that unifiedTCI-StateType-r17 in MIMOparam-r17 in ServingCellConfig (higher layer signaling) is configured as joint. In such a case, the UE may save the payload of the MAC-CE by a maximum of 8 bits according to higher layer signaling configured by the base station. In addition, starting from the fourth octet in FIG. 6, all D/U fields positioned at the first bit may be regarded as R fields, and all R fields may be configured to be 0 bits.

### [PDCCH: Regarding DCI]

Hereinafter, downlink control information (DCI) in a 5G communication system will be described in detail.

According to an embodiment, in a 5G system, scheduling information regarding uplink data (or physical uplink shared channel (PUSCH)) or downlink data (or physical downlink shared channel (PDSCH)) may be included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through or on a physical downlink control channel (PDCCH). A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted on the PDCCH, the UE may identify the CRC by using the allocated RNTI, and if the CRC identification result is right, the UE may identify or know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

According to an embodiment, DCI format 0_0 may be used as fallback DCI for scheduling a PUSCH, and in this case, the CRC may be scrambled by a C-RNTI. DCI format 0_0 in which the CRC is scrambled by a C-RNTI may include at least some of the following pieces of information given in Table 11 below, for example.

TABLE 11

Identifier for DCI formats - [1] bit
Frequency domain resource assignment -
[┌log₂(N_{RB}^{UL, BWP}(N_{RB}^{UL, BWP} + 1)/2)┐] bits
Time domain resource assignment - X bits
Frequency hopping flag - 1 bit.
Modulation and coding scheme - 5 bits
New data indicator - 1 bit
Redundancy version - 2 bits
HARQ process number - 4 bits
Transmit power control (TPC) command
for scheduled PUSCH - [2] bits
Uplink/supplementary uplink (UL/SUL)
indicator - 0 or 1 bit

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 12 below, for example.

TABLE 12
- Carrier indicator − 0 or 3 bits
- UL/SUL indicator − 0 or 1 bit
- Identifier for DCI formats − [1] bits
- Bandwidth part indicator − 0, 1 or 2 bits
- Frequency domain resource assignment
$* For resource allocation type 0 , ⌈ \frac{{N}_{RB}^{UL , BWP}}{P} ⌉ bits$
* For resource allocation type 1, ┌log₂(N_{RB}^{UL,BWP}(N_{RB}^{UL,BWP} + 1)/2)┐ bits
- Time domain resource assignment −1, 2, 3, or 4 bits
- Virtual resource block (VRB)-to-physical resource block (PRB)
mapping − 0 or 1 bit, only for resource allocation type 1.
* 0 bit if only resource allocation type 0 is configured;
* 1 bit otherwise.
- Frequency hopping flag − 0 or 1 bit, only for resource allocation type 1.
* 0 bit if only resource allocation type 0 is configured;
* 1 bit otherwise.
- Modulation and coding scheme − 5 bits
- New data indicator − 1 bit
- Redundancy version − 2 bits
- HARQ process number − 4 bits
- 1st downlink assignment index− 1 or 2 bits
* 1 bit for semi-static HARQ-ACK codebook;
* 2 bits for dynamic HARQ-ACK codebook with single HARQ-ACK
codebook.
- 2nd downlink assignment index − 0 or 2 bits
* 2 bits for dynamic HARQ-ACK codebook with two HARQ-ACK
sub-codebooks;
* 0 bit otherwise.
- TPC command for scheduled PUSCH − 2 bits
$\begin{matrix}‐ SRS resource indicator - ⌈ {log}_{2} ( {\sum }_{k = 1}^{{L}_{max} \sum } ( \begin{matrix}{N}_{SRS} \\ k\end{matrix} ) ( ) ) ▯ ▯ ⌉ or \\ ⌈ {log}_{2} ( {N}_{SRS} ) ⌉ bits\end{matrix}$
$\text{} \begin{matrix}* ⌈ {log}_{2} ( {\sum }_{k = 1}^{{L}_{max} \sum } ( \begin{matrix}{N}_{SRS} \\ k\end{matrix} ) ( ) ) ▯ ▯ ⌉ bits for non ‐ codebook based \\ PUSCH transmission ;\end{matrix}$
* ┌log₂(N_{SRS})┐ bits for codebook based PUSCH transmission.
- Precoding information and number of layers − up to 6 bits
- Antenna ports − up to 5 bits
- SRS request − 2 bits
- Channel state information (CSI) request − 0, 1, 2, 3, 4, 5, or 6 bits
- Code block group (CBG) transmission information − 0, 2, 4, 6, or 8 bits
- Phase tracking reference signal (PTRS)-demodulation reference signal
(DDMRS) association − 0 or 2 bits.
- beta_offset indicator − 0 or 2 bits
- DMRS sequence initialization − 0 or 1 bit

DCI format 1_0 may be used as fallback DCI for scheduling a PDSCH, and in this case, the CRC may be scrambled by a C-RNTI. DCI format 1_0 in which the CRC is scrambled by a C-RNTI may include at least some of the following pieces of information given in Table 13 below, for example.

TABLE 13

Identifier for DCI formats - [1] bit
Frequency domain resource assignment -
[┌log₂(N_{RB}^{DL, BWP}(N_{RB}^{DL, BWP} + 1)/2)┐] bits
Time domain resource assignment - X bits
VRB-to-PRB mapping - 1 bit.
Modulation and coding scheme - 5 bits
New data indicator - 1 bit
Redundancy version - 2 bits
HARQ process number - 4 bits
Downlink assignment index - 2 bits
TPC command for scheduled PUCCH - [2] bits
Physical uplink control channel (PUCCH)
resource indicator - 3 bits
PDSCH-to-HARQ feedback timing
indicator - [3] bits

DCI format 1_1 may be used as non-fallback DCI for scheduling a PDSCH, and in this case, the CRC may be scrambled by a C-RNTI. DCI format 1_1 in which the CRC is scrambled by a C-RNTI may include at least some of the following pieces of information given in Table 14 below, for example.

TABLE 14
- Carrier indicator − 0 or 3 bits
- Identifier for DCI formats − [1] bits
- Bandwidth part indicator − 0, 1 or 2 bits
- Frequency domain resource assignment
$* For resource allocation type 0 , ⌈ \frac{{N}_{RB}^{DL , BWP}}{P} ⌉ bits$
* For resource allocation type 1, ┌log₂(N_{RB}^{DL,BWP}(N_{RB}^{DL,BWP} + 1)/2)┐ bits
- Time domain resource assignment −1, 2, 3, or 4 bits
- VRB-to-PRB mapping − 0 or 1 bit, only for resource allocation type 1.
* 0 bit if only resource allocation type 0 is configured;
* 1 bit otherwise.
- Physical resource block (PRB) bundling size indicator − 0 or 1 bit
- Rate matching indicator − 0, 1, or 2 bits
- Zero power (ZP) channel state information (CSI)-reference signal (RS)
trigger − 0, 1, or 2 bits
For transport block 1:
- Modulation and coding scheme − 5 bits
- New data indicator − 1 bit
- Redundancy version − 2 bits
For transport block 2:
- Modulation and coding scheme − 5 bits
- New data indicator − 1 bit
- Redundancy version − 2 bits
- HARQ process number − 4 bits
- Downlink assignment index − 0 or 2 or 4 bits
- TPC command for scheduled PUCCH − 2 bits
- PUCCH resource indicator − 3 bits
- PDSCH-to-HARQ_feedback timing indicator − 3 bits
- Antenna ports − 4, 5 or 6 bits
- Transmission configuration indication − 0 or 3 bits
- SRS request − 2 bits
- CBG transmission information − 0, 2, 4, 6, or 8 bits
- CBG flushing out information − 0 or 1 bit
- DMRS sequence initialization − 1 bit

### [PDCCH: CORESET, REG, CCE, and Search Space]

Hereinafter, a downlink control channel in a 5G communication system will be described in more detail with reference to the accompanying drawings.

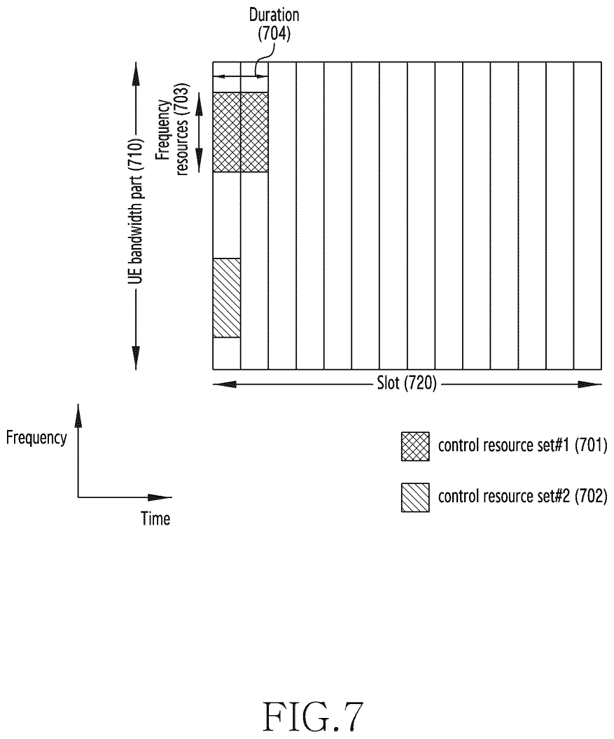

FIG. 7 illustrates an example of a control resource set (CORESET) used to transmit a downlink control channel in a 5G wireless communication system according to an embodiment of the disclosure.

FIG. 7 illustrates an example in which a UE bandwidth part 710 is configured along the frequency axis, and two control resource sets (control resource set #1 701 and control resource set #2 702) are configured within one slot 720 along the time axis. The control resource sets 701 and 702 may be configured in a specific frequency resource 703 within the entire UE bandwidth part 710 along the frequency axis. One or multiple OFDM symbols may be configured along the time axis, and this may be defined as a control resource set duration 704. Referring to the example illustrated in FIG. 7, control resource set #1 701 is configured to have a control resource set duration corresponding to two symbols, and control resource set #2 702 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE means that information such as a control resource set identity, the control resource set's frequency location, and the control resource set's symbol duration is provided. For example, the configuration information may include the following pieces of information given in Table 15.

```
TABLE 15
ConControlResourceSet ::= SEQUENCE {
      -- Corresponds to L1 parameter ′CORESET-ID′
      controlResourceSetId   ControlResourceSetId,
  (control resource set identity)
      frequencyDomainResources BIT STRING (SIZE
      (45)),
  (frequency domain resource assignment information)
      duration  INTEGER (1..
maxCoReSetDuration),
  (time domain resource assignment information)
      cce-REG-MappingType  CHOICE {
  (CCE-to-REG mapping type)
        interleaved   SEQUENCE {
          reg-BundleSize  ENUMERATED
{n2, n3, n6},
    (REG bundle size)
          precoderGranularity ENUMERATED
{sameAsREG-bundle, allContiguousRBs},
          interleaverSize ENUMERATED
{n2, n3, n6}
          (interleaver size)
          shiftIndex  INTEGER
(0..maxNrofPhysicalResourceBlocks-1)
          OPTIONAL
        (interleaver shift)
    },
      nonInterleaved  NULL
      },
      tci-StatesPDCCH  SEQUENCE
(SIZE (1..maxNrofTCI-StatesPDCCH)) OF TCI-StateId
      OPTIONAL,
  (QCL configuration information)
      tci-PresentInDCI  ENUMERATED {enabled}
          OPTIONAL, ... Need S
}
```

In Table 15, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding CORESET.

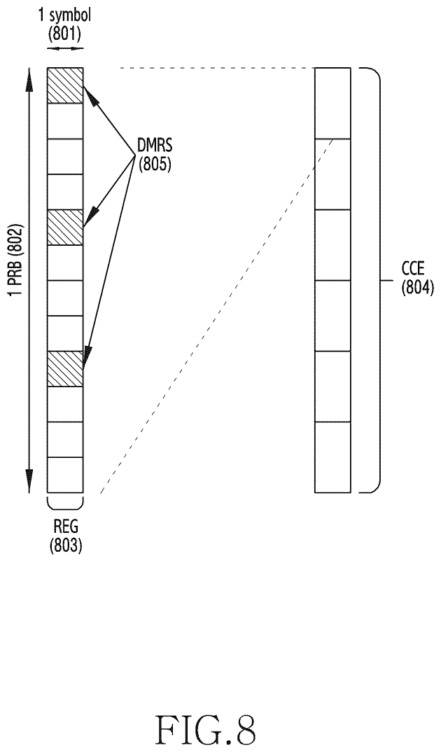

FIG. 8 illustrates an example of a basic unit of time and frequency resources constituting a downlink control channel available in a 5G system according to an embodiment of the disclosure.

Referring to FIG. 8, the basic unit of time and frequency resources constituting a control channel may be referred to as a resource element group (REG) 803, and the REG 803 may be defined by one OFDM symbol 801 along the time axis and one physical resource block (PRB) 802 (that is, 12 subcarriers) along the frequency axis. The base station may configure a downlink control channel allocation unit by concatenating the REGs 803.

Provided that the basic unit of downlink control channel allocation in 5G is a control channel element (CCE) 804 as illustrated in FIG. 8, one CCE 704 may include multiple REGs 803. To describe the REG 803 illustrated in FIG. 8, for example, the REG 803 may include 12 REs, and if one CCE 804 includes six REGs 803, one CCE 804 may then include 72 REs. A downlink control resource set, once configured, may include multiple CCEs 804, and a specific downlink control channel may be mapped to one or multiple CCEs 804 and then transmitted according to the aggregation level (AL) in the control resource set. The CCEs 804 in the control resource set are distinguished by numbers, and the numbers of CCEs 804 may be allocated according to a logical mapping scheme.

The basic unit of the downlink control channel illustrated in FIG. 8, that is, the REG 803 may include both REs to which DCI is mapped, and an area to which a reference signal (DMRS 805) for decoding the same is mapped. As in FIG. 8, three DRMSs 805 may be transmitted inside one REG 803. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALS, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the configuration information may include the following pieces of information given in Table 16.

TABLE 16

| | |
|---|---|
| SearchSpace ::= | SEQUENCE { |

-- Identity of the search space. SearchSpaceId = 0 identifies the SearchSpace configured
via PBCH (MIB) or ServingCellConfigCommon.

| | |
|---|---|
| searchSpaceId | SearchSpaceId, |
| (search space identity) | |
| controlResourceSetId | ControlResourceSetId, |
| (control resource set identity) | |

monitoringSlotPeriodicityAndOffset CHOICE {

| | |
|---|---|
| (monitoring slot level periodicity) | |
| sl1 | |
| NULL, | |
| sl2 | INTEGER |
| (0..1), | |
| sl4 | INTEGER |
| (0..3), | |
| sl5 | INTEGER |
| (0..4), | |
| sl8 | INTEGER |
| (0..7), | |
| sl10 | INTEGER |
| (0..9), | |
| sl16 | INTEGER |
| (0..15), | |
| sl20 | INTEGER |
| (0..19) | |
| } | |
| OPTIONAL, | |

duration (monitoring duration) INTEGER (2..2559)

| | |
|---|---|
| monitoringSymbolsWithinSlot | BIT STRING |
| (SIZE (14)) | |
| OPTIONAL, | |
| (monitoring symbols within slot) | |
| nrofCandidates | SEQUENCE { |
| (number of PDCCH candidates for each aggregation level) | |
| aggregationLevel1 | |
| ENUMERATED {n0, n1, n2, n3, n4, n5, n6, n8}, | |
| aggregationLevel2 | |
| ENUMERATED {n0, n1, n2, n3, n4, n5, n6, n8}, | |
| aggregationLevel4 | |
| ENUMERATED {n0, n1, n2, n3, n4, n5, n6, n8}, | |
| aggregationLevel8 | |
| ENUMERATED {n0, n1, n2, n3, n4, n5, n6, n8}, | |
| aggregationLevel16 | |
| ENUMERATED {n0, n1, n2, n3, n4, n5, n6, n8} | |
| searchSpaceType | CHOICE { |
| (search space type) | |

```
        -- Configures this search space as common search space (CSS) and DCI
formats to monitor.
        common
      SEQUENCE {
      (common search space)
    }
        ue-Specific
      SEQUENCE {
      (UE-specific search space)
          -- Indicates whether the UE monitors in this USS for DCI formats 0-
0 and 1-0 or for formats 0-1 and 1-1.
          formats
      ENUMERATED {formats0-0-And-1-0, formats0-1-And-1-1},
      ...
}
```

According to configuration information, the base station may configure one or multiple search space sets for the UE. According to some embodiments, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the examples given below are not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Obviously, the examples given below are not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below.
Cell RNTI (C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCH
Transmit power control for SRS RNTI (TPC-SRS-RNTI): used to indicate a power control command regarding an SRS

The DCI formats enumerated above may follow the definitions given in Table 17 below:

TABLE 17

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for |
| | PUCCH and PUSCH |
| 2_3 | Transmission of a group of TPC commands |
| | for SRS transmissions by one or more UEs |

In 5G, the search space at aggregation level L in connection with control resource set p and search space set s may be expressed by Equation 1 below:

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 1$$

L: aggregation level
n_{CI}: carrier index
N_{CCE,p}: total number of CCEs existing in control resource set p
n_{s,f}^{μ}: slot index
M_{s,max}^{(L)} er of PDCCH candidates at aggregation level L
m_{s,n}_{_{CI}}=0, M_{s,max}^{(L)}DCCH candidate index at aggregation level L
i=0, . . . , L−1
Y_{p,n}_{_{s,f}}_{^{μ}}=(Aₚ·Y_{p,n}_{_{s,f}}_{^{μ}}₋₁) mod D, Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identity

The

$${Y}_{p , {n}_{s , f}^{μ}}$$

value may correspond to 0 in the case of a common search space.

The

$${Y}_{p , {n}_{s , f}^{μ}}$$

value may correspond to a value changed by the UE's identity (C-RNTI or ID configured for the UE by the base station) and the time index in the case of a UE-specific search space.

In a 5G system, multiple search space sets may be configured by different parameters (for example, parameters in Table 16), and the group of search space sets monitored by the UE at each timepoint may differ accordingly. For example, if search space set #1 is configured at X-slot periodicity, if search space set #2 is configured at Y-slot periodicity, and if X and Y are different, the UE may monitor search space set #1 and search space set #2 both in a specific slot, and may monitor one of search space set #1 and search space set #2 both in another specific slot.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 18 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 18 through upper signaling. If PUSCH transmission is operated by a configured grant, parameters applied to the PUSCH transmission are applied through configuredGrantConfig (upper signaling) in Table 18 except for dataScramblingIdentityPUSCH, txConfig, codebookSubset, maxRank, and scaling of UCI-OnPUSCH, which are provided by pusch-Config (upper signaling) in Table 19. If provided with transformPrecoder inside configuredGrantConfig (upper signaling) in Table 18, the UE applies tp-pi2BPSK inside pusch-Config in Table 19 to PUSCH transmission operated by a configured grant.

TABLE 18
ConfiguredGrantConfig ::= SEQUENCE {

| | |
|---|---|
| frequencyHopping | ENUMERATED {intraSlot, interSlot} |
| OPTIONAL, -- Need S, | |

cg-DMRS-Configuration DMRS-UplinkConfig,

| | |
|---|---|
| mcs-Table | ENUMERATED {qam256, qam64LowSE} |
| OPTIONAL, -- Need S | |
| mcs-TableTransformPrecoder | ENUMERATED {qam256, qam64LowSE} |
| OPTIONAL, -- Need S | |
| uci-OnPUSCH | SetupRelease { CG-UCI-OnPUSCH } |
| OPTIONAL, -- Need M | |
| resourceAllocation | ENUMERATED { resourceAllocationType0, |

resourceAllocationType1, dynamicSwitch },

| | |
|---|---|
| rbg-Size | ENUMERATED {config2} |
| OPTIONAL, -- Need S | |
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |
| OPTIONAL, -- Need S | |
| nrofHARQ-Processes | INTEGER(1..16), |
| repK | ENUMERATED {n1, n2, n4, n8}, |
| repK-RV | ENUMERATED {s1-0231, s2-0303, s3-0000} |
| OPTIONAL, -- Need R | |
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14,

sym128x14, sym160x14, sym256x14, sym320x14, sym512x14,

| | |
|---|---|
| | sym640x14, sym1024x14, sym1280x14, sym2560x14, |
| sym5120x14, | |
| | sym6, sym1x12, sym2x12, sym4x12, sym5x12, |

sym8x12, sym10x12, sym16x12, sym20x12, sym32x12,

sym40x12, sym64x12, sym80x12, sym128x12,

sym160x12, sym256x12, sym320x12, sym512x12, sym640x12,

| | |
|---|---|
| | sym1280x12, sym2560x12 |
| }, | |
| configuredGrantTimer | INTEGER (1..64) |
| OPTIONAL, -- Need R | |
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |
| OPTIONAL, -- Need R | |
| precodingAndNumberOfLayers | INTEGER (0..63), |
| srs-ResourceIndicator | INTEGER (0..15) |
| OPTIONAL, -- Need R | |
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |
| PathlossReferenceRSs-1), | |
| ... | |
| } | OPTIONAL, |
| -- Need R | |
| ... | |
| } | |

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 19, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 30, the UE does not expect scheduling through DCI format 0_1.

TABLE 19
PUSCH-Config ::= SEQUENCE {

| | |
|---|---|
| dataScramblingIdentityPUSCH | INTEGER (0..1023) |
| OPTIONAL, -- Need S | |

txConfig ENUMERATED {codebook, nonCodebook}

| | |
|---|---|
| OPTIONAL, -- Need S | |
| dmrs-UplinkForPUSCH-MappingTypeA | SetupRelease { DMRS-UplinkConfig } |
| OPTIONAL, -- Need M | |
| dmrs-UplinkForPUSCH-MappingTypeB | SetupRelease { DMRS-UplinkConfig } |
| OPTIONAL, -- Need M | |
| pusch-PowerControl | OPTIONAL, -- |
| Need M | |
| frequencyHopping | ENUMERATED {intraSlot, interSlot} |
| OPTIONAL, -- Need S | |

frequencyHoppingOffsetLists SEQUENCE (SIZE (1..4)) OF INTEGER (1..

maxNrofPhysicalResourceBlocks-1)
OPTIONAL, -- Need M

resourceAllocation ENUMERATED { resourceAllocationType0,

| | |
|---|---|
| resourceAllocationType1, dynamicSwitch}, | |
| pusch-TimeDomainAllocationList | SetupRelease { PUSCH- |

TimeDomainResourceAllocationList } OPTIONAL, -- Need M

| | |
|---|---|
| pusch-AggregationFactor | ENUMERATED { n2, n4, n8 } |
| OPTIONAL, -- Need S | |

```
  mcs-Table   ENUMERATED {qam256, qam64LowSE}
OPTIONAL, -- Need S
  mcs-TableTransformPrecoder  ENUMERATED {qam256, qam64LowSE}
```

| | |
|---|---|
| OPTIONAL, -- Need S | |
| transformPrecoder | ENUMERATED {enabled, disabled} |
| OPTIONAL, -- Need S | |

codebookSubset ENUMERATED {fullyAndPartialAndNonCoherent,

| | |
|---|---|
| partialAndNonCoherent,nonCoherent} | |
| OPTIONAL, -- Cond codebookBased | INTEGER (1..4) |
| maxRank | |
| OPTIONAL, -- Cond codebookBased | |
| rbg-Size | ENUMERATED { config2} |
| OPTIONAL, -- Need S | |
| uci-OnPUSCH | SetupRelease { UCI-OnPUSCH} |
| OPTIONAL, -- Need M | |
| tp-pi2BPSK | ENUMERATED {enabled} |
| OPTIONAL, -- Need S | |
| ... | |
| } | |

Next, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI is used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fully AndPartialAndNonCoherent”, “partialAndNonCoherent”, or “noncoherent”, based on UE capability reported by the UE to the base station. If the UE reported “partialAndNonCoherent” as UE capability, the UE does not expect that the value of codebook Subset (upper signaling) will be configured as “fully AndPartialAndNonCoherent”. In addition, if the UE reported “nonCoherent” as UE capability, UE does not expect that the value of codebookSubset (upper signaling) will be configured as “fully AndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE transmits, to the base station, one or multiple SRS resources included in the SRS resource set wherein the value of usage is configured as “codebook” according to upper signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the base station adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS is indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is positioned in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE does not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

### [PUSCH: Preparation Procedure Time]

Next, a PUSCH preparation procedure time will be described. If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in NR in consideration thereof. The PUSCH preparation procedure time of the UE may follow Equation 2 given below.

$${T}_{p roc , 2} = max ( ( {N}_{2} + {d}_{2 , 1} + {d}_{2} ) ( 2048 + 144 ) κ {2}^{- μ} {T}_{c} + {T}_{ext} + {T}_{switch} , {d}_{2 , 2} ) \qquad Equation 2$$

Each parameter in T_{proc,2} described above in Equation 2 may have the following meaning.
N₂: the number of symbols determined according to UE processing capability 1 or 2, based on the UE's capability, and numerology μ. N₂ may have a value in Table 20 if UE processing capability 1 is reported according to the UE's capability report, and may have a value in Table 21 if UE processing capability 2 is reported, and if availability of UE processing capability 2 is configured through upper layer signaling.

TABLE 20

| | PUSCH preparation |
|---|---|
| μ | time N₂ [symbols] |
| 0 | 10 |
| 1 | 12 |
| 2 | 23 |
| 3 | 36 |

TABLE 21

| | PUSCH preparation |
|---|---|
| μ | time N₂ [symbols] |
| 0 | 5 |
| 1 | 5.5 |
| 2 | 11 for frequency |
| | range 1 |

d_{2,1}: the number of symbols determined to be 0 if all resource elements of the first OFDM symbol of PUSCH transmission include DM-RSs, and to be 1 otherwise.
κ: 64
μ: follows a value, among μ_{DL} and μ_{UL}, which makes T_{proc,2} larger. μ_{DL} refers to the numerology of a downlink used to transmit a PDCCH including DCI that schedules a PUSCH, and μ_{UL} refers to the numerology of an uplink used to transmit a PUSCH.
T_{c}: has

$$\frac{1}{Δ {f}_{max} \cdot {N}_{f}} ,$$

Δfₘₐₓ=480·10³ Hz, N_{f}=4096 . . . lows a BWP switching time if DCI that schedules a PUSCH indicates BWP switching, and has 0 otherwise.
d₂: if OFDM symbols overlap temporally between a PUSCH having a high priority index and a PUCCH having a low priority index, the d₂ value of the PUSCH having a high priority index is used. Otherwise, d₂ is 0.
Tₑₓₜ: if the UE uses a shared spectrum channel access scheme, the UE may calculate Tₑₓₜ and apply the same to a PUSCH preparation procedure time. Otherwise, Tₑₓₜ is assumed to be 0.
T_{switch}: if an uplink switching spacing has been triggered, T_{switch} is assumed to be the switching spacing time. Otherwise, T_{switch} is assumed to be 0.

The base station and the UE determine that the PUSCH preparation procedure time is insufficient if the first symbol of a PUSCH starts earlier than the first uplink symbol in which a CP starts after Tproc,2 from the last symbol of a PDCCH including DCI that schedules the PUSCH, in view of the influence of timing advance between the uplink and the downlink and time domain resource mapping information of the PUSCH scheduled through the DCI. Otherwise, the base station and the UE determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

### [PUSCH: Regarding Repetition Transmission]

Hereinafter, repetition transmission of an uplink data channel in a 5G system will be described in detail. A 5G system supports two types of uplink data channel repetition transmission methods, PUSCH repetition type A transmission and PUSCH repetition type B transmission. One of PUSCH repetition type A transmission and PUSCH repetition type B transmission may be configured for a UE through upper layer signaling.

### 1. PUSCH Repetition Type a Transmission (PUSCH Repetition Type A)

As described above, the symbol length of an uplink data channel and the location of the start symbol may be determined by a time domain resource allocation method in one slot, and a base station may notify a UE of the number of repetition transmissions through upper layer signaling (for example, RRC signaling) or L1 signaling (for example, DCI).
Based on the number of repetition transmissions received from the base station, the UE may repetitively transmit an uplink data channel having the same length and start symbol as the configured uplink data channel, in a continuous slot. If the base station configured a slot as a downlink for the UE, or if at least one of symbols of the uplink data channel configured for the UE is configured as a downlink, the UE omits uplink data channel transmission, but counts the number of repetition transmissions of the uplink data channel. That is, although included in the number of repetition transmissions of the uplink data channel, the uplink data channel may not be transmitted. Contrarily, the UE supporting Rel-17 uplink data repetition transmission may determine a slot capable of uplink data repetition transmission as an available slot, and may count the number of transmissions during uplink data channel repetition transmission in the slot determined as an available slot. If uplink data channel repetition transmission is omitted in a slot determined as “available slot”, the repetition transmission may be postponed and thereafter performed through a slot available for transmission.
In order to determine an available slot as described above, if at least one symbol configured for a PUSCH by time domain resource allocation (TDRA) in a slot for PUSCH transmission overlaps a symbol for purposes other than uplink transmission (for example, downlink transmission), the corresponding slot is determined as an unavailable slot (for example, a slot other than an available slot, which is determined as being unavailable for PUSCH transmission). In addition, an available slot may be considered a resource for PUSCH transmission and an uplink resource for determining a transport block size (TBS) in PUSCH repetition transmission and multi-slot PUSCH transmission including one TB (transport block on multiple slots (TBoMS)).

### 2. PUSCH Repetition Type B Transmission (PUSCH Repetition Type B)

As described above, the symbol length of an uplink data channel and the location of the start symbol may be determined by a time domain resource allocation method in one slot, and a base station may notify a UE of the number of repetition transmissions (numberofrepetitions) through upper layer signaling (for example, RRC signaling) or L1 signaling (for example, DCI).
The nominal repetition of the uplink data channel is determined as follows, based on the previously configured start symbol and length of the uplink data channel. The slot in which the n^{th} nominal repetition starts is given by

$${K}_{s} + ⌊ \frac{S + n \cdot L}{{N}_{symb}^{slot}} ⌋ ,$$

and the symbol starting in that slot is given by mod (S+n·L, N_{symb}^{slot}). The slot in which the n^{th} nominal repetition ends is given by

$${K}_{s} + ⌊ \frac{S + ( n + 1 ) \cdot L - 1}{{N}_{symb}^{slot}} ⌋ ,$$

and the symbol ending in that slot is given by mod (S+(n+1)·L−1, N_{symb}^{slot}). In this regard, n=0, . . . , numberofrepetitions-1, S refers to the start symbol of the configured uplink data channel, and L refers to the symbol length of the configured uplink data channel. Kₛ refers to the slot in which PUSCH transmission starts, and N_{symb}^{slot} refers to the number of symbols per slot.
For PUSCH repetition type B transmission, the UE may determine a specific OFDM symbol as an invalid symbol in the following cases.

A symbol configured as a downlink by tdd-UL-DL-ConfigurationCommon or tdd-UL-DL-ConfigurationDedicated may be determined as the invalid symbol for PUSCH repeated transmission type B.

In order to receive an SSB in an unpaired spectrum (time division duplex (TDD) spectrum), symbols indicated by ssb-PositionInBurst within SIB1 or ssb-PositionInBurst within ServingCellConfigCommon (upper layer signaling) may be determined as invalid symbols for PUSCH repetition type B transmission.

In order to transmit a control resource set associated with a Type0-PDCCH CSS set in an unpaired spectrum (TDD spectrum), symbols indicated through by pdsch-ConfigSIBI within an MIB may be determined as invalid symbols for PUSCH repetition type B transmission.

In an unpaired spectrum (TDD spectrum), if numberOfInvalidSymbolsForDL-UL-Switching (upper layer signaling) is configured, as many symbols as numberOfInvalidSymbolsForDL-UL-Switching from symbols configured as a downlink by tdd-UL-DL-ConfigurationCommon or tdd-UL-DL-ConfigurationDedicated may be determined as invalid symbols.

Additionally, the invalid symbol may be configured in an upper layer parameter (for example, InvalidSymbolPattern). The upper layer parameter (for example, InvalidSymbolPattern) may provide a symbol level bitmap across one or two slots, thereby configuring the invalid symbol. In the bitmap, 1 represents the invalid symbol. Additionally, the periodicity and pattern of the bitmap may be configured through the upper layer parameter (for example, InvalidSymbolPattern). If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 indicates 1, the UE applies an invalid symbol pattern, and if the above parameter indicates 0, the UE does not apply the invalid symbol pattern. If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 is not configured, the UE applies the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition includes a set of consecutive valid symbols available for PUSCH repeated transmission type B in one slot. In the case where the OFDM symbol length of the nominal repetition is not 1, if the length of the actual repetition is 1, the UE may ignore transmission for the actual repetition.

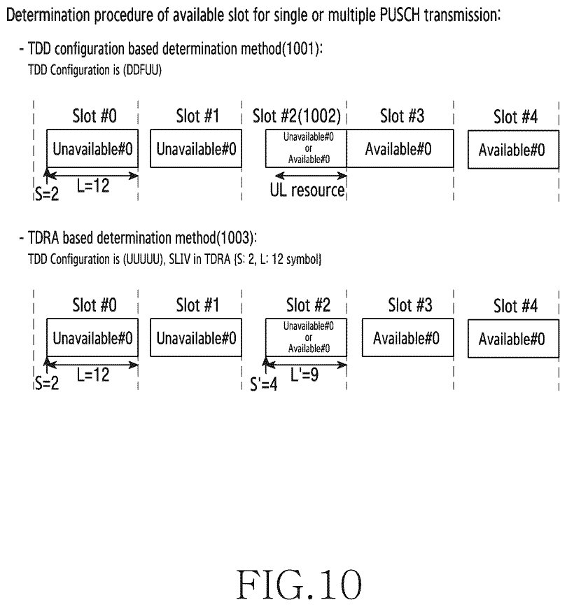

FIG. 10 illustrates a method for determining an available slot during PUSCH repetition type A by a UE in a 5G system according to an embodiment of the disclosure.

When a base station configured an uplink resource through higher layer signaling (for example, tdd-UL-DL-ConfigurationCommon or tdd-UL-DL-ConfigurationDedicated) or L1 signaling (for example, dynamic slot format indicator), the base station and the UE may determine an available slot according to the following two methods with regard to the configured uplink resource.
A method in which an available slot is determined based on a TDD configuration
A method in which an available slot is determined in consideration of a TDD configuration, time domain resource allocation (TDRA), and configured grant (CG) configuration or activation DCI

As an example of the method in which an available slot is determined based on a TDD configuration, in case that the TDD configuration is configured as “DDFUU” through higher layer signaling in FIG. 10, the base station and the UE may determine that slot #3 and slot #4 configured for uplink “U”, based on the TDD configuration, are available slots (1001). Slot #2 (1002) configured as flexible slot “F”, based on the TDD configuration, may be determined to be an unavailable slot or an available slot, and may be predefined through a base station configuration, for example.

As an example of the method in which an available slot is determined in consideration of a TDD configuration, time domain resource allocation (TDRA), and configured grant (CG) configuration or activation DCI, in case that the TDD configuration is configured as “UUUUU” through higher layer signaling in FIG. 10, and in case that the start and length indicator value (SLIV) of PUSCH transmission is configured as {S: 2, L: 12 symbol} through L1 signaling, the base station and the UE may determine that slot #0, slot #1, slot #3, and slot #4 which satisfies the SLIV of the PUSCH with regard to the configured uplink slot “U” are available slots. The base station and the UE may determine that slot #2 (“L=9”≤SLIV “L=12”) which fails to satisfy the SLIV (TDRA condition for PUSCH transmission) is an unavailable slot (1003). This is only an example, the range is not limited to PUSCH transmission, and the same may also be applied to the case of PUCCH transmission, PUSCH/PUCCH repeated transmission, nominal repetition of PUSCH repetition type B, and TBoMS.

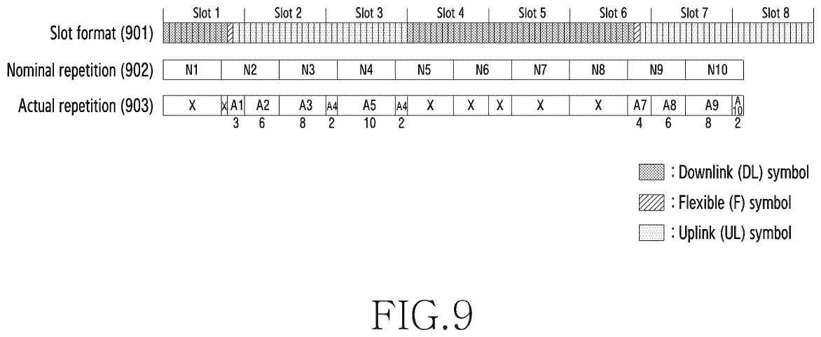

FIG. 9 illustrates an example of PUSCH repeated transmission type B in a wireless communication system according to an embodiment of the disclosure.

FIG. 9 illustrates a case where, for nominal repetition, the UE receives the following configurations: the transmission start symbol S is 0, the transmission symbol length L is 10, which may be represented by N1 to N10 in the drawing (902). In this case, the UE may determine invalid symbols in consideration of a slot format (901) and thereby determine actual repetition, which may be represented by A1 to A10 in the drawing (903) In this regard, according to the invalid symbol and actual repetition determination scheme, PUSCH repetition type B transmission is not performed in a symbol for which the slot format is determined as downlink (DL), and if a slot boundary exists within nominal repetition, two actual repetitions may be dividedly transmitted with respect to the slot boundary. As an example, A1 referring to the first actual repetition may include three OFDM symbols, and A2 that can be transmitted next may include six OFDM symbols.

In addition, with regard to PUSCH repetition transmission, additional methods may be defined in NR Release 16 with regard to UL grant-based PUSCH transmission and configured grant-based PUSCH transmission, across slot boundaries, as follows:
Method 1 (mini-slot level repetition): through one UL grant, two or more PUSCH repetition transmissions are scheduled inside one slot or across the boundary of consecutive slots. In connection with method 1, time domain resource allocation information inside DCI indicates resources of the first repetition transmission. In addition, time domain resource information of remaining repetition transmissions may be determined according to time domain resource information of the first repetition transmission, and the uplink or downlink direction determined with regard to each symbol of each slot. Each repetition transmission occupies consecutive symbols.
Method 2 (multi-segment transmission): through one UL grant, two or more PUSCH repetition transmissions are scheduled in consecutive slots. Transmission no. 1 is designated for each slot, and the start point or repetition length differs between respective transmissions. In method 2, time domain resource allocation information inside DCI indicates the start point and repetition length of all repetition transmissions. In the case of performing repetition transmissions inside a single slot through method 2, if there are multiple bundles of consecutive uplink symbols in the corresponding slot, respective repetition transmissions may be performed with regard to respective uplink symbol bundles. If there is a single bundle of consecutive uplink symbols in the corresponding slot, PUSCH repetition transmission is performed once according to the method of NR Release 15.
Method 3: two or more PUSCH repetition transmissions are scheduled in consecutive slots through two or more UL grants. Transmission no. 1 may be designated with regard to each slot, and the nth UL grant may be received before PUSCH transmission scheduled by the (n−1)th UL grant is over.
Method 4: through one UL grant or one configured grant, one or multiple PUSCH repetition transmissions inside a single slot, or two or more PUSCH repetition transmissions across the boundary of consecutive slots may be supported. The number of repetitions indicated to the UE by the base station is only a nominal value, and the UE may actually perform a larger number of PUSCH repetition transmissions than the nominal number of repetitions. Time domain resource allocation information inside DCI or configured grant refers to resources of the first repetition transmission indicated by the base station. Time domain resource information of remaining repetition transmissions may be determined with reference to resource information of the first repetition transmission and the uplink or downlink direction of symbols. If time domain resource information of repetition transmission indicated by the base station spans a slot boundary or includes an uplink/downlink switching point, the corresponding repetition transmission may be divided into multiple repeated transmissions. One repetition transmission may be included in one slot with regard to each uplink period.

### [PUSCH: Frequency Hopping Process]

Hereinafter, frequency hopping of a physical uplink shared channel (PUSCH) in a 5G system will be described in detail.

5G supports two kinds of PUSCH frequency hopping methods with regard to each PUSCH repeated transmission type. First of all, in PUSCH repeated transmission type A, intra-slot frequency hopping and inter-slot frequency hopping are supported, and in PUSCH repeated transmission type B, inter-repetition frequency hopping and inter-slot frequency hopping are supported.

The intra-slot frequency hopping method supported in PUSCH repetition type A transmission may include a method in which a UE transmits allocated resources in the frequency domain, after changing the same by a configured frequency offset, by two hops in one slot. The start RB of each hop in connection with intra-slot frequency hopping may be expressed by Equation 3 below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad Equation 3$$

In Equation 3, i=0 and i=1 may denote the first and second hops, respectively, and RBₛₜₐᵣₜ may denote the start RB in a UL BWP and may be calculated from a frequency resource allocation method. RB_{offset} denotes a frequency offset between two hops through an upper layer parameter. The number of symbols of the first hop may be represented by └N_{symb}^{PUSCH,s}/2┘, and number of symbols of the second hop may be represented by N_{symb}^{PUSCH,s}−└N_{symb}^{PUSCH,s}/2┘. N_{symb}^{PUSCH,s} is the length of PUSCH transmission in one slot and is expressed by the number of OFDM symbols.

Next, the inter-slot frequency hopping method supported in PUSCH repetition type A and type B transmissions is a method in which the UE transmits allocated resources in the frequency domain, after changing the same by a configured frequency offset, in each slot. The start RB during a slot in connection with inter-slot frequency hopping may be expressed by Equation 4 below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad Equation 4$$

In Equation 4, nₛ^{μ} denotes the current slot number during multi-slot PUSCH transmission, and RBₛₜₐᵣₜ denotes the start RB inside a UL BWP and is calculated from a frequency resource allocation method. RB_{offset} denotes a frequency offset between two hops through an upper layer parameter.

The inter-repetition frequency hopping method supported in PUSCH repeated transmission type B may be a method in which resources allocated in the frequency domain regarding one or multiple actual repetitions in each nominal repetition are moved by a configured frequency offset and then transmitted. The index RBstart(n) of the start RB in the frequency domain regarding one or multiple actual repetitions in the nth nominal repetition may follow Equation 5 given below:

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad Equation 5$$

In Equation 5, n denotes the index of nominal repetition, and RB_{offset} denotes an RB offset between two hops through an upper layer parameter.

### [PUSCH: Regarding Transmission Power]

Hereinafter, a method for determining transmission power of an uplink data channel in a 5G system will be described in detail.

In a 5G system, transmission power of an uplink data channel may be determined through Equation 6 as follows:

$${P}_{PUSCH , b , f , c} ( i , j , {q}_{d} , l ) = min \{ \begin{matrix}{P}_{CMAX , f , c} ( i ) , \\ {P}_{O\_PUSCH , b , f , c} ( j ) + 10 {log}_{10} ( {2}^{μ} \cdot {M}_{RB , b , f , c}^{PUSCH} ( j ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} \qquad Equation 6$$

$$[ dB m ]$$

In Equation 6, j refers to a PUSCH grant type. Specifically, j=0 denotes a PUSCH grant regarding a random access response, j=1 denotes a configured grant, and j∈{2,3, . . . . J−1} denotes a dynamic grant. P_{CMAXf,c}(i) refers to maximum output power configured for the UE regarding carrier f of support cell c with regard to PUSCH transmission occasion i. P_{O_PUSCHb,f,c}(j) is a parameter configured by the sum of P_{O_NOMINAL_PUSCH,f,c}(j) which is configured by a higher layer parameter and P_{O_UE_PUSCH,b,f,c}(j) which may be determined through a higher layer configuration and an SRI (in the case of a dynamic grant PUSCH). M_{RB,b,f,c}^{PUSCH}(i) refers to a bandwidth regarding resource allocation expressed by the number of resource blocks with regard to PUSCH transmission occasion i. Δ_{TF,b,f,c}(i) is a value determined according to the modulation coding scheme (MCS), the type of information (for example, whether or not UL-SCH is included or whether or not CSI is included) transmitted by the PUSCH, and the like. α_{b,f,c}(j) is a value for compensating for pathloss, and may be determined through a higher layer configuration and an SRS resource indicator (SRI) (in the case of a dynamic grant PUSCH). PL_{b,f,c}(q_{d}) refers to an estimated downlink pathloss value estimated by the UE through a reference signal, the reference signal index of which is qd, and the reference signal index qd may be determined by the UE through a higher layer configuration and an SRI (in the case of a dynamic grant PUSCH or a configured grant PUSCH based on ConfiguredGrantConfig including no rrc-ConfiguredUplinkGrant (higher layer signaling) (type 2 configured grant PUSCH)) or through a higher layer configuration. f_{b,f,c}(i,l) is a closed loop power adjustment value, and may be supported in an accumulation type and in an absolute type. If higher layer parameter tpc-Accumulation is not configured for the UE, the closed loop power adjustment value may be determined in the accumulation type. f_{b,f,c}(i,l) is determined to be

$${f}_{b , f , c} ( i - {i}_{0} , l ) + {\sum }_{m = 0}^{\text{?} ( {D}_{i} ) - 1} {δ}_{PUSCH , b , f , c} ( m , l )$$

$$\text{?} \text{indicates text missing or illegible when filed}$$

which is the sum of the closed loop power adjustment value regarding previous PUSCH transmission occasion i-i0 and TPC command values regarding closed loop index l, received through DCI between symbol KPUSCH(i-i0)−1 for transmitting PUSCH transmission occasion i-i0 and symbol KPUSCH (i) for transmitting PUSCH transmission occasion i. If higher layer parameter tpc-Accumulation is configured for the UE, f_{b,f,c}(i,l) is determined to be TPC command value δ_{PUSCH,b,f,c}(i,l) regarding closed loop index/received through DCI. If higher layer parameter twoPUSCH-PC-AdjustementStates is configured for the UE, closed loop index l may be configured to be 0 or 1, and the value thereof may be determined through a higher layer configuration and an SRI (in the case of a dynamic grant PUSCH). The mapping relation between the TPC value δ_{PUSCH,b,f,c} and the TPC command value in DCI, based on the accumulation type and absolute type, may be defined as in Table 22 below:

TABLE 22

| | Accumulated | Absolute |
|---|---|---|
| TPC command field | δ_{PUSCH, b, f, c} [dB] | δ_{PUSCH, b, f, c} [dB] |
| 0 | −1 | −4 |
| 1 | 0 | −1 |
| 2 | 1 | 1 |
| 3 | 3 | 4 |

### [PUSCH: Regarding TPMI]

Next, a transmit precoding matrix indicator (TPMI) indicated through DCI by a base station during codebook-based PUSCH transmission will be described.

If a UE is configured by a base station through DCI or higher layer signaling such that 1-layer transmission is scheduled therefor by using a single PUSCH antenna port, the TPMI may be defined W=1. Otherwise, that is, if the UE is configured by the base station through DCI or higher layer signaling such that 1-layer or more PUSCHs are scheduled therefor by using multiple PUSCH antenna ports, the TPMI (which is W) may be defined through Tables 23 to 29 below:

TABLE 23

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

Table 23 above describes a 1-layer TPMI in case that the UE has two PUSCH antenna ports. In Table 23 above, if the UE has a non-coherent antenna structure and has reported UE capability corresponding thereto to the base station, the base station may select one from TPMI index 0 and 1 and indicate the same to the UE. If the UE has a full-coherent antenna structure and has reported UE capability corresponding thereto to the base station, the base station may select one from TPMI index 0 to 5 and indicate the same to the UE.

TABLE 24

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

Table 24 above describes a 1-layer TPMI in case that the UE has four PUSCH antenna ports, and in case that transform precoding is used (that is, in case that a discrete fourier transform-spread (DFTS)-OFDM waveform is used). In Table 24 above, if the UE has a non-coherent antenna structure and has reported UE capability corresponding thereto to the base station, the base station may select one from TPMI index 0 to 3 and indicate the same to the UE. If the UE has a partial-coherent antenna structure and has reported UE capability corresponding thereto to the base station, the base station may select one from TPMI index 0 to 11 and indicate the same to the UE. If the UE has a full-coherent antenna structure and has reported UE capability corresponding thereto to the base station, the base station may select one from TPMI index 0 to 27 and indicate the same to the UE.

TABLE 25

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

Table 25 above describes a 1-layer TPMI in case that the UE has four PUSCH antenna ports, and in case that transform precoding is not used (that is, in case that a CP-OFDM waveform is used). In Table 25 above, if the UE has a non-coherent antenna structure and has reported UE capability corresponding thereto to the base station, the base station may select one from TPMI index 0 to 3 and indicate the same to the UE. If the UE has a partial-coherent antenna structure and has reported UE capability corresponding thereto to the base station, the base station may select one from TPMI index 0 to 11 and indicate the same to the UE. If the UE has a full-coherent antenna structure and has reported UE capability corresponding thereto to the base station, the base station may select one from TPMI index 0 to 27 and indicate the same to the UE.

TABLE 26

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

Table 26 above describes a 2-layer TPMI in case that the UE has two PUSCH antenna ports, and in case that transform precoding is not used (that is, in case that a CP-OFDM waveform is used). In Table 26 above, if the UE has a non-coherent antenna structure and has reported UE capability corresponding thereto to the base station, the base station may select TPMI index 0 and indicate the same to the UE. If the UE has a full-coherent antenna structure and has reported UE capability corresponding thereto to the base station, the base station may select one from TPMI index 0 to 2 and indicate the same to the UE.

TABLE 27

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

Table 27 above describes a 2-layer TPMI in case that the UE has four PUSCH antenna ports, and in case that transform precoding is not used (that is, in case that a CP-OFDM waveform is used). In Table 27 above, if the UE has a non-coherent antenna structure and has reported UE capability corresponding thereto to the base station, the base station may select one from TPMI index 0 to 5 and indicate the same to the UE. If the UE has a partial-coherent antenna structure and has reported UE capability corresponding thereto to the base station, the base station may select one from TPMI index 0 to 13 and indicate the same to the UE. If the UE has a full-coherent antenna structure and has reported UE capability corresponding thereto to the base station, the base station may select one from TPMI index 0 to 21 and indicate the same to the UE.

TABLE 28

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

Table 28 above describes a 3-layer TPMI in case that the UE has four PUSCH antenna ports, and in case that transform precoding is not used (that is, in case that a CP-OFDM waveform is used). In Table 28 above, if the UE has a non-coherent antenna structure and has reported UE capability corresponding thereto to the base station, the base station may select TPMI index 0 and indicate the same to the UE. If the UE has a partial-coherent antenna structure and has reported UE capability corresponding thereto to the base station, the base station may select one from TPMI index 0 to 2 and indicate the same to the UE. If the UE has a full-coherent antenna structure and has reported UE capability corresponding thereto to the base station, the base station may select one from TPMI index 0 to 6 and indicate the same to the UE.

TABLE 29

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

Table 29 above describes a 4-layer TPMI in case that the UE has four PUSCH antenna ports, and in case that transform precoding is not used (that is, in case that a CP-OFDM waveform is used). In Table 29 above, if the UE has a non-coherent antenna structure and has reported UE capability corresponding thereto to the base station, the base station may select TPMI index 0 and indicate the same to the UE. If the UE has a partial-coherent antenna structure and has reported UE capability corresponding thereto to the base station, the base station may select one from TPMI index 0 to 2 and indicate the same to the UE. If the UE has a full-coherent antenna structure and has reported UE capability corresponding thereto to the base station, the base station may select one from TPMI index 0 to 4 and indicate the same to the UE.

### [Regarding SRS]

Next, an uplink channel estimation method using sounding reference signal (SRS) transmission of a UE will be described. The base station may configure at least one SRS configuration with regard to each uplink BWP in order to transfer configuration information for SRS transmission to the UE, and may also configure as least one SRS resource set with regard to each SRS configuration. As an example, the base station and the UE may exchange upper signaling information as follows, in order to transfer information regarding the SRS resource set.
srs-ResourceSetId: an SRS resource set index
srs-ResourceIdList: a set of SRS resource indices referred to by SRS resource sets
resourceType: time domain transmission configuration of SRS resources referred to by SRS resource sets, and may be configured as one of “periodic”, “semi-persistent”, and “aperiodic”. If configured as “periodic” or “semi-persistent”, associated CSI-RS information may be provided according to the place of use of SRS resource sets. If configured as “aperiodic”, an aperiodic SRS resource trigger list/slot offset information may be provided, and associated CSI-RS information may be provided according to the place of use of SRS resource sets.
usage: a configuration regarding the place of use of SRS resources referred to by SRS resource sets, and may be configured as one of “beamManagement”, “codebook”, “nonCodebook”, and “antennaSwitching”.
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

In addition, the base station and the UE may transmit/receive upper layer signaling information in order to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. The individual configuration information regarding SRS resources may include time domain transmission configuration of SRS resources, and may be configured as one of “periodic”, “semi-persistent”, and “aperiodic”. The time domain transmission configuration of SRS resources may be limited to have the same time domain transmission configuration as the SRS resource set including the SRS resources. If the time domain transmission configuration of SRS resources is configured as “periodic” or “semi-persistent”, the time domain transmission configuration may further include an SRS resource transmission cycle and a slot offset (for example, periodicity AndOffset).

The base station may activate or deactivate SRS transmission for the UE through upper layer signaling including RRC signaling or MAC CE signaling, or L1 signaling (for example, DCI). For example, the base station may activate or deactivate periodic SRS transmission for the UE through upper layer signaling. The base station may indicate activation of an SRS resource set having resourceType configured as “periodic” through upper layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicity AndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the periodic SRS resource activated through upper layer signaling.

For example, the base station may activate or deactivate semi-persistent SRS transmission for the UE through upper layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent”. Intra-slot time-frequency domain resource mapping of the transmitted SRS resource follows resource mapping information configured for the SRS resource, and slot mapping, including the transmission cycle and slot offset, follows periodicity AndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through upper layer signaling.

For example, the base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource follows resource mapping information configured for the SRS resource. In addition, slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. The minimum time interval may have a different value depending on the place of use of the SRS resource set including the transmitted SRS resource. For example, the minimum time interval may be determined as N2 symbols defined in consideration of UE processing capability that follows the UE's capability with reference to the UE's PUSCH preparation procedure time. In addition, if the place of use of the SRS resource set is configured as “codebook” or “antennaSwitching” in view of the place of use of the SRS resource set including the transmitted SRS resource, the minimum time interval may be determined as N2 symbols, and if the place of use of the SRS resource set is configured as “nonCodebook” or “beamManagement”, the minimum time interval may be determined as N2+14 symbols. The UE may transmit an aperiodic SRS if the time interval for aperiodic SRS transmission is larger than or equal to the minimum time interval, and may ignore the DCI that triggers the aperiodic SRS if the time interval for aperiodic SRS transmission is smaller than the minimum time interval.

TABLE 30

| | |
|---|---|
| SRS-Resource ::= | SEQUENCE { |
| srs-ResourceId | , |
| nrofSRS-Ports | ENUMERATED {port1, ports2, ports4}, |
| ptrs-PortIndex | ENUMERATED {n0, n1 } |
| OPTIONAL, -- Need R | |
| transmissionComb | CHOICE { |
| n2 | SEQUENCE { |
| combOffset-n2 | INTEGER (0..1), |
| cyclicShift-n2 | INTEGER (0..7) |
| }, | |
| n4 | SEQUENCE { |
| combOffset-n4 | INTEGER (0..3), |
| cyclicShift-n4 | INTEGER (0..11) |
| } | |
| }, | |
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |
| }, | |
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |
| }, | |
| groupOrSequenceHopping | ENUMERATED { neither, groupHopping, |
| [symbol] quenceHopping }, | |
| resourceType | CHOICE { |
| aperiodic | SEQUENCE { |
| ... | |
| }, | |
| semi-persistent | SEQUENCE { |
| periodicityAndOffset-sp | SRS-PeriodicityAndOffset, |
| ... | |
| }, | |
| periodic | SEQUENCE { |
| periodicityAndOffset-p | SRS-PeriodicityAndOffset, |
| ... | |
| } | |
| }, | |
| sequenceId | INTEGER (0..1023), |
| spatialRelationInfo | SRS-SpatialRelationInfo |
| OPTIONAL, -- Need R | |
| ... | |
| } | |

[symbol]

indicates data missing or illegible when filed

Configuration information spatialRelationInfo in Table 30 above is applied, with reference to one reference signal, to a beam used for SRS transmission corresponding to beam information of the corresponding reference signal. For example, configuration of spatialRelationInfo may include information as in Table 31 below.

TABLE 31

| SRS-SpatialRelationInfo ::= SEQUENCE { | |
|---|---|
| servingCellId | ServCellIndex OPTIONAL, -- Need S |
| referenceSignal | CHOICE { |
| ssb-Index | , |
| csi-RS-Index | NZP-CSI-RS-ResourceId, |
| srs | SEQUENCE { |
| resourceId | SRS-ResourceId, |
| uplinkBWP | BWP-Id |
| } | |
| } | |
| } | |

Referring to the above-described spatialRelationInfo configuration, an SS/PBCH block index, CSI-RS index, or SRS index may be configured as the index of a reference signal to be referred to in order to use beam information of a specific reference signal. Upper signaling referenceSignal corresponds to configuration information indicating which reference signal's beam information is to be referred to for corresponding SRS transmission, ssb-Index refers to the index of an SS/PBCH block, csi-RS-Index refers to the index of a CSI-RS, and srs refers to the index of an SRS. If upper signaling referenceSignal has a configured value of “ssb-Index”, the UE may apply the reception beam which was used to receive the SS/PBCH block corresponding to ssb-Index as the transmission beam for the corresponding SRS transmission. If upper signaling referenceSignal has a configured value of “csi-RS-Index”, the UE may apply the reception beam which was used to receive the CSI-RS corresponding to csi-RS-Index as the transmission beam for the corresponding SRS transmission. If upper signaling referenceSignal has a configured value of “′srs”, the UE may apply the reception beam which was used to transmit the SRS corresponding to srs as the transmission beam for the corresponding SRS transmission.

### [SRS: Comb Offset/Cyclic Shift Configuration Method]

Next, a method for configuring a comb offset and a cyclic shift during sounding reference signal (SRS) transmission by the UE will be described.

The base station may configure an SRS resource for the UE through SRS-Resource or SRS-PosResource (higher layer signaling), and the same may be configured by the following details:
The number of antenna ports may be configured for the UE with regard to each SRS resource in the case of SRS-Resource, and the value thereof may be defined as Nₐₚ^{SRS}∈{1,2,4,8} and may be configured through nrofSRS-Ports or nrofSRS-Ports-n8 (higher layer signaling). If usage (higher layer signaling) in SRS-ResourceSet is configured to be a value other than nonCodebook, pᵢ=1000+i may refer to the number of i^{th} antenna port, and i may be an integer of 0 to Nₐₚ^{SRS}−1. If usage (higher layer signaling) in SRS-ResourceSet is configured to be nonCodebook, Nₐₚ^{SRS}=1 antenna port may be configured for each SRS resource, and the antenna port of (i+1)^{th} SRS resource in SRS-ResourceSet may be defined as pᵢ=1000+i. In the case of SRS-PosResource, Nₐₚ^{SRS}=1 may be defined.
The base station may configure, for the UE, the number of consecutive symbols used to transmit an SRS through nrofSymbols in resourceMapping (higher layer signaling), and the value thereof may be defined as N_{symb}^{SRS}∈{1,2,4,8,10,12,14}.
The base station may configure, for the UE, the position of a starting symbol in which an SRS is transmitted within one slot through startPosition in resourceMapping (higher layer signaling), and the value thereof may be defined as l₀=N_{symb}^{slot}−1−l_{offset}. N_{symb}^{slot} may refer to the number of symbols in the slot, and the value thereof may be 14 in the case of a normal cyclic prefix, or may be 12 in the case of an extended cyclic prefix. l_{offset}∈{0, 1, . . . , 13} may refer to an offset value for counting the number of symbols inversely from the symbol positioned rearmost in the slot. l_{offset}≥N_{symb}^{SRS}−1 may be satisfied.
k₀ may refer to the starting position of a frequency resource used to transmit an SRS.

An SRS sequence that may be produced through an SRS resource defined based on the above information may be defined as in Equation 7 below:

$$\begin{matrix}{r}^{( {p}_{i} )} ( n , {l}^{′} ) = {w}_{TDM}^{( {p}_{i} )} ( {l}^{′} ) {r}_{u , v}^{( {α}_{i} , δ )} ( n ) \\ 0 \leq n \leq {M}_{sc , b}^{SRS} - 1 \\ {l}^{′} ∈ \{ 0 , 1 , … , {N}_{symb}^{SRS} - 1 \}\end{matrix} \qquad Equation 7$$

wherein

$${M}_{sc , b}^{SRS} = \frac{{m}_{SRS , b} {N}_{sc}^{RB}}{{K}_{TC} {P}_{F}}$$

refers to the length of the SRS sequence. m_{SRS,b} is determined through Table 33 below, and may be determined through b-SRS and c-SRS (higher layer signaling). In case that b-SRS is configured, B_{SRS}∈{0,1,2,3} value in Table 33 below may be determined, and the value of subscript b of m_{SRS,b} may be determined. In case that b-SRS is not configured, B_{SRS}=0 may hold. c-SRS may determine C_{SRS}∈{0, 1, . . . , 63} value in Table 33 below. P_{F}∈{2,4} may be determined through FreqScalingFactor (higher layer signaling), and P_{F}=1 may hold in case that the corresponding parameter is not configured. In case that FreqScalingFactor (higher layer signaling) is configured, the UE may expect that the length of the SRS sequence will be a multiple of 6.

δ=log₂(K_{TC}) may be defined, and K_{TC}∈{2,4,8} may determine the comb size. The comb size may denote the interval between REs used to transmit an SRS in a frequency resource. As an example, the comb size, if K_{TC}=2, may mean that the interval between REs used to transmit an SRS corresponds to two REs. The comb size may be configured for the UE through transmissionComb (higher layer signaling). l′∈{0, 1, . . . , N_{symb}^{SRS}−1} may denote a symbol index in symbols used to transmit an SRS resource. The UE may determine the maximum cyclic shift value n_{SRS}^{cs,max} according to the K_{TC} value as in Table 32 below:

TABLE 32

| K_{TC} | n_{SRS}^{cs, max} |
|---|---|
| 2 | 8 |
| 4 | 12 |
| 8 | 6 |

r_{u,v}^{(α}^{ᵢ}^{,δ)}(n) may be defined through αᵢ which refer to a cyclic shift of the i^{th} antenna port and a basic sequence r̅_{u,v}(n) as below:

$${r}_{u , v}^{( {α}_{i} , δ )} ( n ) = {e}^{j {α}_{i} n} {\overline{r}}_{u , v} ( n ) , 0 \leq n < {M}_{ZC}$$

$${M}_{ZC} = \frac{m {N}_{sc}^{RB}}{{2}^{δ}}$$

may denote the length of the SRS sequence. With regard to one basic sequence, multiple SRS sequences may be produced according to different αᵢ and δ values.

Multiple basic sequences may be divided into groups, the group index may be defined as u∈{0, 1, . . . , 29}, and v may refer to the index of the basic sequence in a group. If

$$\frac{1}{2} \leq \frac{m}{{2}^{δ}} \leq 5 ,$$

each group may include one basic sequence, and v=0 may hold. If

$$6 \leq \frac{m}{{2}^{δ}} ,$$

each group may include two basic sequences, and v=0.1 may hold. The definition of r̅_{u,v}(n) may vary according to the value of M_{ZC} (sequence length).

In case that the length of the basic sequence is 36 or larger, that is M_{ZC}≥3N_{sc}^{RB}, the basic sequence r̅_{u,v}(n) may be defined as below. N_{ZC} may be the largest prime number smaller than M_{ZC}.

$${\overline{r}}_{u , v} ( n ) = {x}_{q} ( n mod {N}_{ZC} )$$

$${x}_{q} ( m ) = {e}^{- j \frac{π qm ( m + 1 )}{{N}_{ZC}}}$$

$$q = ⌊ \overline{q} + \frac{1}{2} ⌋ + v \cdot {( - 1 )}^{⌊ 2 \overline{q} ⌋}$$

$$\overline{q} = {N}_{ZC} \cdot \frac{u + 1}{31}$$

In case that the length of the basic sequence is 6, 12, 18, or 24, that is, M_{ZC}∈{6,12,18,24}, the basic sequence r̅_{u,v}(n) may be defined as below:

$${\overline{r}}_{u , v} ( n ) = {e}^{\frac{j φ ( n ) π}{4}} , 0 \leq n \leq {M}_{ZC} - 1$$

The value of φ(n) may be defined through Tables 34 to 37 below.

In case that the length of the basic sequence is 30, that is M_{ZC}=30, the basic sequence r̅_{u,v}(n) may be defined as below:

$${\overline{r}}_{u , v} ( n ) = {e}^{- j \frac{π ( u + 1 ) ( n + 1 ) ( n + 2 )}{31}} , 0 \leq n \leq {M}_{ZC} - 1$$

In case that nrofSRS-Ports-n8 (higher layer signaling) is configured as ports8tdm for the UE, w_{TDM}^{(p}^{ᵢ}⁾(l′) may be defined as below. Otherwise, w_{TDM}^{(p}^{ᵢ}⁾(l′)=1 may be defined.
In case that l′∈{0, 2, . . . , N_{symb}^{SRS}.−2} and pᵢ∈{1000,1001,1004,1005}, w_{TDM}^{(p}^{ᵢ}⁾(l′)=1 may be defined.
In case that l′∈{1, 3, . . . , N_{symb}^{SRS}−1} and pᵢ∈{1002,1003,1006,1007}, w_{TDM}^{(p}^{ᵢ}⁾(l′)=1 may be defined.
Other than the two cases above, w_{TDM}^{(p}^{ᵢ}⁾(l′)=0 may be defined.

αᵢ denotes a cyclic shift corresponding to antenna port pᵢ, and may be defined as below:

$${α}_{i} = 2 π \frac{{n}_{SRS}^{cs , i}}{{n}_{SRS}^{cs , max}}$$

n_{SRS}^{cs,i} may be defined as below:

In case that N̅aₚ^{SRS}=8 and n_{SRS}^{cs,max}=6,

$${n}_{SRS}^{cs , i} = ( {n}_{SRS}^{cs} + \frac{{n}_{SRS}^{cs , max} ⌊ \frac{{\overline{p}}_{i} - 1000}{4} ⌋}{\frac{{\overline{N}}_{ap}^{SRS}}{4}} ) mod {n}_{SRS}^{cs , max}$$

may be defined.

In case that N̅ₐₚ^{SRS}=4 and n_{SRS}^{cs,max}=6, or N̅aₚ^{SRS}=8 and n_{SRS}^{cs,max}=12,

$${n}_{SRS}^{cs , i} = ( {n}_{SRS}^{cs} + \frac{{n}_{SRS}^{cs , max} ⌊ \frac{{\overline{p}}_{i} - 1000}{2} ⌋}{\frac{{\overline{N}}_{ap}^{SRS}}{2}} ) mod {n}_{SRS}^{cs , max}$$

may be defined.

Other than the two cases above,

$${n}_{SRS}^{cs , i} = ( {n}_{SRS}^{cs} + \frac{{n}_{SRS}^{cs , max} ( {\overline{p}}_{i} - 1000 )}{{\overline{N}}_{ap}^{SRS}} ) mod {n}_{SRS}^{cs , max}$$

may be defined.

n_{SRS}^{cs}∈{0, 1, . . . n_{SRS}^{cs,max}−1} is a parameter that determines the cyclic shift value, and may be configured through yclicShift-n2, cyclicShift-n4, or cyclicShift-n8 in transmissionComb (higher layer signaling), and n_{SRS}^{cs,max} may be determined through Table 32 above.

N̅ₐₚ^{SRS} and p̅ᵢ may be defined as below:
In case that nrofSRS-Ports-n8 (higher layer signaling) is configured as ports8tdm, N̅ₐₚ^{SRS}=4 may be defined. p̅ᵢ may be defined as p̅ᵢ=1000+pᵢ mod 2 in case that pᵢ−1000<4, and may be defined as p̅ᵢ=1000+pᵢ mod 2+2 in case that pᵢ−1000≥4. That is, in case that the UE transmits an SRS resource configured by eight antenna ports in a TDM type, p̅ᵢ=1000, 1001, 1002, 1003 may be defined with regard to pᵢ=1000, 1001, 1004, 1005 which are antenna ports to be transmitted at the first symbol, respectively, and p̅ᵢ=1000, 1001, 1002, 1003 may be defined with regard to pᵢ=1002, 1003, 1006, 1007 which are antenna ports to be transmitted at the second symbol, respectively, such that, when allocating resources to four different antenna ports transmitted at each symbol, the same resource allocation scheme regarding an SRS resource configured by four antenna ports may be applied thereto.
Other than the above case, that is, in case that nrofSRS-Ports-n8 (higher layer signaling) is not configured as ports8tdm, N̅ₐₚ^{SRS}=Nₐₚ^{SRS} and p̅ᵢ=pᵢ may be defined.

k₀^{(p}^{ᵢ}⁾ refers to the starting position in the frequency domain of an SRS corresponding to the i^{th} antenna port, and may be defined as below:

$${k}_{0}^{( {p}_{i} )} = {\overline{k}}_{0}^{( {p}_{i} )} + {n}_{offset}^{FH} + {n}_{offset}^{RPFS}$$

k̅₀^{(p}^{ᵢ}⁾ may be defined as below:

$${\overline{k}}_{0}^{( {p}_{i} )} - {n}_{shift} {N}_{sc}^{RB} + ( {k}_{TC}^{( {p}_{i} )} + {k}_{offset}^{{l}^{′}} )$$

k_{TC}^{(p}^{ᵢ}⁾ may be defined as below:
In case that N̅ₐₚ^{SRS}=8, p̅ᵢ∈{1003,1007}, n_{SRS}^{cs,max}=6,

$${k}_{TC}^{( {p}_{i} )} = ( {\overline{k}}_{TC} + \frac{3 {K}_{TC}}{4} ) mod {K}_{TC}$$

may be defined.
In case that N̅ₐₚ^{SRS}=8, p̅ᵢ∈{1002,1006}, n_{SRS}^{cs,max}=6,

$${k}_{TC}^{( {p}_{i} )} = ( {\overline{k}}_{TC} + \frac{{K}_{TC}}{2} ) mod {K}_{TC}$$

may be defined.
In case that N̅ₐₚ^{SRS}=8, p̅ᵢ∈{1001,1005}, n_{SRS}^{cs,max}=6,

$${k}_{TC}^{( {p}_{i} )} = ( {\overline{k}}_{TC} + \frac{{K}_{TC}}{4} ) mod {K}_{TC}$$

may be defined.
In case that N̅ₐₚ^{SRS}=8, p̅ᵢ∈{1001,1003,1005,1007}, n_{SRS}^{cs,max}=12,

$${k}_{TC}^{( {p}_{i} )} = ( {\overline{k}}_{TC} + \frac{{K}_{TC}}{2} ) mod {K}_{TC}$$

may be defined.
In case that N̅ₐₚ^{SRS}=8, p̅ᵢ∈{1001,1003,1005,1007}, n_{SRS}^{cs,max}=8,

$${n}_{SRS}^{cs} \geq \frac{{n}_{SRS}^{cs , max}}{2} , {k}_{TC}^{( {p}_{i} )} = ( {\overline{k}}_{TC} + \frac{{K}_{TC}}{2} )$$

mod K_{TC} may be defined.
In case that N̅ₐₚ^{SRS}=4, p̅ᵢ∈{1001,1003}, n_{SRS}^{cs,max}=6,

$${k}_{TC}^{( {p}_{i} )} = ( {\overline{k}}_{TC} + \frac{{K}_{TC}}{2} ) mod {K}_{TC}$$

may be defined.
In case that N̅ₐₚ^{SRS}=4, p̅ᵢ∈{1001,1003}, n_{SRS}^{sc,max}∈{8,12},

$${n}_{SRS}^{cs} \geq \frac{{n}_{SRS}^{cs , max}}{2} , {k}_{TC}^{( {p}_{i} )} = ( {\overline{k}}_{TC} + \frac{{K}_{TC}}{2} )$$

Other than the above cases, k_{TC}^{(p}^{ᵢ}⁾=k̅_{TC} may be defined.

n_{offset}^{FH} may be defined as below:

$${n}_{offset}^{FH} = {\sum }_{b = 0}^{{B}_{SRS}} {m}_{SRS , b} {N}_{sc}^{RB} {n}_{b}$$

n_{offset}^{RPFS} may be defined as below:

$${n}_{offset}^{RPFS} = \frac{{N}_{sc}^{RB} {m}_{SRS , {B}_{SRS}} ( ( {k}_{F} + {k}_{hop} ) mod {P}_{F} )}{{P}_{F}}$$

k_{F}∈{0, 1, . . . , P_{F}−1} may be configured by StartRBIndex (higher layer signaling). If not configured, k_{F}=0 may be defined.

kₕₒₚ may be determined through Table 38, based on k̅ₕₒₚ and N_{b}_{ₕₒₚ} values below, in case that EnableStartRBHopping (higher layer signaling) is configured. Otherwise, kₕₒₚ=0 may be defined.

$${\overline{k}}_{hop} = ⌊ \frac{{n}_{SRS}}{{\prod }_{{b}^{′} = {b}_{hop}}^{{B}_{SRS}} {N}_{b}^{′}} ⌋ mod {P}_{F} , {N}_{{b}_{hop}} = 1$$

If SRS transmission is performed based on SRS-PosResource, k_{offset}^{l′} may be defined based on Table 39 below. Otherwise (if SRS transmission is performed based on SRS-Resource), k_{offset}^{l′}=0 may be defined.

n_{shift} is an offset value in the frequency domain, determines the degree of offset of the SRS transmission position from the reference position in the frequency domain, and may be configured through freqDomainShift (higher layer signaling). k̅_{TC}∈{0, 1, . . . , K_{TC}−1} denotes a comb offset value and may be configured through combOffset-n2, combOffset-n4, or combOffset-n8 in transmissionComb (higher layer signaling).

b-hop may be configured in freqHoping as higher layer signaling related to the SRS's frequency hopping, and bₕₒₚ∈{0,1,2,3} may be defined.

n_{b} denotes a frequency position's index, and may be defined as below:
In case that bₕₒₚ≥B_{SRS}, the SRS's frequency hopping is not supported. n_{b} which denotes a frequency position's index may have a predetermined value during all N_{symb}^{SRS} symbols and may be defined as below:

$${n}_{b} = ⌊ \frac{4 {n}_{RRC}}{{m}_{SRS , b}} ⌋ mod {N}_{b}$$

The value of n_{RRC} is configured through freqDomainPosition (higher layer signaling) and, if not configured, may be 0.
In case that bₕₒₚ<B_{SRS}, the SRS's frequency hopping is supported, and n_{b} may be defined as follows:
In case that b≤bₕₒₚ,

$${n}_{b} = ⌊ \frac{4 {n}_{RRC}}{{m}_{SRS , b}} ⌋ mod {N}_{b}$$

may be defined.

Otherwise,

$${n}_{b} = {F}_{b} ( {n}_{SRS} ) + ⌊ \frac{4 {n}_{PRC}}{{m}_{SRS , b}} ⌋ mod {N}_{b}$$

may be defined.

In case that Ng is an even number, F_{b}(n_{SRS}) may be defined as

$${F}_{b} ( {n}_{SRS} ) = ( \frac{{N}_{b}}{2} ) ⌊ \frac{{n}_{SRS} mod {\prod }_{{b}^{′} = {b}_{hop}}^{b} {N}_{b}^{′}}{{\prod }_{{b}^{′} = {b}_{hop}}^{b - 1} {N}_{b}^{′}} ⌋ + ⌊ \frac{{n}_{SRS} mod {\prod }_{{b}^{′} = {b}_{hop}}^{b} {N}_{b}^{′}}{2 {\prod }_{{b}^{′} = {b}_{hop}}^{b - 1} {N}_{b}^{′}} ⌋ .$$

In case that N_{b} is an odd number,

$${F}_{b} ( {n}_{SRS} ) = ⌊ \frac{{N}_{b}}{2} ⌋ ⌊ \frac{{n}_{SRS}}{{\prod }_{{b}^{′} = {b}_{hop}}^{b - 1} {N}_{b}^{′}} ⌋$$

may be defined. N_{b}_{ₕₒₚ} may be defined to be 1 regardless of the value of N_{b}.

n_{SRS} may be defined as a parameter for counting the number of SRS transmissions. In case that the UE transmits an aperiodic SRS resource, the same may be defined as

$${n}_{SRS} = ⌊ \frac{{l}^{′}}{sR} ⌋$$

in N_{symb}^{SRS} symbols in a specific slot. s may be defined as s=2 in case that nrofSRS-Ports-n8 (higher layer signaling) is configured as ports8tdm, and may be defined as s=1 in other cases.

$$R \leq \frac{{N}_{symb}^{SRS}}{2}$$

may be a value configured by repetitionFactor (higher layer signaling), and R=N_{symb}^{SRS} may be defined in case that the same is not configured.

In case that the UE transmits a periodic or semi-persistent SRS resource, n_{SRS} may be defined as below in slots satisfying (Nₛₗₒₜ^{frame,μ}n_{f}+n_{s,f}^{μ}−T_{offset}) mod T_{SRS}=0.

$${n}_{SRS} = ( \frac{{N}_{slot}^{frame , μ} {n}_{f} + {n}_{s , f}^{μ} - {T}_{offset}}{{T}_{SRS}} ) ( \frac{{N}_{symb}^{SRS}}{sR} ) + ⌊ \frac{{l}^{′}}{sR} ⌋$$

wherein T_{SRS} and T_{offset} may refer to the period and slot offset of the periodic or semi-persistent SRS.

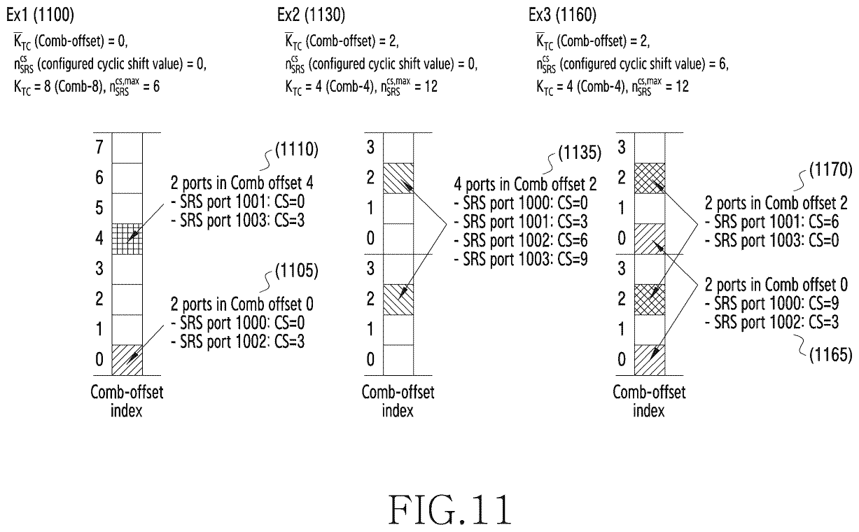

FIG. 11 illustrates a method for allocating a comb offset and a cyclic shift during SRS transmission according to an embodiment of the disclosure.

The first example 1100 may assume a situation wherein, with regard to an SRS resource including four antenna ports, k̅_{TC}=0 (comb offset value), n_{SRS}^{cs}=0 (cyclic shift value), K_{TC}=8 (comb size value), and n_{SRS}^{cs,max}=6 (maximum cyclic shift value) are configured for the UE. In such a case, the UE may define n_{SRS}^{cs,0}=0 and n_{SRS}^{cs,2}=3 as cyclic shift values allocated with regard to p̅ᵢ=1000 and 1002, respectively, and may define all comb offset values as k_{TC}^{(p}^{ᵢ}⁾=0 with regard to p̅ᵢ=1000 and 1002 (1105). In addition, the UE may define n_{SRS}^{cs,1}=0 and n_{SRS}^{cs,3}=3 as cyclic shift values allocated with regard to p̅ᵢ=1001 and 1003, respectively, and may define all comb offset values as k_{TC}^{(p}^{ᵢ}⁾=4 with regard to p̅ᵢ=1001 and 1003 (1110). Therefore, in order to allocate every two of the four antenna ports to the same comb offset and to separate two antenna ports in the same comb offset, the interval between cyclic shift values corresponding to two antenna ports may be determined to be

$$\frac{{n}_{SRS}^{cs , max}}{2} = 3$$

such that the interval is maximized.

The second example 1130 may assume a situation wherein, with regard to an SRS resource including four antenna ports, k̅_{TC}=2 (comb offset value), n_{SRS}^{cs}=0 (cyclic shift value), K_{TC}=4 (comb size value), and n_{SRS}^{cs,max}=12 (maximum cyclic shift value) are configured for the UE. In such a case, the UE may define n_{SRS}^{cs,0}=0, n_{SRS}^{cs,1}=3, n_{SRS}^{cs,2}=6, and n_{SRS}^{cs,3}=9 as cyclic shift values allocated with regard to p̅ᵢ=1000, 1001, 1002, and 1003, respectively, and may define all comb offset values as k_{TC}^{(p}^{ᵢ}⁾=2 with regard to p̅ᵢ=1000, 1001, 1002, and 1003 (1135). Therefore, in order to allocate four antenna ports all to the same comb offset and to separate four antenna ports in the same comb offset, the interval between cyclic shift values corresponding to four antenna ports may be determined to be

$$\frac{{n}_{SRS}^{cs , max}}{4} = 3$$

such that the interval is maximized.

The third example 1160 may assume a situation wherein, with regard to an SRS resource including four antenna ports, k̅_{TC}=2 (comb offset value), n_{SRS}^{cs}=6 (cyclic shift value), K_{TC}=4 (comb size value), and n_{SRS}^{cs,max}=12 (maximum cyclic shift value) are configured for the UE. In such a case, the UE may define n_{SRS}^{cs,0}=9 and n_{SRS}^{cs,2}=3 as cyclic shift values allocated with regard to p̅ᵢ=1000 and 1002, respectively, and may define all comb offset values as k_{TC}^{(p}^{ᵢ}⁾=0 with regard to p̅ᵢ=1000 and 1023 (1165). In addition, the UE may define n_{SRS}^{cs,1}=6 and n_{SRS}^{cs,3}=0 as cyclic shift values allocated with regard to p̅ᵢ=1001 and 1003, respectively, and may define all comb offset values as k_{TC}^{(p}^{ᵢ}⁾=2 with regard to p̅ᵢ=1001 and 1003 (1170). Therefore, in order to allocate every two of the four antenna ports to the same comb offset and to separate two antenna ports in the same comb offset, the interval between cyclic shift values corresponding to two antenna ports may be determined to be

$$\frac{{n}_{SRS}^{cs , max}}{2} = 6$$

such that the interval is maximized.

TABLE 33

| | B_{SRS} = 0 | | B_{SRS} = 1 | | B_{SRS} = 2 | | B_{SRS} = 3 | |
|---|---|---|---|---|---|---|---|---|
| C_{SRS} | m_{SRS, 0} | N₀ | m_{SRS, 1} | N₁ | m_{SRS, 2} | N₂ | m_{SRS, 3} | N₃ |
| 0 | 4 | 1 | 4 | 1 | 4 | 1 | 4 | 1 |
| 1 | 8 | 1 | 4 | 2 | 4 | 1 | 4 | 1 |
| 2 | 12 | 1 | 4 | 3 | 4 | 1 | 4 | 1 |
| 3 | 16 | 1 | 4 | 4 | 4 | 1 | 4 | 1 |
| 4 | 16 | 1 | 8 | 2 | 4 | 2 | 4 | 1 |
| 5 | 20 | 1 | 4 | 5 | 4 | 1 | 4 | 1 |
| 6 | 24 | 1 | 4 | 6 | 4 | 1 | 4 | 1 |
| 7 | 24 | 1 | 12 | 2 | 4 | 3 | 4 | 1 |
| 8 | 28 | 1 | 4 | 7 | 4 | 1 | 4 | 1 |
| 9 | 32 | 1 | 16 | 2 | 8 | 2 | 4 | 2 |
| 10 | 36 | 1 | 12 | 3 | 4 | 3 | 4 | 1 |
| 11 | 40 | 1 | 20 | 2 | 4 | 5 | 4 | 1 |
| 12 | 48 | 1 | 16 | 3 | 8 | 2 | 4 | 2 |
| 13 | 48 | 1 | 24 | 2 | 12 | 2 | 4 | 3 |
| 14 | 52 | 1 | 4 | 13 | 4 | 1 | 4 | 1 |
| 15 | 56 | 1 | 28 | 2 | 4 | 7 | 4 | 1 |
| 16 | 60 | 1 | 20 | 3 | 4 | 5 | 4 | 1 |
| 17 | 64 | 1 | 32 | 2 | 16 | 2 | 4 | 4 |
| 18 | 72 | 1 | 24 | 3 | 12 | 2 | 4 | 3 |
| 19 | 72 | 1 | 36 | 2 | 12 | 3 | 4 | 3 |
| 20 | 76 | 1 | 4 | 19 | 4 | 1 | 4 | 1 |
| 21 | 80 | 1 | 40 | 2 | 20 | 2 | 4 | 5 |
| 22 | 88 | 1 | 44 | 2 | 4 | 11 | 4 | 1 |
| 23 | 96 | 1 | 32 | 3 | 16 | 2 | 4 | 4 |
| 24 | 96 | 1 | 48 | 2 | 24 | 2 | 4 | 6 |
| 25 | 104 | 1 | 52 | 2 | 4 | 13 | 4 | 1 |
| 26 | 112 | 1 | 56 | 2 | 28 | 2 | 4 | 7 |
| 27 | 120 | 1 | 60 | 2 | 20 | 3 | 4 | 5 |
| 28 | 120 | 1 | 40 | 3 | 8 | 5 | 4 | 2 |
| 29 | 120 | 1 | 24 | 5 | 12 | 2 | 4 | 3 |
| 30 | 128 | 1 | 64 | 2 | 32 | 2 | 4 | 8 |
| 31 | 128 | 1 | 64 | 2 | 16 | 4 | 4 | 4 |
| 32 | 128 | 1 | 16 | 8 | 8 | 2 | 4 | 2 |
| 33 | 132 | 1 | 44 | 3 | 4 | 11 | 4 | 1 |
| 34 | 136 | 1 | 68 | 2 | 4 | 17 | 4 | 1 |
| 35 | 144 | 1 | 72 | 2 | 36 | 2 | 4 | 9 |
| 36 | 144 | 1 | 48 | 3 | 24 | 2 | 12 | 2 |
| 37 | 144 | 1 | 48 | 3 | 16 | 3 | 4 | 4 |
| 38 | 144 | 1 | 16 | 9 | 8 | 2 | 4 | 2 |
| 39 | 152 | 1 | 76 | 2 | 4 | 19 | 4 | 1 |
| 40 | 160 | 1 | 80 | 2 | 40 | 2 | 4 | 10 |
| 41 | 160 | 1 | 80 | 2 | 20 | 4 | 4 | 5 |
| 42 | 160 | 1 | 32 | 5 | 16 | 2 | 4 | 4 |
| 43 | 168 | 1 | 84 | 2 | 28 | 3 | 4 | 7 |
| 44 | 176 | 1 | 88 | 2 | 44 | 2 | 4 | 11 |
| 45 | 184 | 1 | 92 | 2 | 4 | 23 | 4 | 1 |
| 46 | 192 | 1 | 96 | 2 | 48 | 2 | 4 | 12 |
| 47 | 192 | 1 | 96 | 2 | 24 | 4 | 4 | 6 |
| 48 | 192 | 1 | 64 | 3 | 16 | 4 | 4 | 4 |
| 49 | 192 | 1 | 24 | 8 | 8 | 3 | 4 | 2 |
| 50 | 208 | 1 | 104 | 2 | 52 | 2 | 4 | 13 |
| 51 | 216 | 1 | 108 | 2 | 36 | 3 | 4 | 9 |
| 52 | 224 | 1 | 112 | 2 | 56 | 2 | 4 | 14 |
| 53 | 240 | 1 | 120 | 2 | 60 | 2 | 4 | 15 |
| 54 | 240 | 1 | 80 | 3 | 20 | 4 | 4 | 5 |
| 55 | 240 | 1 | 48 | 5 | 16 | 3 | 8 | 2 |
| 56 | 240 | 1 | 24 | 10 | 12 | 2 | 4 | 3 |
| 57 | 256 | 1 | 128 | 2 | 64 | 2 | 4 | 16 |
| 58 | 256 | 1 | 128 | 2 | 32 | 4 | 4 | 8 |
| 59 | 256 | 1 | 16 | 16 | 8 | 2 | 4 | 2 |
| 60 | 264 | 1 | 132 | 2 | 44 | 3 | 4 | 11 |
| 61 | 272 | 1 | 136 | 2 | 68 | 2 | 4 | 17 |
| 62 | 272 | 1 | 68 | 4 | 4 | 17 | 4 | 1 |
| 63 | 272 | 1 | 16 | 17 | 8 | 2 | 4 | 2 |

TABLE 34

| u | φ(0), . . . , φ(5) | | | | | |
|---|---|---|---|---|---|---|
| 0 | −3 | −1 | 3 | 3 | −1 | −3 |
| 1 | −3 | 3 | −1 | −1 | 3 | −3 |
| 2 | −3 | −3 | −3 | 3 | 1 | −3 |
| 3 | 1 | 1 | 1 | 3 | −1 | −3 |
| 4 | 1 | 1 | 1 | −3 | −1 | 3 |
| 5 | −3 | 1 | −1 | −3 | −3 | −3 |
| 6 | −3 | 1 | 3 | −3 | −3 | −3 |
| 7 | −3 | −1 | 1 | −3 | 1 | −1 |
| 8 | −3 | −1 | −3 | 1 | −3 | −3 |
| 9 | −3 | −3 | 1 | −3 | 3 | −3 |
| 10 | −3 | 1 | 3 | 1 | −3 | −3 |
| 11 | −3 | −1 | −3 | 1 | 1 | −3 |
| 12 | 1 | 1 | 3 | −1 | −3 | 3 |
| 13 | 1 | 1 | 3 | 3 | −1 | 3 |
| 14 | 1 | 1 | 1 | −3 | 3 | −1 |
| 15 | 1 | 1 | 1 | −1 | 3 | −3 |
| 16 | −3 | −1 | −1 | −1 | 3 | −1 |
| 17 | −3 | −3 | −1 | 1 | −1 | −3 |
| 18 | −3 | −3 | −3 | 1 | −3 | −1 |
| 19 | −3 | 1 | 1 | −3 | −1 | −3 |
| 20 | −3 | 3 | −3 | 1 | 1 | −3 |
| 21 | −3 | 1 | −3 | −3 | −3 | −1 |
| 22 | 1 | 1 | −3 | 3 | 1 | 3 |
| 23 | 1 | 1 | −3 | −3 | 1 | −3 |
| 24 | 1 | 1 | 3 | −1 | 3 | 3 |
| 25 | 1 | 1 | −3 | 1 | 3 | 3 |
| 26 | 1 | 1 | −1 | −1 | 3 | −1 |
| 27 | 1 | 1 | −1 | 3 | −1 | −1 |
| 28 | 1 | 1 | −1 | 3 | −3 | −1 |
| 29 | 1 | 1 | −3 | 1 | −1 | −1 |

TABLE 35

| u | φ(0), . . . , φ(11) | | | | | | | | | | | |
|---|---|---|---|---|---|---|---|---|---|---|---|---|
| 0 | −3 | 1 | −3 | −3 | −3 | 3 | −3 | −1 | 1 | 1 | 1 | −3 |
| 1 | −3 | 3 | 1 | −3 | 1 | 3 | −1 | −1 | 1 | 3 | 3 | 3 |
| 2 | −3 | 3 | 3 | 1 | −3 | 3 | −1 | 1 | 3 | −3 | 3 | −3 |
| 3 | −3 | −3 | −1 | 3 | 3 | 3 | −3 | 3 | −3 | 1 | −1 | −3 |
| 4 | −3 | −1 | −1 | 1 | 3 | 1 | 1 | −1 | 1 | −1 | −3 | 1 |
| 5 | −3 | −3 | 3 | 1 | −3 | −3 | −3 | −1 | 3 | −1 | 1 | 3 |
| 6 | 1 | −1 | 3 | −1 | −1 | −1 | −3 | −1 | 1 | 1 | 1 | −3 |
| 7 | −1 | −3 | 3 | −1 | −3 | −3 | −3 | −1 | 1 | −1 | 1 | −3 |
| 8 | −3 | −1 | 3 | 1 | −3 | −1 | −3 | 3 | 1 | 3 | 3 | 1 |
| 9 | −3 | −1 | −1 | −3 | −3 | −1 | −3 | 3 | 1 | 3 | −1 | −3 |
| 10 | −3 | 3 | −3 | 3 | 3 | −3 | −1 | −1 | 3 | 3 | 1 | −3 |
| 11 | −3 | −1 | −3 | −1 | −1 | −3 | 3 | 3 | −1 | −1 | 1 | −3 |
| 12 | −3 | −1 | 3 | −3 | −3 | −1 | −3 | 1 | −1 | −3 | 3 | 3 |
| 13 | −3 | 1 | −1 | −1 | 3 | 3 | −3 | −1 | −1 | −3 | −1 | −3 |
| 14 | 1 | 3 | −3 | 1 | 3 | 3 | 3 | 1 | −1 | 1 | −1 | 3 |
| 15 | −3 | 1 | 3 | −1 | −1 | −3 | −3 | −1 | −1 | 3 | 1 | −3 |
| 16 | −1 | −1 | −1 | −1 | 1 | −3 | −1 | 3 | 3 | −1 | −3 | 1 |
| 17 | −1 | 1 | 1 | −1 | 1 | 3 | 3 | −1 | −1 | −3 | 1 | −3 |
| 18 | −3 | 1 | 3 | 3 | −1 | −1 | −3 | 3 | 3 | −3 | 3 | −3 |
| 19 | −3 | −3 | 3 | −3 | −1 | 3 | 3 | 3 | −1 | −3 | 1 | −3 |
| 20 | 3 | 1 | 3 | 1 | 3 | −3 | −1 | 1 | 3 | 1 | −1 | −3 |
| 21 | −3 | 3 | 1 | 3 | −3 | 1 | 1 | 1 | 1 | 3 | −3 | 3 |
| 22 | −3 | 3 | 3 | 3 | −1 | −3 | −3 | −1 | −3 | 1 | 3 | −3 |
| 23 | 3 | −1 | −3 | 3 | −3 | −1 | 3 | 3 | 3 | −3 | −1 | −3 |
| 24 | −3 | −1 | 1 | −3 | 1 | 3 | 3 | 3 | −1 | −3 | 3 | 3 |
| 25 | −3 | 3 | 1 | −1 | 3 | 3 | −3 | 1 | −1 | 1 | −1 | 1 |
| 26 | −1 | 1 | 3 | −3 | 1 | −1 | 1 | −1 | −1 | −3 | 1 | −1 |
| 27 | −3 | −3 | 3 | 3 | 3 | −3 | −1 | 1 | −3 | 3 | 1 | −3 |
| 28 | 1 | −1 | 3 | 1 | 1 | −1 | −1 | −1 | 1 | 3 | −3 | 1 |
| 29 | −3 | 3 | −3 | 3 | −3 | −3 | 3 | −1 | −1 | 1 | 3 | −3 |

TABLE 36

| u | φ(0), . . . , φ(17) | | | | | | | | | | | | | | | | | |
|---|---|---|---|---|---|---|---|---|---|---|---|---|---|---|---|---|---|---|
| 0 | −1 | 3 | −1 | −3 | 3 | 1 | −3 | −1 | 3 | −3 | −1 | −1 | 1 | 1 | 1 | −1 | −1 | −1 |
| 1 | 3 | −3 | 3 | −1 | 1 | 3 | −3 | −1 | −3 | −3 | −1 | −3 | 3 | 1 | −1 | 3 | −3 | 3 |
| 2 | −3 | 3 | 1 | −1 | −1 | 3 | −3 | −1 | 1 | 1 | 1 | 1 | 1 | −1 | 3 | −1 | −3 | −1 |
| 3 | −3 | −3 | 3 | 3 | 3 | 1 | −3 | 1 | 3 | 3 | 1 | −3 | −3 | 3 | −1 | −3 | −1 | 1 |
| 4 | 1 | 1 | −1 | −1 | −3 | −1 | 1 | −3 | −3 | −3 | 1 | −3 | −1 | −1 | 1 | −1 | 3 | 1 |
| 5 | 3 | −3 | 1 | 1 | 3 | −1 | 1 | −1 | −1 | −3 | 1 | 1 | −1 | 3 | 3 | −3 | 3 | −1 |
| 6 | −3 | 3 | −1 | 1 | 3 | 1 | −3 | −1 | 1 | 1 | −3 | 1 | 3 | 3 | −1 | −3 | −3 | −3 |
| 7 | 1 | 1 | −3 | 3 | 3 | 1 | 3 | −3 | 3 | −1 | 1 | 1 | −1 | 1 | −3 | −3 | −1 | 3 |
| 8 | −3 | 1 | −3 | −3 | 1 | −3 | −3 | 3 | 1 | −3 | −1 | −3 | −3 | −3 | −1 | 1 | 1 | 3 |
| 9 | 3 | −1 | 3 | 1 | −3 | −3 | −1 | 1 | −3 | −3 | 3 | 3 | 3 | 1 | 3 | −3 | 3 | −3 |
| 10 | −3 | −3 | −3 | 1 | −3 | 3 | 1 | 1 | 3 | −3 | −3 | 1 | 3 | −1 | 3 | −3 | −3 | 3 |
| 11 | −3 | −3 | 3 | 3 | 3 | −1 | −1 | −3 | −1 | −1 | −1 | 3 | 1 | −3 | −3 | −1 | 3 | −1 |
| 12 | −3 | −1 | −3 | −3 | 1 | 1 | −1 | −3 | −1 | −3 | −1 | −1 | 3 | 3 | −1 | 3 | 1 | 3 |
| 13 | 1 | 1 | −3 | −3 | −3 | −3 | 1 | 3 | −3 | 3 | 3 | 1 | −3 | −1 | 3 | −1 | −3 | 1 |
| 14 | −3 | 3 | −1 | −3 | −1 | −3 | 1 | 1 | −3 | −3 | −1 | −1 | 3 | −3 | 1 | 3 | 1 | 1 |
| 15 | 3 | 1 | −3 | 1 | −3 | 3 | 3 | −1 | −3 | −3 | −1 | −3 | −3 | 3 | −3 | −1 | 1 | 3 |
| 16 | −3 | −1 | −3 | −1 | −3 | 1 | 3 | −3 | −1 | 3 | 3 | 3 | 1 | −1 | −3 | 3 | −1 | −3 |
| 17 | −3 | −1 | 3 | 3 | −1 | 3 | −1 | −3 | −1 | 1 | −1 | −3 | −1 | −1 | −1 | 3 | 3 | 1 |
| 18 | −3 | 1 | −3 | −1 | −1 | 3 | 1 | −3 | −3 | −3 | −1 | −3 | −3 | 1 | 1 | 1 | −1 | −1 |
| 19 | 3 | 3 | 3 | −3 | −1 | −3 | −1 | 3 | −1 | 1 | −1 | −3 | 1 | −3 | −3 | −1 | 3 | 3 |
| 20 | −3 | 1 | 1 | −3 | 1 | 1 | 3 | −3 | −1 | −3 | −1 | 3 | −3 | 3 | −1 | −1 | −1 | −3 |
| 21 | 1 | −3 | −1 | −3 | 3 | 3 | −1 | −3 | 1 | −3 | −3 | −1 | −3 | −1 | 1 | 3 | 3 | 3 |
| 22 | −3 | −3 | 1 | −1 | −1 | 1 | 1 | −3 | −1 | 3 | 3 | 3 | 3 | −1 | 3 | 1 | 3 | 1 |
| 23 | 3 | −1 | −3 | 1 | −3 | −3 | −3 | 3 | 3 | −1 | 1 | −3 | −1 | 3 | 1 | 1 | 3 | 3 |
| 24 | 3 | −1 | −1 | 1 | −3 | −1 | −3 | −1 | −3 | −3 | −1 | −3 | 1 | 1 | 1 | −3 | −3 | 3 |
| 25 | −3 | −3 | 1 | −3 | 3 | 3 | 3 | −1 | 3 | 1 | 1 | −3 | −3 | −3 | 3 | −3 | −1 | −1 |
| 26 | −3 | −1 | −1 | −3 | 1 | −3 | 3 | −1 | −1 | −3 | 3 | 3 | −3 | −1 | 3 | −1 | −1 | −1 |
| 27 | −3 | −3 | 3 | 3 | −3 | 1 | 3 | −1 | −3 | 1 | −1 | −3 | 3 | −3 | −1 | −1 | −1 | 3 |
| 28 | −1 | −3 | 1 | −3 | −3 | −3 | 1 | 1 | 3 | 3 | −3 | 3 | 3 | −3 | −1 | 3 | −3 | 1 |
| 29 | −3 | 3 | 1 | −1 | −1 | −1 | −1 | 1 | −1 | 3 | 3 | −3 | −1 | 1 | 3 | −1 | 3 | −1 |

TABLE 37

| u | φ(0), . . . , φ(23) | | | | | | | | | | | | | | | | | | | | | | | |
|---|---|---|---|---|---|---|---|---|---|---|---|---|---|---|---|---|---|---|---|---|---|---|---|---|
| 0 | −1 | −3 | 3 | −1 | 3 | 1 | 3 | −1 | 1 | −3 | −1 | −3 | −1 | 1 | 3 | −3 | −1 | −3 | 3 | 3 | 3 | −3 | −3 | −3 |
| 1 | −1 | −3 | 3 | 1 | 1 | −3 | 1 | −3 | −3 | 1 | −3 | −1 | −1 | 3 | −3 | 3 | 3 | 3 | −3 | 1 | 3 | 3 | −3 | −3 |
| 2 | −1 | −3 | −3 | 1 | −1 | −1 | −3 | 1 | 3 | −1 | −3 | −1 | −1 | −3 | 1 | 1 | 3 | 1 | −3 | −1 | −1 | 3 | −3 | −3 |
| 3 | 1 | −3 | 3 | −1 | −3 | −1 | 3 | 3 | 1 | −1 | 1 | 1 | 3 | −3 | −1 | −3 | −3 | −3 | −1 | 3 | −3 | −1 | −3 | −3 |
| 4 | −1 | 3 | −3 | −3 | −1 | 3 | −1 | −1 | 1 | 3 | 1 | 3 | −1 | −1 | −3 | 1 | 3 | 1 | −1 | −3 | 1 | −1 | −3 | −3 |
| 5 | −3 | −1 | 1 | −3 | −3 | 1 | 1 | −3 | 3 | −1 | 1 | −3 | 1 | 3 | 1 | −1 | −3 | −1 | −3 | 1 | −3 | −3 | −3 | −3 |
| 6 | −3 | 3 | 1 | 3 | −1 | 1 | −3 | 1 | −3 | 1 | −1 | −3 | −1 | −3 | −3 | −3 | −3 | −1 | −1 | −1 | 1 | 1 | −3 | −3 |
| 7 | −3 | 1 | 3 | −1 | 1 | −1 | 3 | −3 | 3 | −1 | −3 | −1 | −3 | 3 | −1 | −1 | −1 | −3 | −1 | −1 | −3 | 3 | 3 | −3 |
| 8 | −3 | 1 | −3 | 3 | −1 | −1 | −1 | −3 | 3 | 1 | −1 | −3 | −1 | 1 | 3 | −1 | 1 | −1 | 1 | −3 | −3 | −3 | −3 | −3 |
| 9 | 1 | 1 | −1 | −3 | −1 | 1 | 1 | −3 | 1 | −1 | 1 | −3 | 3 | −3 | −3 | 3 | −1 | −3 | 1 | 3 | −3 | 1 | −3 | −3 |
| 10 | −3 | −3 | −3 | −1 | 3 | −3 | 3 | 1 | 3 | 1 | −3 | −1 | −1 | −3 | 1 | 1 | 3 | 1 | −1 | −3 | 3 | 1 | 3 | −3 |
| 11 | −3 | 3 | −1 | 3 | 1 | −1 | −1 | −1 | 3 | 3 | 1 | 1 | 1 | 3 | 3 | 1 | −3 | −3 | −1 | 1 | −3 | 1 | 3 | −3 |
| 12 | 3 | −3 | 3 | −1 | −3 | 1 | 3 | 1 | −1 | −1 | −3 | −1 | 3 | −3 | 3 | −1 | −1 | 3 | 3 | −3 | −3 | 3 | −3 | −3 |
| 13 | −3 | 3 | −1 | 3 | −1 | 3 | 3 | 1 | 1 | −3 | 1 | 3 | −3 | 3 | −3 | −3 | −1 | 1 | 3 | −3 | −1 | −1 | −3 | −3 |
| 14 | −3 | 1 | −3 | −1 | −1 | 3 | 1 | 3 | −3 | 1 | −1 | 3 | 3 | −1 | −3 | 3 | −3 | −1 | −1 | −3 | −3 | −3 | 3 | −3 |
| 15 | −3 | −1 | −1 | −3 | 1 | −3 | −3 | −1 | −1 | 3 | −1 | 1 | −1 | 3 | 1 | −3 | −1 | 3 | 1 | 1 | −1 | −1 | −3 | −3 |
| 16 | −3 | −3 | 1 | −1 | 3 | 3 | −3 | −1 | 1 | −1 | −1 | 1 | 1 | −1 | −1 | 3 | −3 | 1 | −3 | 1 | −1 | −1 | −1 | −3 |
| 17 | 3 | −1 | 3 | −1 | 1 | −3 | 1 | 1 | −3 | −3 | 3 | −3 | −1 | −1 | −1 | −1 | −1 | −3 | −3 | −1 | 1 | 1 | −3 | −3 |
| 18 | −3 | 1 | −3 | 1 | −3 | −3 | 1 | −3 | 1 | −3 | −3 | −3 | −3 | −3 | 1 | −3 | −3 | 1 | 1 | −3 | 1 | 1 | −3 | −3 |
| 19 | −3 | −3 | 3 | 3 | 1 | −1 | −1 | −1 | 1 | −3 | −1 | 1 | −1 | 3 | −3 | −1 | −3 | −1 | −1 | 1 | −3 | 3 | −1 | −3 |
| 20 | −3 | −3 | −1 | −1 | −1 | −3 | 1 | −1 | −3 | −1 | 3 | −3 | 1 | −3 | 3 | −3 | 3 | 3 | 1 | −1 | −1 | 1 | −3 | −3 |
| 21 | 3 | −1 | 1 | −1 | 3 | −3 | 1 | 1 | 3 | −1 | −3 | 3 | 1 | −3 | 3 | −1 | −1 | −1 | −1 | 1 | −3 | −3 | −3 | −3 |
| 22 | −3 | 1 | −3 | 3 | −3 | 1 | −3 | 3 | 1 | −1 | −3 | −1 | −3 | −3 | −3 | −3 | 1 | 3 | −1 | 1 | 3 | 3 | 3 | −3 |
| 23 | −3 | −1 | 1 | −3 | −1 | −1 | 1 | 1 | 1 | 3 | 3 | −1 | 1 | −1 | 1 | −1 | −1 | −3 | −3 | −3 | 3 | 1 | −1 | −3 |
| 24 | −3 | 3 | −1 | −3 | −1 | −1 | −1 | 3 | −1 | −1 | 3 | −3 | −1 | 3 | −3 | 3 | −3 | −1 | 3 | 1 | 1 | −1 | −3 | −3 |
| 25 | −3 | 1 | −1 | −3 | −3 | −1 | 1 | −3 | −1 | −3 | 1 | 1 | −1 | 1 | 1 | 3 | 3 | 3 | −1 | 1 | −1 | 1 | −1 | −3 |
| 26 | −1 | 3 | −1 | −1 | 3 | 3 | −1 | −1 | −1 | 3 | −1 | −3 | 1 | 3 | 1 | 1 | −3 | −3 | −3 | −1 | −3 | −1 | −3 | −3 |
| 27 | 3 | −3 | −3 | −1 | 3 | 3 | −3 | −1 | 3 | 1 | 1 | 1 | 3 | −1 | 3 | −3 | −1 | 3 | −1 | 3 | 1 | −1 | −3 | −3 |
| 28 | −3 | 1 | −3 | 1 | −3 | 1 | 1 | 3 | 1 | −3 | −3 | −1 | 1 | 3 | −1 | −3 | 3 | 1 | −1 | −3 | −3 | −3 | −3 | −3 |
| 29 | 3 | −3 | −1 | 1 | 3 | −1 | −1 | −3 | −1 | 3 | −1 | −3 | −1 | −3 | 3 | −1 | 3 | 1 | 1 | −3 | 3 | −3 | −3 | −3 |

TABLE 38

| | kₕₒₚ | | |
|---|---|---|---|
| k̅ₕₒₚ | P_{F} = 1 | P_{F} = 2 | P_{F} = 4 |
| 0 | 0 | 0 | 0 |
| 1 | | 1 | 2 |
| 2 | | | 1 |
| 3 | | | 3 |

TABLE 39

| | k_{offset}⁰, . . . , k_{offset}^{N}^{_{symb}}^{^{SRS}}⁻¹ | | | | |
|---|---|---|---|---|---|
| K_{TC} | N_{symb}^{SRS} = 1 | N_{symb}^{SRS} = 2 | N_{symb}^{SRS} = 4 | N_{symb}^{SRS} = 8 | N_{symb}^{SRS} = 12 |
| 2 | 0 | 0, 1 | 0, 1, 0, 1 | | |
| 4 | | 0, 2 | 0, 2, 1, 3 | 0, 2, 1, 3, 0, 2, 1, 3 | 0, 2, 1, 3, 0, 2, 1, 3, 0, 2, 1, 3 |
| 8 | | | 0, 4, 2, 6 | 0, 4, 2, 6, 1, 5, 3, 7 | 0, 4, 2, 6, 1, 5, 3, 7, 0, 4, 2, 6 |

### [SRS: Antenna Switching]

Hereinafter, an SRS for antenna witching will be described.

An SRS transmitted from a UE may be used by a base station to acquire DL channel state information (CSI) (for example, DL CSI acquisition). As a specific example, in a time division duplex (TDD)-based single-cell or multi-cell (for example, carrier aggregation (CA)) situation, the base station (BS) may schedule transmission of an SRS to the user equipment (UE) and may then measure the SRS transmitted from the UE. In this case, the base station may assume reciprocity between the downlink (DL) and uplink (UL) channels, thereby considering uplink channel information estimated based on the SRS transmitted from the UE as downlink channel information, and may perform downlink signal/channel scheduling for the UE by using the same. The base station may configure the usage regarding the SRS for downlink channel information acquisition to be antenna switching, for the UE.

As an example, when following specifications (for example, 3gpp TS38.214), the usage of an SRS may be configured for the base station and/or the UE by using a higher layer parameter (for example, usage of RRC parameter SRS-ResourceSet). The configured usage of an SRS may be beam management usage, codebook transmission usage, non-codebook transmission usage, antenna switching usage, and the like.

In case that parameter “usage” in SRS-ResourceSet (higher layer signaling) is configured as “antennaSwitching” for the UE by the base station, the UE may receive at least one higher layer signaling configuration from the base station according to reported UE capability. The UE may report “supportedSRS-TxPortSwitch” as UE capability, and the value thereof may be as below. In the following, “mTnR” may denote UE capability supporting transmission through m antennas and reception through n antennas.
“t1r2”: a UE capability report value meaning that the UE is capable of a 1T2R operation
“tlr1-t1r2”: a UE capability report value meaning that the UE is capable of a 1T1R or 1T2R operation
“t2r4”: a UE capability report value meaning that the UE is capable of a 2T4R operation
“tlr4”: a UE capability report value meaning that the UE is capable of a 1T4R operation
“t1r6”: a UE capability report value meaning that the UE is capable of a 1T6R operation
“tlr8”: a UE capability report value meaning that the UE is capable of a 1T8R operation
“t2r6”: a UE capability report value meaning that the UE is capable of a 2T6R operation
“t2r8”: a UE capability report value meaning that the UE is capable of a 2T8R operation
“t4r8”: a UE capability report value meaning that the UE is capable of a 4T8R operation
“tr1-t1r2-t1r4”: a UE capability report value meaning that the UE is capable of a 1T1R, 2T2R, or 1T4R operation
“t1r4-t2r4”: a UE capability report value meaning that the UE is capable of a 1T4R or 2T4R operation
“t1r1-t1r2-t2r2-t2r4”: a UE capability report value meaning that the UE is capable of a 1T1R, 1T2R, 2T2R, or 2T4R operation
“t1r1-t1r2-t2r2-t1r4-t2r4”: a UE capability report value meaning that the UE is capable of a 1T1R, 1T2R, 2T2R, 1T4R, or 2T4R operation
“t1r1”: a UE capability report value meaning that the UE is capable of a 1T1R operation
“t2r2”: a UE capability report value meaning that the UE is capable of a 2T2R operation
“t1r1-t2r2”: a UE capability report value meaning that the UE is capable of a 1T1R or 2T2R operation
“t4r4”: a UE capability report value meaning that the UE is capable of a 4T4R operation
“t1r1-t2r2-t4r4”: a UE capability report value meaning that the UE is capable of a 1T1R, 2T2R, 2T2R, or 4T4R operation

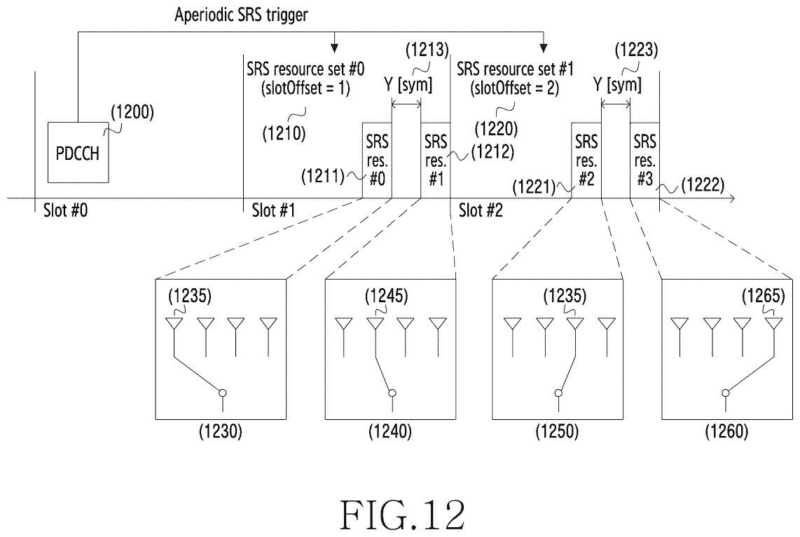

FIG. 12 illustrates an SRS antenna switching operation according to an embodiment of the disclosure.

FIG. 12 illustrates a situation in which a UE operates according to 1T4R, and may have two aperiodic SRS resource sets (for example, SRS resource set #0 and #1) configured therefor. The UE may receive a PDCCH from the base station (1200), and may be instructed to perform an aperiodic SRS trigger with regard to SRS resource set #0 1210 and SRS resource set #1 1220 through the PDCCH. The slot offset value regarding SRS resource set #0 1210 may be configured by slotOffset (higher layer signaling), the value thereof may be 1, and aperiodic SRS transmission regarding SRS resource set #0 may be performed at a location one slot after the slot in which the PDCCH has been received (that is, in slot #1). In addition, the slot offset value regarding SRS resource set #1 1220 may be configured by slotOffset (higher layer signaling), the value thereof may be 2, and aperiodic SRS transmission regarding SRS resource set #1 may be performed at a location two slots after the slot in which the PDCCH has been received (that is, in slot #2).

SRS resource #0 1211 and SRS resource #1 1212 included in SRS resource set #0 1210 are transmitted at different OFDM symbol locations in slot #1, and Y OFDM symbols may exist as a guard interval between SRS resource set #0 and #1 (1213). In addition, during transmission regarding SRS resource set #0 (1230), the UE may connect one SRS port to the first reception antenna port 1235 of the UE, thereby performing SRS transmission. During transmission regarding SRS resource set #1 (1240), the UE may connect one SRS port to the second reception antenna port 1245 of the UE, thereby performing SRS transmission.

SRS resource #2 1221 and SRS resource #3 1222 included in SRS resource set #1 1220 are transmitted at different OFDM symbol locations in slot #1, and Y OFDM symbols may exist as a guard interval between SRS resource set #2 and #3 (1223). In addition, during transmission regarding SRS resource set #2 (1250), the UE may connect one SRS port to the third reception antenna port 1255 of the UE, thereby performing SRS transmission. During transmission regarding SRS resource set #3 (1260), the UE may connect one SRS port to the fourth reception antenna port 1265 of the UE, thereby performing SRS transmission.

By connecting the above-described four SRS resource #0 to #3 to different reception antenna ports of the UE and then transmitting an SRS, the UE may transmit an SRS from all different reception antenna ports such that information regarding channels connected to all reception antennas of the UE can be acquired. The base station may thereby acquire information regarding channels between the base station and the UE and may use the same for uplink or downlink scheduling.

### [Regarding Uplink PTRS]

Higher layer parameter phaseTrackingRS for a PTRS may be configured for the UE on higher layer parameter DMRS-UplinkConfig. When transmitting a PUSCH to the base station, the UE may transmit a phase tracking reference signal (PTRS) for phase tracking regarding an uplink channel. The procedure in which the UE transmits a UL PTRS may be determined whether or not transform precoding is performed during PUSCH transmission. In case that transform precoding is performed, and a transformPrecoderEnabled area is configured in higher layer parameter PTRS-UplinkConfig, sampleDensity in the transformPrecoderEnabled area may indicate a sample density threshold represented by NRB0 to NRB4 in the table below. In case that transform precoding is performed, and a transformPrecoderEnabled area is configured in higher layer parameter PTRS-UplinkConfig, the UE may determine a PT-RS group pattern regarding a scheduled resource NRB according to Table 40. If a transform precoder is additionally applied to PUSCH transmission, the number of bits of the PTRS-DMRS association area for indicating association between the PTRS and DMRS in DCI format 0_1 or 0_2 may be 0.

TABLE 40

| | Number of | Number of samples |
|---|---|---|
| Scheduled bandwidth | PT-RS groups | per PT-RS group |
| N_{RB0} ≤ N_{RB} < N_{RB1} | 2 | 2 |
| N_{RB1} ≤ N_{RB} < N_{RB2} | 2 | 4 |
| N_{RB2} ≤ N_{RB} < N_{RB3} | 4 | 2 |
| N_{RB3} ≤ N_{RB} < N_{RB4} | 4 | 4 |
| N_{RB4} ≤ N_{RB} | 8 | 4 |

In case that transform precoding is not applied to PUSCH transmission, and higher layer parameter phaseTrackingRS is configured for the UE, frequecyDensity in the transformPrecoderDisabled area in higher layer parameter PTRS-UplinkConfig may indicate NRB0 to NRB1, and timeDensity may indicate ptrs-MCS1 to ptrs-MCS3. The UE may determine the PT-RS density in the time domain (LPT-RS) and the PT-RS density (KPT-RS) in the frequency domain, as described in Tables 41 and 42, according to the MCS (IMCS) and RB (NRB) of a scheduled PUSCH. In Table 41, ptrs-MCS4 is not specified as a higher layer parameter, but the base station and the UE may know that the same is 29 or 28 according to the configured MCS table.

TABLE 41

| Scheduled MCS | Time Density (L_{PT-RS}) |
|---|---|
| I_{MCS} < ptrs-MCS₁ | PT-RS is not present |
| ptrs-MCS₁ ≤ I_{MCS} < ptrs-MCS₂ | 4 |
| ptrs-MCS₂ ≤ I_{MCS} < ptrs-MCS₃ | 2 |
| ptrs-MCS₃ ≤ I_{MCS} < ptrs-MCS₄ | 1 |

TABLE 42

| Scheduled bandwidth | Frequency density (K_{PT-RS}) |
|---|---|
| N_{RB} < N_{RB0} | PT-RS is not present |
| N_{RB0} ≤ NRB < N_{RB1} | 2 |
| N_{RB1} ≤ NRB | 4 |

In case that transform precoding is not applied to PUSCH transmission, and PTRS-UplinkConfig is configured, the base station may indicate a two-bit “PTRS-DMRS association” area to the UE in order to indicate association between the PTRS and DMRS in DCI format 0_1 or 0_2. The indicated two-bit PTRS-DMRS association area may be applied to the following Table 43 or 44 according to the maximum port number of the PTRs configured by maxNrofPorts in higher layer parameter PTRS-UplinkConfig. If the maximum PTRS port number is 1, the UE may determine association between the PTRS and DMRS by two bits indicated by the PTRS-DMRS association area and Table 43, and may transmit the PTRS according to the determined association. If the maximum PTRS port number is 2, the UE may determine association between the PTRS and DMRS by two bits indicated by the PTRS-DMRS association area and Table 44, and may transmit the PTRS according to the determined association.

TABLE 43

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

TABLE 44

| Value | | Value | |
|---|---|---|---|
| of MSB | DMRS port | of LSB | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |

The DMRS port in Tables 43 and 44 may be determined through a table determined by a higher layer parameter configuration and an “antenna ports” area indicated by the same DCI as the DCI that indicates PTRS-DMRS association. In case that no transform precoder is configured by a higher configuration of the PUSCH, in case that, with regard to the DMRS, dmrs-Type is configured as 1, and maxLength is configured as 2, and in case that the PUSCH's rank is 2, the UE may determine the DMRS port through a bit indicated by the antenna ports area and a table regarding “antenna port(s)” such as Table 45. In case that a non-codebook-based PUSCH is supported, the UE may determine the value of the rank with reference to the SRI area indicated by the same DCI as the DCI including the “antenna ports” area (that is, in case that no SRI area exists, the rank may be regarded as 1). In case that a codebook-based PUSCH is supported, the UE may determine the value of the rank with reference to the TPMI area indicated by the same DCI as the DCI including the “antenna ports” area. Table 45 is an example of the antenna port table referenced during the PUSCH configuration described above. If the PUSCH has been configured by a different parameter, the DMRS port may be determined according to the bit of the antenna ports area indicated by DCI and the antenna port table that follows the configuration.

TABLE 45

| | Number of DMRS CDM | | Number of front- |
|---|---|---|---|
| Value | group(s) without data | DMRS port(s) | load symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

The 1^{st} scheduled DMRS to 4th scheduled DMRS in Table 43 may be defined as values obtained by successively mapping bits in the antenna ports area of DCI and DMRS ports indicated by an antenna port table that follows a higher layer configuration. For example, if the bit of the antenna ports area of DCI is 0001, and if DMRS ports are determined with reference to Table 45 above, scheduled DMRS ports may be 0 and 1, DMRS port 0 may be defined as the 1^{st} scheduled DMRS, and DMRS port 1 may be defined as the 2^{nd} scheduled DMRS. DMRS ports determined by bits in a different antenna ports area and an antenna port table that follows a different higher layer configuration may be similarly applied. The UE may determine one DMRS port to be associated with a PTRS port with reference to bits indicated by PTRS-DMRS association in DCI from DMRS ports defined as above, and transmits a PTRS according to the determined DMRS port.

In Table 44, the DMRS port that shared TPRS port 0 and the DMRS port that shared TPRS port 1 may be determined according to codebook-based PUSCH transmission or non-codebook-based PUSCH transmission. If the UE transmits a PUSCH based on a partial-coherent or non-coherent codebook, the uplink layer transmitted by PUSCH antenna ports 1000 and 1002 is associated with PTRS port 0, and the uplink layer transmitted by PUSCH antenna ports 1001 and 1003 is associated with PTRS port 1. To describe a more detailed example, if layer 3: TPMI=2 has been selected for codebook-based PUSCH transmission, the first layer is transmitted by PUSCH antenna ports 1000 and 1002 and thus is associated with PTRS port 0. The second layer is transmitted by PUSCH antenna port 1001, the third layer is transmitted by PUSCH antenna port 1002, and the second and third layers are thus associated with PTRS port 1. The three layers refer to respective DMRS ports. The DMRS port regarding the first layer corresponds to “1st DMRS port which shares PTRS port 0” in Table 44. The DMRS port regarding the second layer corresponds to “1st DMRS port which shares PTRS port 1” in Table 44. The DMRS port regarding the third layer corresponds to “2ndt DMRS port which shares PTRS port 1” in Table 44. Similarly, the DMRS port associated with PTRS port 0 and the DMRS port associated with PTRS port 1 may be determined according to a different layer number and a different TPMI. If the UE transmits a PUSCH based on a non-codebook, the DMRS port associated with PTRS port 0 and the DMRS port associated with PTRS port 1 may be distinguished according to the SRI indicated by DCI and antenna ports. To describe a more detailed example, an SRS resource included in an SRS resource set having usage “nonCodebook” is configured regarding whether the same is associated with PTRS port 0 or PTRS port 1 through higher layer parameter ptrs-PortIndex. The base station indicates an SRS resource for transmitting a non-codebook-based PUSCH by the SRI. The port of each indicated SRS resource is mapped to each PUSCH DMRS port one to one. The association between PUSCH DMRS ports and PTRS ports is determined according to higher layer parameter ptrs-PortIndex of SRS resources mapped to DMRS ports. To describe a more detailed example, it is assumed that ptrs-PortIndex is configured as n0, n0, n1, and n1 for SRS resources 1 to 4 included in an SRS resource set having usage nonCodebook, respectively. It is also assumed that transmission of a PUSCH through SRS resources 1, 2, and 4 is indicated by SRI, and DMRS ports 0, 1, and 2 are indicated by the antenna ports area. Respective ports of SRS resources 1, 2, and 4 are mapped to DMRS ports 0, 1, and 2. According to ptrs-PortIndex in SRS resources, DMRS ports 0 and I are associated with PTRS port 0, and DMRS port 2 is associated with PTRS port 1. Therefore, in Table 44, DMRS port 0 corresponds to “1st DMRS port which shares PTRS port 0”, DMRS port 1 corresponds to “2^{nd} DMRS port which shares PTRS port 0”, and DMRS port 2 corresponds to “1st DMRS port which shares PTRS port 1”. Similarly, the DMRS port associated with PTRS port 0 and the DMRS port associated with PTRS port 1 may be determined according to a ptrs-PortIndex configuration method in SRS resources of a different pattern, or a different SRI value. The UE determines the association between DMRS ports and PTRS ports as described above with regard to the two PTRS ports. Thereafter, the UE determines a DMRS port to be associated with PTRS port 0 with reference to the MBS bit of PTRS-DMRS association among multiple DMRS ports associated with respective PTRS ports, and determines a DMRS port to be associated with PTRS port 1 with reference to the LSB bit, thereby transmitting a PTRS.

### [Regarding UE Capability Report]

In LTE and NR, a UE may perform a procedure in which, while being connected to a serving base station, the UE reports capability supported by the UE to the corresponding base station. In the following description, the above-described procedure will be referred to as a UE capability report.

According to an embodiment, the base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times.

According to an embodiment, in next-generation mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

According to an embodiment, upon receiving the UE capability report request from the base station, the UE may configure UE capability according to band information and RAT type requested by the base station. The method in which the UE configures UE capability in an NR system is summarized below.

1. If the UE receives a list regarding LTE and/or NR bands from the base station at a UE capability request, the UE may construct band combinations (BCs) regarding EN-DC and NR standalone (SA). That is, the UE may configure a candidate list of BCs regarding EN-DC and NR SA, based on bands received from the base station at a request through FreqBandList. In addition, bands may have priority in the order described in FreqBandList.

2. If the base station has set “eutra-nr-only” flag or “eutra” flag and requested a UE capability report, the UE may remove everything related to NR SA BCs from the configured BC candidate list. Such an operation may occur only if an LTE base station (eNB) requests “eutra” capability.

3. The UE may then remove fallback BCs from the BC candidate list configured in the above step. As used herein, a fallback BC may refer to a BC that can be obtained by removing a band corresponding to at least one SCell from a specific BC, and since a BC before removal of the band corresponding to at least one SCell can already cover a fallback BC, the same may be omitted. This step is applied in MR-DC as well, that is, LTE bands are also applied. BCs remaining after the above step constitute the final “candidate BC list”.

4. The UE may select BCs appropriate for the requested RAT type from the final “candidate BC list” and select BCs to report. In this step, the UE may configure supportedBandCombinationList in a determined order. That is, the UE configures BCs and UE capability to report according to a preconfigured rat-Type order. (nr->eutra-nr->eutra). In addition, the UE may configure featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be acquired from feature set combinations of containers of UE-NR-Capabilities and UE-MRDC-Capabilities.

5. If the requested RAT type is eutra-nr and has an influence, featureSetCombinations may be included on both containers of UE-MRDC-Capabilities and UE-NR-Capabilities. However, the feature set of NR may be included only in UE-NR-Capabilities.

According to an embodiment, after the UE capability is configured, the UE may transfer a UE capability information message including the UE capability to the base station. The base station may perform scheduling and transmission/reception management appropriate for the UE, based on the UE capability received from the UE.

Hereinafter, embodiments of the disclosure will be described in detail in conjunction with the accompanying drawings. The contents of the disclosure may be applied to frequency division duplex (FDD) and TDD systems. As used herein, upper signaling (or upper layer signaling) is a method for transferring signals from a base station to a UE by using a downlink data channel of a physical layer, or from the UE to the base station by using an uplink data channel of the physical layer, and may also be referred to as “RRC signaling”, “PDCP signaling”, or “medium access control (MAC) control element (MAC CE)”.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

Hereinafter, for the sake of descriptive convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a TRP, a beam, or a TCI state as a whole. Therefore, in actual applications, a TRP, a beam, or a TCI state may be appropriately replaced with one of the above terms.

As used herein, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed, for the sake of descriptive convenience, that NC-JT case refers to a case in which the UE receives a PDSCH to which cooperative communication is applied, based on conditions similar to those described above.

Hereinafter, embodiments of the disclosure will be described in detail in conjunction with the accompanying drawings. Hereinafter, a base station refers to an entity that allocates resources to a terminal, and may be at least one of a gNode B, a gNB, an eNode B, a node B, a base station (BS), a radio access unit, a base station controller, or a node on a network. A terminal may include a user equipment (UE), a mobile station (MS), a cellular phone, a smartphone, a computer, or a multimedia system capable of performing a communication function. In the following description of embodiments of the disclosure, 5G systems will be described by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may be applied to other communication systems through some modifications without significantly departing from the scope of the disclosure. The contents of the disclosure may be applied to FDD and TDD systems.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, upper layer signaling may refer to signaling corresponding to at least one signaling among the following signaling, or a combination of one or more thereof.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof.
Physical downlink control channel (PDCCH)
Downlink control information (DCI)
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
Physical uplink control channel (PUCCH)
Uplink control information (UCI)

Hereinafter, determining priority between A and B may be variously described as, for example, selecting an entity having a higher priority according to a predetermined priority rule and performing an operation corresponding thereto, or omitting or dropping operations regarding an entity having a lower priority.

As used herein, the term “slot” may generally refer to a specific time unit corresponding to a transmit time interval (TTI), may specifically refer to a slot used in a 5G NR system, or may refer to a slot or a subframe used in a 4G LTE system.

Hereinafter, the above examples may be described through multiple embodiments, but they are not independent of each other, and one or more embodiments may be applied simultaneously or in combination.

### First Embodiment: A Method for Supporting a Codebook-Usage SRS for a UE Supporting Three Transmission Antennas

In an embodiment of the disclosure, a method for supporting a codebook-usage SRS for a UE supporting three transmission antennas will be described. This embodiment may operate in combination with at least one other embodiment described in the disclosure.

As described above, for codebook-based PUSCH transmission, “codebook” may be configured for the UE with regard to txConfig (higher layer signaling). In addition, the base station may configure, for the UE, an SRS resource set having usage (higher layer signaling) configured as “codebook”, and the UE may have a maximum of two SRS resources configured in the configured SRS resource set. SRS resources that may be configured such that a UE supporting three transmission antennas transmits a codebook-based PUSCH may follow a combination of at least one of the methods described below:

### Method 1-1

According to an embodiment of the disclosure, an SRS resource configured by four antenna ports may be configured for the UE in order to perform codebook-based PUSCH transmission through three antenna ports. More specifically, the UE may expect that a maximum of two SRS resources configured by four antenna ports will be configured in a configured SRS resource set, the usage of which is configured as a codebook. That is, the SRS resource set, the usage of which is configured as a codebook, may include a maximum of two SRS resources configured by four antenna ports. The UE may not perform transmission with regard to one of the four antenna ports constituting the SRS resources. One antenna port not to be transmitted by the UE may be determined to be the last antenna port (for example, antenna port 1003) among the four antenna ports constituting (included in) the SRS resources. Alternatively, one antenna port not to be transmitted by the UE may be determined to be the first antenna port (for example, antenna port 1000) among the four antenna ports constituting (included in) the SRS resources. Alternatively, one antenna port not to be transmitted by the UE may be determined to be any antenna port that may be defined by specifications among the four antenna ports constituting (included in) the SRS resources (for example, antenna port 1002 or any antenna port among antenna ports 1000 to 1003). Alternatively, one antenna port not to be transmitted by the UE may be determined to be any antenna port determined according to a notification (for example, a combination of a least one of higher layer signaling, MAC-CE signaling, and L1 signaling) from the base station among the four antenna ports constituting (included in) the SRS resources (for example, the base station may determine that antenna port 1002 is not to be transmitted through higher layer signaling).

Hereinafter, in the disclosure, the description that the UE does not perform transmission with regard to a specific antenna port related to an SRS resource may mean that the UE does not perform SRS transmission in the specific antenna port. In addition, in the disclosure, the description that a specific antenna port related to an SRS resource is not transmitted may mean that the UE does not perform SRS transmission in the specific antenna port.

Hereinafter, in the disclosure, the description that the UE performs transmission with regard to a specific antenna port related to an SRS resource may mean that the UE performs SRS transmission in the specific antenna port. In addition, in the disclosure, the description that a specific antenna port related to an SRS resource is transmitted may mean that the UE performs SRS transmission in the specific antenna port.

According to an embodiment of the disclosure, in case that the UE does not perform transmission with regard to the last antenna port (for example, antenna port 1003) with regard to an SRS resource configured by four antenna ports, the UE may transmit an SRS in allocated time and frequency resources (SRS resources), by using only comb offset and cyclic shift values obtained by allocating an SRS sequence produced based on the SRS resource to antenna ports 1000, 1001, and 1002. The UE and the base station may assume that the antenna port related to the SRS transmitted by the UE is identical to the PUSCH antenna port that may be scheduled by the base station, based on the SRS transmitted by the UE. Therefore, in case that there are three antenna ports (for example, 1000, 1001, and 1002) of the PUSCH transmitted from the UE in consideration of three transmission antennas, not transmitting the last antenna port 1003 among the four antenna ports with regard to an SRS resource having four antenna ports (transmitting no SRS in the last antenna port 1003) may be the simplest method from the viewpoint of the single UE and the base station, which can maintain connection/association between an SRS antenna port and a PUSCH antenna port. The connection/association between an SRS antenna port and a PUSCH antenna port may mean an assumption that the antenna port related to the SRS transmitted by the UE is identical to the PUSCH antenna port that may be scheduled by the base station, based on the SRS transmitted by the UE. Maintaining the connection/association between an SRS antenna port and a PUSCH antenna port may mean that the port number of antenna ports constituting the SRS antenna port is identical to the port number of antenna ports constituting the PUSCH antenna port. For example, if the port number of antenna ports constituting the SRS antenna port is 1000, 1001, and 1002, the connection/association between the SRS antenna port and the PUSCH antenna port may be maintained in case that the port number of antenna ports constituting the PUSCH antenna port is also 1000, 1001, and 1002. As another example, if the port number of antenna ports constituting the SRS antenna port is 1001, 1002, and 1003, the connection/association between the SRS antenna port and the PUSCH antenna port may not be maintained in case that the port number of antenna ports constituting the PUSCH antenna port is also 1000, 1001, and 1002. Meanwhile, a failure to perform SRS transmission in a fixed manner with regard to a specific antenna port may degrade flexibility from the viewpoint of the base station's scheduling.

According to an embodiment of the disclosure, in case that a different antenna port other than the last antenna port with regard to an SRS resource configured by four antenna ports is not transmitted (that is, in case that, among four antenna ports constituting an SRS resource, an SRS is not transmitted in a different antenna port other than the last antenna port), the UE may readjust/resort/renumber the number of remaining antenna ports other than the antenna port in which transmission is not performed to 1000, 1001, and 1002. As an example, in case that the UE does not transmit the first antenna port (for example, antenna port 1000), the UE may readjust/resort/renumber the remaining antenna ports 1001, 1002, and 1003 to 1000, 1002, and 1002, respectively, may produce an SRS sequence, and may transmit an SRS in allocated time and frequency resources (SRS resources) by using comb offset and cyclic shift values. As another example, in case that the UE does not perform transmission in the second antenna port (for example, antenna port 1001), the UE may readjust/resort/renumber, among the remaining antenna ports 1000, 1002, and 1003, 1002 to 1001 and 1003 to 1002. As another example, in case that the UE does not perform transmission in the third antenna port (for example, antenna port 1002), the UE may readjust/resort/renumber, among the remaining antenna ports 1000, 1001, and 1003, 1003 to 1002. As another example, in case that the UE does not perform transmission in the fourth antenna port (for example, antenna port 1003), the UE may not perform readjusting/resorting/renumbering because the remaining antenna ports are 1000, 1001, and 1002. Antenna port number readjusting may be a method in which the connection/association between SRS and PUSCH antenna ports can be maintained, but the same effect may be obtained as in the above-described method in which transmission is not performed in the last antenna port, from the viewpoint of allocating resources from the base station to multiple UEs, and the base station's scheduling flexibility may thus be degraded similarly to the above-described method.

According to an embodiment of the disclosure, in case that the UE does not transmit a different antenna port other than the last antenna port with regard to an SRS resource configured by four antenna ports, the UE may not readjust/resort/renumber the number of remaining antenna ports other than the antenna port which is not transmitted to 1000, 1001, and 1002. As an example, in case that the UE does not transmit the first antenna port (for example, antenna port 1000), the UE may produce an SRS sequence based on an assumption that an SRS is transmitted in the remaining antenna ports 1001, 1002, and 1003, and may perform transmission in allocated time and frequency resources (SRS resources) by using comb offset and cyclic shift values. In such a case, PUSCH antenna ports are 1000, 1001, and 1002, while SRS antenna ports are 1001, 1002, and 1003, and the assumption between the base station and the UE that the PUSCH's antenna port and the SRS's antenna port are identical is invalidated. This may require an additional definition regarding the connectivity/association between the PUSCH's antenna port and the SRS's antenna port. As an example, a connectivity may be defined between PUSCH antenna ports and SRS antenna ports such that they are associated one to one in ascending order from the lowest antenna port number. That is, according to the additional connectivity, assuming that the individual connectivity between ports is (PUSCH antenna ports<->SRS antenna ports), the entire additional connectivity may include individual associations between ports such as (1000<->1001), (1001<->1002), (1002<->1003). According to an embodiment of the disclosure, it may be possible to flexibly allocate a different UE's antenna port according to the scheduling situation from the viewpoint of allocating resources from the base station to multiple UEs.

[Method 1-1] above may not only be applied to a UE having three transmission antennas, but may also be similarly applied to a case in which UEs having 5, 6, and 7 transmission antennas define SRS resources to perform codebook-based PUSCH transmission. As an example, in case that UEs have 5, 6, and 7 transmission antennas, the same may not perform transmission with regard to three antenna ports, two antenna ports, and one antenna port, respectively, with regard to an SRS resource configured by eight antenna ports. Regarding how to select three antenna ports, two antenna ports, and one antenna port, respectively, the above method in which one of four antenna ports is not transmitted may be reused.

### Method 1-2

According to an embodiment of the disclosure, in order to perform codebook-based PUSCH transmission through three antenna ports, a UE may perform uplink channel estimation regarding the three antenna ports by using one SRS resource configured by one antenna port and one SRS resource configured by two antenna ports. That is, the UE may transmit an SRS to a base station through three antenna ports by using one SRS resource configured by one antenna port and one SRS resource configured by two antenna ports, and the base station may perform uplink channel estimation by using the SRS transmitted through three antenna ports. The UE may consider that, in an SRS resource set having a “codebook” usage, an SRS resource configured by one antenna port and an SRS resource configured by two antenna ports constitute one SRS resource group, and the UE may expect that a maximum of two SRS resource groups each including an SRS resource configured by one antenna port and an SRS resource configured by two antenna ports will be configured. As an example, in case that first and third SRS resources each configured by one antenna port and second and fourth SRS resources each configured by two antenna ports are configured for the UE, the UE may consider that the first and second SRS resources constitute a first SRS resource group and may use the same during channel estimation regarding three antenna ports. In addition, the UE may consider that the third and fourth SRS resources constitute a second SRS resource group and may likewise use the same during channel estimation regarding three antenna ports.

Instead of indicating SRS resources through the SRI field in DCI, the base station may indicate each SRS resource group to the UE. As an example, in case that first to fourth SRS resources are configured for the UE as described above, first and second SRS resources are defined as a first SRS resource group, and third and fourth SRS resources are defined as a second SRS resource group, the UE may assume that the first and second codepoints in the SRI field indicate the first and second SRS resource groups, respectively.

### Method 1-3

According to an embodiment of the disclosure, in order to perform codebook-based PUSCH transmission through three antenna ports, a UE may define an SRS resource configured by three antenna ports and may perform uplink channel estimation regarding the three antenna ports. That is, an SRS resource configured by three antenna ports may be defined/configured, an SRS may be transmitted to a base station through the three antenna ports on one SRS resource configured by three antenna ports, and the base station may perform uplink channel estimation by using the SRS transmitted through the three antenna ports on one SRS resource. The three antenna ports that may be included in the SRS resource may be 1000, 1001, and 1002, respectively. The UE may expect that, in an SRS resource set having a “codebook” usage, a maximum of two SRS resources each configured by three antenna ports will be configured. One comb offset value and one cyclic shift value, which may be commonly applied to the three antenna ports, may be configured for the UE. For example, in case that a first SRS resource including three antenna ports and a second SRS resource including three antenna ports are configured, a first comb offset value and a first cyclic shift value may be configured with regard to the three antenna ports included in the first SRS resource, and a second comb offset value and a second cyclic shift value may be configured with regard to the three antenna ports included in the second SRS resource.

According to an embodiment of the disclosure, in case that the comb size is 2 (for example, K_{TC}=2, that is, n_{SRS}^{cs,max}=8 according to Table 32 above), the UE may determine the comb offset and cyclic shift values of antenna ports 1000, 1001, and 1002 by using a combination of at least one of the following embodiments:
According to an embodiment of the disclosure, in case that p̅ᵢ∈{1000,1001,1002}, the UE may define k_{TC}^{(p}^{ᵢ}⁾=k̅_{TC}, and k̅_{TC}∈{0, 1, . . . , K_{TC}−1} may be configured by higher layer signaling. That is, the UE may transmit three antenna ports 1000, 1001, and 1002 at the same RE location by distinguishing the same with different cyclic shift values, thereby guaranteeing excellent frequency resource allocation efficiency. With regard to the cyclic shift value regarding p̅ᵢ∈{1000,1001,1002}, the UE may define and use

$${n}_{SRS}^{cs , i} = ( {n}_{SRS}^{cs} + ⌊ \frac{{n}_{SRS}^{cs , max} ( {\overline{p}}_{i} - 1000 )}{{\overline{N}}_{ap}^{SRS}} ⌋ ) mod {n}_{SRS}^{cs , max} ,$$

and n_{SRS}^{cs}∈{0, 1, . . . n_{SRS}^{cs,max}−1} may be configured by higher layer signaling. N̅ₐₚ^{SRS} is the number of SRS antenna ports (=3), and n_{SRS}^{cs,max}=8. For example, in case that n_{SRS}^{cs}=0, the cyclic shift value regarding antenna ports 1000, 1001, and 1002 may be 0, 2, and 5, respectively. Hereinafter, when calculating the cyclic shift interval between antenna ports, the tendency that, if the cyclic shift value has reached the maximum value, the cyclic shift value returns to 0, may be used. More specifically, in case that the maximum value of cyclic shift is 8, the cyclic shift value may be 0,1,2,3,4,5,6,7 and then return to 0. In such a case, the cyclic shift interval between antenna ports 1000 and 1001 may be 2 (2−0=2), the cyclic shift interval between antenna ports 1001 and 1002 may be 3 (5−2=3), and the cyclic shift interval between antenna ports 1002 and 1000 may be 5 (8−5=3) (that is, when calculating the cyclic shift interval between antenna ports 1002 and 1000, the cyclic shift value of port 1000 is 0, but is assumed to be 8). As a result, a non-uniform cyclic shift interval may occur, and the performance of channel estimation between antenna ports may thus differ. In another method, with regard to the cyclic shift value regarding p̅ᵢ∈{1000,1001,1002}, the UE may define and use

$${n}_{SRS}^{cs , i} = ( {n}_{SRS}^{cs} + ⌊ \frac{{n}_{SRS}^{cs , max} ( {\overline{p}}_{i} - 1000 )}{{\overline{N}}_{ap}^{SRS}} ⌋ ) mod {n}_{SRS}^{cs , max} .$$

In case that n_{SRS}^{cs}=0, the cyclic shift value regarding antenna ports 1000, 1001, and 1002 may be 0, 3, and 6. Hereinafter, when calculating the cyclic shift interval between antenna ports, the tendency that, if the cyclic shift value has reached the maximum value, the cyclic shift value returns to 0, may be used. More specifically, in case that the maximum value of cyclic shift is 8, the cyclic shift value may be 0,1,2,3,4,5,6,7 and then return to 0. In such a case, similarly, the cyclic shift interval between antenna ports 1000 and 1001 may be 3, the cyclic shift interval between antenna ports 1001 and 1002 may be 3, and the cyclic shift interval between antenna ports 1002 and 1000 may be 2 (8−6=2) (that is, when calculating the cyclic shift interval between antenna ports 1002 and 1000, the cyclic shift value of port 1000 is 0, but is assumed to be 8). As a result, a non-uniform cyclic shift interval may occur, and the performance of channel estimation between antenna ports may thus differ.
According to an embodiment of the disclosure, in case that p̅ᵢ∈{1001}, the UE may define

$${k}_{TC}^{( {p}_{i} )} = ( {\overline{k}}_{TC} + \frac{{K}_{TC}}{2} )$$

mod K_{TC}, and in case that p̅ᵢ∈{1000, 1002}, may define k_{TC}^{(p}^{ᵢ}⁾=K̅_{TC}. That is, the UE may transmit antenna ports 1000 and 1002 at the same RE location by distinguishing the same with different cyclic shift values, and may transmit antenna port 1001 at a different RE location. Accordingly, twice the frequency resource is used, but the cyclic shift interval between two antenna ports allocated in the same RE may be maximized. With regard to the cyclic shift value regarding p̅ᵢ∈{1000,1001,1002}, the UE may define and use

$${n}_{SRS}^{cs , i} = ( {n}_{SRS}^{cs} + \frac{{n}_{SRS}^{cs , max} ⌊ \frac{{\overline{p}}_{i} - 1000}{2} ⌋}{⌈ \frac{{\overline{N}}_{ap}^{SRS}}{2} ⌉} ) mod {n}_{S R S}^{cs , max} .$$

As an example, in case that k̅_{TC}=0, n_{SRS}^{cs}=0, the cyclic shift value regarding antenna ports 1000 and 1002 at comb offset 0 location may be 0 and 4, respectively, and the cyclic shift value regarding antenna port 1001 at comb offset 1 location may be 0. In such a case, the cyclic shift interval between antenna ports 1000 and 1002 is 4, and in case that there is no different SRS transmission allocation from the base station, a different cyclic shift value is not allocated to antenna port 1001. Accordingly, the performance of channel estimation between antenna ports may differ. In addition, even if transmitted at different comb offset locations, the interval between comb offsets is merely one. Therefore, if the cyclic shift value regarding antenna port 1000 at comb offset 0 and the cyclic shift value regarding antenna port 1001 at comb offset 1 are both 0, distinction between antenna ports during channel estimation may become difficult. Therefore, in case that the UE defines and use the cyclic shift value of p̅ᵢ∈{1000,1001,1002} as

$${n}_{SRS}^{cs , i} = ( {n}_{SRS}^{cs} + \frac{{n}_{SRS}^{cs , max} ⌈ \frac{{\overline{p}}_{i} - 1000}{2} ⌉}{⌈ \frac{{\overline{N}}_{a p}^{S R S}}{2} ⌉} + \frac{{{k}_{T C}^{( {p}_{i} )}}_{{n}_{SRS}^{cs , max}}}{2} ) mod {n}_{S R S}^{cs , max} ,$$

and in case that k̅_{TC}=0, n_{SRS}^{cs}=0, the cyclic shift value regarding antenna ports 1000 and 1002 at comb offset 0 location may be 0 and 4, respectively, and the cyclic shift value regarding antenna port 1001 at comb offset 1 location may be 8. Therefore, clear distinction between antenna ports during channel estimation may be made by allocating cyclic shift values at respective comb offsets so as to not to overlap each other, even if the difference in comb offset is 1.

In case that the comb size is 4 (for example, K_{TC}=4, that is, n_{SRS}^{cs,max}=12 according to Table 32 above), the UE may determine the comb offset value of antenna ports 1000, 1001, and 1002 by using a combination of at least one of the following embodiments:
According to an embodiment of the disclosure, in case that p̅ᵢ∈{1000,1001,1002}, the UE may define k_{TC}^{(p}^{ᵢ}⁾=k̅_{TC}, and k̅_{TC}∈{0, 1, . . . , K_{TC}−1} may be configured by higher layer signaling. That is, the UE may transmit three antenna ports 1000, 1001, and 1002 at the same RE location by distinguishing the same with different cyclic shift values, thereby guaranteeing excellent frequency resource allocation efficiency. With regard to the cyclic shift value regarding p̅ᵢ∈{1000,1001,1002} the UE may define and use

$${n}_{SRS}^{cs , i} = ( {n}_{SRS}^{c s} + \frac{{n}_{SRS}^{cs , max} ( {\overline{p}}_{i} - 1000 )}{{\overline{N}}_{a p}^{S R S}} ) mod {n}_{S R S}^{cs , max} ,$$

and n_{SRS}^{cs}∈{0, 1, . . . , n_{SRS}^{cs,max}−1} may be configured by higher layer signaling. As an example, in case that n_{SRS}^{cs}=0, the cyclic shift value regarding antenna ports 1000, 1001, and 1002 may be 0, 4, and 8, respectively. Hereinafter, when calculating the cyclic shift interval between antenna ports, the tendency that, if the cyclic shift value has reached the maximum value, the cyclic shift value returns to 0, may be used. More specifically, in case that the maximum value of cyclic shift is 12, the cyclic shift value may be 0,1,2,3,4,5,6,7, 8, 9, 10, 11 and then return to 0. In such a case, the interval between two antenna ports among the three antenna ports may be equally 4 (that is, when calculating the cyclic shift interval between ports 1002 and 1000, the cyclic shift value of port 1000 is 0, but is assumed to be 12), and the performance of channel estimation between antenna ports may be similar.
According to an embodiment of the disclosure, in case that p̅ᵢ∈{1001}, the UE may define

$${k}_{T C}^{( {p}_{i} )} = ( {\overline{k}}_{T C} + \frac{{K}_{T C}}{2} ) mod {K}_{T C} ,$$

and in case that p̅ᵢ∈{1000, 1002}, may define k_{TC}^{(p}^{ᵢ}⁾=k̅_{TC}. That is, the UE may transmit antenna ports 1000 and 1002 at the same RE location by distinguishing the same with different cyclic shift values, and may transmit antenna port 1001 at a different RE location. Accordingly, twice the frequency resource is used, but the cyclic shift interval between two antenna ports allocated in the same RE may be maximized. With regard to the cyclic shift value regarding p̅ᵢ∈{1000,1001,1002}, the UE may define and use

$${n}_{SRS}^{cs , i} = ( {n}_{SRS}^{cs} + \frac{{n}_{SRS}^{cs , max} ⌊ \frac{{\overline{p}}_{i} - 1000}{2} ⌋}{⌈ \frac{{\overline{N}}_{ap}^{SRS}}{2} ⌉} ) mod {n}_{S R S}^{cs , max} .$$

As an example, in case that k̅_{TC}=0, n_{SRS}^{cs}=0, the cyclic shift value regarding antenna ports 1000 and 1002 at comb offset 0 location may be 0 and 6, respectively, and the cyclic shift value regarding antenna port 1001 at comb offset 2 location may be 0. In such a case, the cyclic shift interval between antenna ports 1000 and 1002 is 6, and in case that there is no different SRS transmission allocation from the base station, a different cyclic shift value is not allocated to antenna port 1001, and the performance of channel estimation between antenna ports may thus differ.
According to an embodiment of the disclosure, in case that p̅ᵢ∈{1000,1001,1002}, the UE may define

$${k}_{T C}^{( {p}_{i} )} = ( {\overline{k}}_{T C} + ⌊ \frac{{K}_{T C}}{3} ⌋ ( {p}_{i} - 1000 ) ) mod {K}_{T C} .$$

That is, the UE uses RE resources by transmitting respective antenna ports at different comb offset locations, but different antenna ports are not allocated in the same RE. Therefore, the base station may perform appropriate cyclic shift allocation regarding different SRS transmissions, thereby maximizing the cyclic shift interval. With regard to the cyclic shift value regarding p̅ᵢ∈{1000,1001,1002}, the UE may define and use n_{SRS}^{cs,i}=n_{SRS}^{cs}. As an example, in case that k̅_{TC}=0, n_{SRS}^{cs}=0, the cyclic shift value regarding antenna ports 1000, 1001, and 1002 at comb offset 0, 1, and 2 locations, respectively, may all be 0. In such a case, a different cyclic shift value is not allocated to antenna ports 1000, 1001, and 1002 in case that there is no different SRS transmission allocation from the base station. Therefore, the performance of channel estimation between antenna ports may be similar in case that the base station uniformly performs different SRS transmission allocations with regard to respective REs. In addition, even if an SRS is transmitted at different comb offset locations, the interval between comb offsets is merely one. Therefore, if the cyclic shift value regarding antenna ports 1000, 1001, and 1002 at comb offsets 0, 1, and 2, respectively, is equally 0 as in the above-described method, distinction between antenna ports during channel estimation may become difficult. Therefore, in case that the UE defines and use the cyclic shift value of p̅ᵢ∈{1000,1001,1002} as

$${n}_{S R S}^{cs , i} = ( {n}_{S R S}^{c s} + \frac{{n}_{S R S}^{cs , max} ( {\overline{p}}_{ι} - 1000 )}{{\overline{N}}_{a p}^{S R S}} ) mod {n}_{S R S}^{c s ,} ,$$

and in case that k̅_{TC}=0, n_{SRS}^{cs}=0, the cyclic shift value regarding antenna ports 1000, 1001, and 1002 at comb offsets 0, 1, and 2, respectively, may be 0, 4, and 8, respectively. Therefore, clear distinction between antenna ports during channel estimation may be possible by allocating cyclic shift values at respective comb offsets so as to not to overlap each other, even if the difference in comb offset is 1.

According to an embodiment of the disclosure, in case that the comb size is 8 (for example, K_{TC}=8, that is, n_{SRS}^{cs,max}=6 according to Table 32 above), the UE may determine the comb offset value of antenna ports 1000, 1001, and 1002 by using a combination of at least one of the following embodiments:
According to an embodiment of the disclosure, in case that p̅ᵢ∈{1000,1001,1002}, the UE may define k_{TC}^{(p}^{ᵢ}⁾=k̅_{TC}, and k̅_{TC}∈{0,1, . . . , K_{TC}−1} may be configured by higher layer signaling. That is, the UE may transmit three antenna ports 1000, 1001, and 1002 at the same RE location by distinguishing the same with different cyclic shift values, thereby guaranteeing excellent frequency resource allocation efficiency. With regard to the cyclic shift value regarding p̅ᵢ∈{1000,1001,1002}, the UE may define and use

$${n}_{S R S}^{cs , i} = ( {n}_{S R S}^{c s} + \frac{{n}_{S R S}^{cs , max} ( {\overline{p}}_{i} - 1000 )}{{\overline{N}}_{a p}^{S R S}} ) mod {n}_{S R S}^{cs , max} ,$$

and n_{SRS}^{cs}∈{0, 1, . . . , n_{SRS}^{cs,max}−1} may be configured by higher layer signaling. As an example, in case that n_{SRS}^{cs}=0, the cyclic shift value regarding antenna ports 1000, 1001, and 1002 may be 0, 2, and 4, respectively. In such a case, the interval between two antenna ports among the three antenna ports may be equally 2, and the performance of channel estimation between antenna ports may thus be similar.
According to an embodiment of the disclosure, in case that p̅ᵢ∈{1001}, the UE may define

$${k}_{T C}^{( {p}_{i} )} = ( {\overline{k}}_{T C} + \frac{{K}_{T C}}{2} ) mod {K}_{T C} ,$$

and in case that p̅ᵢ∈{1000, 1002}, may define k_{TC}^{(p}^{ᵢ}⁾=k̅_{TC}. That is, the UE may transmit antenna ports 1000 and 1002 at the same RE location by distinguishing the same with different cyclic shift values, and may transmit antenna port 1001 at a different RE location. Accordingly, twice the frequency resource is used, but the cyclic shift interval between two antenna ports allocated in the same RE may be maximized. With regard to the cyclic shift value regarding p̅ᵢ∈{1000,1001,1002}, the UE may define and use

$${n}_{S R S}^{cs , i} = ( {n}_{S R S}^{c s} + \frac{{n}_{S R S}^{cs , max} ( \frac{{\overline{p}}_{i} - 1000}{2} )}{\frac{{\overline{N}}_{a p}^{S R S}}{2}} ) mod {n}_{S R S}^{cs , max} .$$

As an example, in case that k̅_{TC}=0, n_{SRS}^{cs}=0, the cyclic shift value regarding antenna ports 1000 and 1002 at comb offset 0 location may be 0 and 3, respectively, and the cyclic shift value regarding antenna port 1001 at comb offset 4 location may be 0. In such a case, the cyclic shift interval between antenna ports 1000 and 1002 is 3, and in case that there is no different SRS transmission allocation from the base station, a different cyclic shift value is not allocated to antenna port 1001. Therefore, the performance of channel estimation between antenna ports may differ.
According to an embodiment of the disclosure, in case that p̅ᵢ∈{1000,1001,1002}, the UE may define

$${k}_{T C}^{( {p}_{i} )} = ( {\overline{k}}_{T C} + ⌊ \frac{{K}_{T C}}{3} ⌋ ( {p}_{i} - 1000 ) ) mod {K}_{T C} .$$

That is, the UE uses three times the RE resource by transmitting respective antenna ports at different comb offset locations, but different antenna ports are not allocated in the same RE. Therefore, the base station may perform appropriate cyclic shift allocation regarding different SRS transmissions, thereby maximizing the cyclic shift interval. With regard to the cyclic shift value regarding p̅ᵢ∈{1000,1001,1002}, the UE may define and use n_{SRS}^{cs,i}=n_{SRS}^{cs}. As an example, in case that k̅_{TC}=0, n_{SRS}^{cs}=0, the cyclic shift value regarding antenna ports 1000, 1001, and 1002 at comb offset 0, 2, and 4 locations, respectively, may all be 0. In such a case, a different cyclic shift value is not allocated to antenna ports 1000, 1001, and 1002 in case that there is no different SRS transmission allocation from the base station. Therefore, the performance of channel estimation between antenna ports may be similar in case that the base station uniformly performs different SRS transmission allocations with regard to respective REs. In addition, even if an SRS is transmitted at different comb offset locations, the interval between comb offsets is merely two. Therefore, if the cyclic shift value regarding antenna ports 1000, 1001, and 1002 at comb offsets 0, 1, and 2, respectively, is equally 0 as in the above-described method, distinction between antenna ports during channel estimation may become difficult. Therefore, in case that the UE defines and use the cyclic shift value of p̅ᵢ∈{1000,1001,1002} as

$${n}_{S R S}^{cs , i} = ( {n}_{S R S}^{c s} + \frac{{n}_{S R S}^{cs , max} ( {\overline{p}}_{ι} - 1000 )}{{\overline{N}}_{a p}^{S R S}} ) mod {n}_{S R S}^{c s ,} ,$$

and in case that k̅_{TC}=0, n_{SRS}^{cs}=0, the cyclic shift value regarding antenna ports 1000, 1001, and 1002 at comb offsets 0, 1, and 2, respectively, may be 0, 2, and 4, respectively. Therefore, clear distinction between antenna ports during channel estimation may be possible by allocating cyclic shift values at respective comb offsets so as to not to overlap each other, even if the difference in comb offset is 2.

### Method 1-4

According to an embodiment of the disclosure, in order to perform codebook-based PUSCH transmission through three antenna ports, a UE may define an SRS resource configured by three antenna ports and may perform uplink channel estimation regarding the three antenna ports. That is, an SRS resource configured by three antenna ports may be defined/configured, an SRS may be transmitted to a base station through the three antenna ports on one SRS resource configured by three antenna ports, and the base station may perform uplink channel estimation by using the SRS transmitted through the three antenna ports on one SRS resource. The three antenna ports that may be included in the SRS resource may be 1000, 1001, and 1002, respectively. The UE may expect that, in an SRS resource set having a “codebook” usage, a maximum of two SRS resources each configured by three antenna ports will be configured.

Multiple comb offset value and cyclic shift values may be configured for the UE with regard to each of the three antenna ports. In case that two comb offset values and two cyclic shift values are configured for the UE, the UE may use a method in which a comb offset and a cyclic shift are allocated to each antenna port in an SRS resource that may be configured by one antenna port, by using the first comb offset value and the first cyclic shift value, thereby applying comb offset and cyclic shift values to one of the three antennas (for example, to antenna port 1001). In addition, the UE may use a method in which a comb offset and a cyclic shift are allocated to each antenna port in an SRS resource that may be configured by two antenna ports, by using the second comb offset value and the second cyclic shift value, thereby applying the second comb offset value and the second cyclic shift value to two of the three antennas (for example, to antenna ports 1000 and 1002).

In case that three comb offset values and three cyclic shift values are configured for the UE, the UE may use a method in which a comb offset and a cyclic shift are allocated to each antenna port in an SRS resource that may be configured by one antenna port, by using the first comb offset value and the first cyclic shift value, thereby applying the first comb offset value and the first cyclic shift value to one of the three antennas (for example, to antenna port 1000). In addition, the UE may use a method in which a comb offset and a cyclic shift are allocated to each antenna port in an SRS resource that may be configured by one antenna port, by using the second comb offset value and the second cyclic shift value, thereby applying the second comb offset value and the second cyclic shift value to one of the three antennas (for example, to antenna port 1001). In addition, the UE may use a method in which a comb offset and a cyclic shift are allocated to each antenna port in an SRS resource that may be configured by one antenna port, by using the third comb offset value and the third cyclic shift value, thereby applying the third comb offset value and the third cyclic shift value to one of the three antennas (for example, to antenna port 1002).

The base station may notify the UE of a combination of at least one of [Method 1-1] to [Method 1-4] described above through a combination of at least one of higher layer signaling, MAC-CE signaling, and L1 signaling, or the UE may expect that a combination of at least one of [Method 1-1] to [Method 1-4] described above is fixedly defined in specifications. Additionally, a case in which the base station may notify the UE of a combination of one or more specific methods through a combination of at least one of higher layer signaling, MAC-CE signaling, and L1 signaling may mean that the UE cannot support another combination of one or more specific methods. As an example, the UE may expect that [Method 1-1] described above will be fixedly defined in specifications, and the UE may assume that [Method 1-1] described above is used to configure an SRS resource during codebook-based PUSCH transmission through three antenna ports. As another example, the base station may notify the UE of [Method 1-4] described above through a combination of at least one of higher layer signaling, MAC-CE signaling, and L1 signaling, and the UE may consider, in such a case, that the base station has notified that [Method 1-1] described above is not supported.

The UE may report, to the base station, whether or not a combination of at least one of [Method 1-1] to [Method 1-4] described above can be supported, as UE capability. In case that the UE has reported, to the base station, that a combination of one or more specific methods can be supported, as UE capability, it may be considered that the UE has reported that the UE cannot support another combination of one or more specific methods. As an example, the UE may report, to the base station, whether or not [Method 1-1] described above can be supported. As another example, the UE may report, to the base station, that [Method 1-4] described above can be supported, and such a UE capability report may mean that the UE cannot support [Method 1-1].

The UE may define an SRS resource for performing codebook-based PUSCH transmission through three antenna ports in consideration of [Method 1-1] to [Method 1-4] described above, may calculate the transmission power regarding the SRS resource defined as such (in order to perform codebook-based PUSCH transmission through three antenna ports), and may then split the same (calculated transmission power) by the total number of antenna ports (three), thereby determining the transmission power with regard to each antenna port.

As an example, in case that the UE defines an SRS resource for performing codebook-based PUSCH transmission through three antenna ports, based on [Method 1-1] described above, and in case that, although the SRS resource is configured by four antenna ports, transmission regarding one antenna port among the same (for example, the last antenna port (port no. 1003)) is not performed, the UE may calculate the transmission power regarding the SRS resource and may then split the same by 3, thereby determining the transmission power with regard to each antenna port (for example, in case that the last antenna port (port no. 1003) is not used for transmission, with regard to each of the remaining ports nos. 1000, 1001, and 1002 other than port no. 1003 among the four antenna ports).

As another example, in case that the UE transmits one SRS resource configured by one antenna port and one SRS resource configured by two antenna ports, based on [Method 1-2] described above, such that the base station can perform channel estimation regarding the three antenna ports by which the UE has performed SRS resource transmission, the UE may first calculate the total transmission power regarding two SRS resources, although the two SRS resources are configured by one antenna port and two antenna ports, respectively. Thereafter, the UE may allocate one third the total transmission power to the SRS resource configured by one antenna port, may allocate two thirds the total transmission power to the SRS resource configured by two antenna ports, and may allocate half the transmission power allocated to the SRS resource configured by two antenna ports to each antenna port. That is, the UE may allocate the same transmission power to each of the three antenna ports across the two SRS resources.

As another example, in case that the UE transmits an SRS resource configured by three antenna ports, based on [Method 1-3] and [Method 1-4] described above, such that the base station can perform channel estimation regarding the three antenna ports by which the UE has performed SRS resource transmission, the UE may calculate the transmission power regarding the RS resource transmitted by the UE and may then split the same (calculated transmission power) by 3, thereby determining the transmission power with regard to each antenna port.

### Second Embodiment: A Method for Defining an Uplink Codebook for a UE Supporting Three Transmission Antennas

A method for defining an uplink codebook for a UE supporting three transmission antennas according to an embodiment of the disclosure will be described. This embodiment may operate in combination with at least one other embodiment described in the disclosure.

A UE supporting three transmission antennas may report, to a base station, that codebook-based PUSCH transmission using three antenna ports is possible, as UE capability. The UE may report, to a base station, that only non-coherent transmission is possible. For such a codebook-based PUSCH transmission scheme, the base station may indicate a TPMI corresponding to three antenna ports to the UE. The UE may support a non-coherent codebook in case that three transmission antennas are supported. A non-coherent precoding matrix W to be used by the UE to transmit one, two, and three layers by using three antenna ports may be defined as in Tables 46, 47, and 48 below, respectively.

In Table 47 below, the base station may indicate, to the UE, a matrix in which the order of two columns of each of TPMI 0, 1, and 2 is changed. As an example, the base station may indicate, to the UE, a matrix in which two columns of TPMI 0 in Table 47 is changed, such as

$$\frac{1}{\sqrt{6}} [ \begin{matrix}0 & 1 \\ 1 & 0 \\ 0 & 0\end{matrix} ] .$$

In addition to the matrix in which the order of two columns of TPMI 0 is changed, if a matrix in which the order of two columns of TPMI 1 is changed and a matrix in which the order of two columns of TPMI 2 is changed are included, Table 47 below may include six matrices to which TPMI 0 to 5 are allocated.

Likewise, in Table 48 below, the UE may also support matrices in which the order of three columns of TPMI 0 is changed. As an example, the base station may indicate, to the UE, a matrix in which positions of three columns of TPMI 0 in Table 48 below is changed with each other, such as

$$\frac{1}{\sqrt{3}} [ \begin{matrix}0 & 0 & 1 \\ 1 & 0 & 0 \\ 0 & 1 & 0\end{matrix} ] .$$

The total number of cases in which three different columns can be arranged in different orders is 6 (3!=3*2*1=6), and Table 48, which is a codebook for three-port three-layer transmission, may include six matrices to which TPMI 0 to 5 are allocated.

TABLE 46

| TPMI | W | | |
|---|---|---|---|
| index | (TPMI index allocated in ascending order from left to right) | | |
| 0-2 | $\frac{1}{\sqrt{3}} [ \begin{matrix}1 \\ 0 \\ 0\end{matrix} ]$ | $\frac{1}{\sqrt{3}} [ \begin{matrix}0 \\ 1 \\ 0\end{matrix} ]$ | $\frac{1}{\sqrt{3}} [ \begin{matrix}0 \\ 0 \\ 1\end{matrix} ]$ |

TABLE 47

| TPMI | W | | |
|---|---|---|---|
| index | (TPMI index allocated in ascending order from left to right) | | |
| 0-2 | $\frac{1}{\sqrt{3}} [ \begin{matrix}1 & 0 \\ 0 & 1 \\ 0 & 0\end{matrix} ]$ | $\frac{1}{\sqrt{3}} [ \begin{matrix}1 & 0 \\ 0 & 0 \\ 0 & 1\end{matrix} ]$ | $\frac{1}{\sqrt{3}} [ \begin{matrix}0 & 0 \\ 1 & 0 \\ 0 & 1\end{matrix} ]$ |

TABLE 48

| TPMI index | W |
|---|---|
| 0 | $\frac{1}{\sqrt{3}} [ \begin{matrix}1 & 0 & 0 \\ 0 & 1 & 0 \\ 0 & 0 & 1\end{matrix} ]$ |

The UE that supports three transmission antennas may receive DCI format 0_1, 0_2, or 0_3 from the base station, and may include a TPMI field (for example, “precoding information and number of layers” field) in the DCI format. The UE may expect that the TPMI field will be configured as in Tables 49, 50, and 51 below.

As an example, in case that maxRank (higher layer signaling) is configured as 1 for the UE, and a transform precoder has been configured therefor (enabled) or not configured therefor (disabled), the UE may assume that the TPMI field has a two-bit length, and each codepoint of the TPMI field may be defined/configured as in Table 49 below. In Table 49 below, codepoints 0, 1, and 2 may be interpreted as indicating TPMI index 0, 1, and 2 appearing in the second, third, and fourth columns of Table 46 above, respectively (precoding matrix corresponding to TPMI index 0, 1, and 2).

As an example, in case that maxRank (higher layer signaling) is configured as 2 for the UE, and no transform precoder has been configured therefor, the UE may assume that the TPMI field has a three-bit length, and each codepoint of the TPMI field may be defined/configured as in Table 50 below. In Table 50 below, codepoints 0, 1, and 2 may be interpreted as indicating TPMI index 0, 1, and 2 appearing in the second, third, and fourth columns of Table 46 above, respectively (precoding matrix corresponding to TPMI index 0, 1, and 2), and codepoints 3, 4, and 5 may be interpreted as indicating TPMI index 0, 1, and 2 appearing in the second, third, and fourth columns of Table 47 above, respectively (precoding matrix corresponding to TPMI index 0, 1, and 2).

As an example, in case that maxRank (higher layer signaling) is configured as 3 for the UE, and no transform precoder has been configured therefor, the UE may assume that the TPMI field has a three-bit length, and each codepoint of the TPMI field may be defined/configured as in Table 51 below. In Table 51 below, codepoints 0, 1, and 2 may be interpreted as indicating TPMI index 0, 1, and 2 appearing in the second, third, and fourth columns of Table 46 above, respectively (precoding matrix corresponding to TPMI index 0, 1, and 2), codepoints 3, 4, and 5 may be interpreted as indicating TPMI index 0, 1, and 2 appearing in the second, third, and fourth columns of Table 47 above, respectively (precoding matrix corresponding to TPMI index 0, 1, and 2), and codepoint 6 may be interpreted as indicating TPMI index 0 appearing in the second column of Table 48 above (precoding matrix corresponding to TPMI index 0).

In case that the UE supports dynamic switching between DFTS-OFDM and CP-OFDM, and in case that the base station has configured higher layer signaling regarding whether or not a dynamic switching field between DFTS-OFDM and CP-OFDM exists for the UE, the UE may consider that the TPMI field has a two-bit length if maxRank is 1, and may consider that the TPMI field has a three-bit length if maxRank is larger than 1. In case that the UE has received DCI format 0_1, 0_2, or 0_3 in which a dynamic switching field between DFTS-OFDM and CP-OFDM exists, and in case that the UE has received PUSCH scheduling information, based on a DFTS-OFDM waveform, through the dynamic switching field, the UE may interpret that, among eight codepoints that three bits may express, the first three codepoints correspond to codepoints 0, 1, and 2 in Table 49 below, respectively. In case that the UE has received PUSCH scheduling information, based on a CP-OFDM waveform, through the dynamic switching field, and in case that maxRank is 1, the UE may interpret that, among eight codepoints that three bits may express, the first three codepoints correspond to codepoints 0, 1, and 2 in Table 49 below, respectively. In case that maxRank is 2, the UE may interpret that, among eight codepoints that three bits may express, the first six codepoints correspond to codepoints 0 to 5 in Table 50 below, respectively. In case that maxRank is 3, the UE may interpret that, among eight codepoints that three bits may express, the first seven codepoints correspond to codepoints 0 to 7 in Table 51 below, respectively.

TABLE 49
Table 7.3.1.1.2-X: Precoding information and number of layers,
for 3 antenna ports, if transform precoder is enabled or
if transform precoder is disabled and maxRank = 1

| Bit field mapped to index | codebookSubset = nonCoherent |
|---|---|
| 0 | 1 layer: TPMI = 0 |
| 1 | 1 layer: TPMI = 1 |
| 2 | 1 layer: TPMI = 2 |
| 3 | Reserved |

TABLE 50
Table 7.3.1.1.2-X: Precoding information and number of layers, for
3 antenna ports, if transform precoder is disabled and maxRank = 2

| Bit field mapped to index | codebookSubset = nonCoherent |
|---|---|
| 0 | 1 layer: TPMI = 0 |
| 1 | 1 layer: TPMI = 1 |
| 2 | 1 layer: TPMI = 2 |
| 3 | 2 layers: TPMI = 0 |
| 4 | 2 layers: TPMI = 1 |
| 5 | 2 layers: TPMI = 2 |
| 6 | Reserved |
| 7 | Reserved |

TABLE 51
Table 7.3.1.1.2-X: Precoding information and number of layers, for
3 antenna ports, if transform precoder is disabled and maxRank = 3

| Bit field mapped to index | codebookSubset = nonCoherent |
|---|---|
| 0 | 1 layer: TPMI = 0 |
| 1 | 1 layer: TPMI = 1 |
| 2 | 1 layer: TPMI = 2 |
| 3 | 2 layers: TPMI = 0 |
| 4 | 2 layers: TPMI = 1 |
| 5 | 2 layers: TPMI = 2 |
| 6 | 3 layers: TPMI = 0 |
| 7 | Reserved |

In case that the UE has three transmission antennas, the UE has received higher layer signaling related to PUSCH transmission corresponding to three antenna ports from the base station, two SRS resource sets have been configured for the UE, and the usage of the two SRS resource sets has been configured as a codebook or non-codebook, the UE may expect that a second TPMI field (for example, second precoding information field) will exist in DCI format 0_1, 0_2, or 0_3 (the UE may expect that the above-described TPMI field (for example, “precoding information and number of layers” field) will also exist in DCI format 0_1, 0_2, or 0_3 received by the UE). The UE may expect that the number of uplink layers indicated through the TPMI field will be equal to the number of layers of the TPMI indicated through the second TPMI field. As an example, in case that maxRank (higher layer signaling) is configured as 1 for the UE, and a transform precoder has been configured therefor or not configured therefor, the UE may assume that the second TPMI field has a two-bit length, and each codepoint of the second TPMI field may be defined/configured as in Table 49 above.

As an example, in case that maxRank (higher layer signaling) is configured as 2 for the UE, and no transform precoder has been configured therefor, the UE may assume that the second TPMI field has a two-bit length, and each codepoint of the second TPMI field may be defined/configured as in Table 52 below. In case that the number of layers of the TPMI received through the TPMI field is 1, the second, third, and fourth rows in Table 52 below may correspond to codepoints 0, 1, and 2 of the second TPMI field, respectively, and this (codepoints 0, 1, and 2 of the second TPMI field corresponding to the second, third, and fourth rows in Table 52 below, respectively) may be interpreted as indicating TPMI index 0, 1, and 2 appearing in the second, third, and fourth columns of Table 46 above, respectively (precoding matrix corresponding to TPMI index 0, 1, and 2). The UE may know a precoding matrix and a layer value through the TPMI field. Since the UE has already acquired layer information through the TPMI field, information regarding a precoding matrix, excluding layer information, may be solely provided to the UE through the second TPMI field. That is, since the UE can acquire layer information through the TPMI field, the UE may not need to acquire layer information through the second TPMI field. The above description may be equally/similarly applied to the following description. In case that the number of layers of the TPMI acquired through the TPMI field is 2, the fifth, sixth, and seventh rows in Table 52 below may correspond to codepoints 0, 1, and 2 of the second TPMI field, respectively, and this (codepoints 0, 1, and 2 of the second TPMI field corresponding to the fifth, sixth, and seventh rows in Table 52 below, respectively) may be interpreted as indicating TPMI index 0, 1, and 2 appearing in the second, third, and fourth columns of Table 47 above, respectively (precoding matrix corresponding to TPMI index 0, 1, and 2).

As an example, in case that maxRank (higher layer signaling) is configured as 3 for the UE, and no transform precoder has been configured therefor, the UE may assume that the second TPMI field has a two-bit length, and each codepoint of the second TMPI field may be defined/configured as in Table 53 below. In case that the number of layers of the TPMI received by the UE through the TPMI field is 1, the second, third, and fourth rows in Table 53 below may correspond to codepoints 0, 1, and 2 of the second TPMI field, respectively, and this (codepoints 0, 1, and 2 of the second TPMI field corresponding to the second, third, and fourth rows in Table 53 below, respectively) may be interpreted as indicating TPMI index 0, 1, and 2 appearing in the second, third, and fourth columns of Table 46 above, respectively (precoding matrix corresponding to TPMI index 0, 1, and 2). In case that the number of layers of the TPMI received by the UE through the TPMI field is 2, the fifth, sixth, and seventh rows in Table 53 below may correspond to codepoints 0, 1, and 2 of the second TPMI field, respectively, and this (codepoints 0, 1, and 2 of the second TPMI field corresponding to the fifth, sixth, and seventh rows in Table 53 below, respectively) may be interpreted as indicating TPMI index 0, 1, and 2 appearing in the second, third, and fourth columns of Table 47 above, respectively (precoding matrix corresponding to TPMI index 0, 1, and 2). In case that the number of layers of the TPMI received by the UE through the TPMI field is 3, the eighth row in Table 53 below may correspond to codepoint 0 of the second TPMI field, and this (codepoint 0 of the second TPMI field corresponding to the eighth row in Table 53 below) may be interpreted as indicating TPMI index 0 appearing in the second column of Table 48 above (precoding matrix corresponding to TPMI index 0).

TABLE 52
Table 7.3.1.1.2-X: Second precoding information, for 3 antenna
ports, if transform precoder is disabled and maxRank = 2

| Bit field mapped to index | codebookSubset = nonCoherent |
|---|---|
| 0 | 1 layer: TPMI = 0 |
| 1 | 1 layer: TPMI = 1 |
| 2 | 1 layer: TPMI = 2 |
| 3 | 1 layer: reserved |
| 0 | 2 layers: TPMI = 0 |
| 1 | 2 layers: TPMI = 1 |
| 2 | 2 layers: TPMI = 2 |
| 3 | 2 layers: Reserved |

TABLE 53
Table 7.3.1.1.2-X: Second precoding information, for 3 antenna
ports, if transform precoder is disabled and maxRank = 3

| Bit field mapped to index | codebookSubset = nonCoherent |
|---|---|
| 0 | 1 layer: TPMI = 0 |
| 1 | 1 layer: TPMI = 1 |
| 2 | 1 layer: TPMI = 2 |
| 3 | 1 layer: reserved |
| 0 | 2 layers: TPMI = 0 |
| 1 | 2 layers: TPMI = 1 |
| 2 | 2 layers: TPMI = 2 |
| 3 | 1 layer: reserved |
| 0 | 3 layers: TPMI = 0 |
| 1-3 | 3 layers: reserved |

### Third Embodiment: A Method for Supporting a Non-Codebook Usage SRS for a UE Supporting Three Transmission Antennas

In an embodiment of the disclosure, a method for supporting a non-codebook usage SRS for a UE supporting three transmission antennas will be described. This embodiment may operate in combination with at least one other embodiment described in the disclosure.

According to an embodiment of the disclosure, txConfig (higher layer signaling) may be configured as “non-codebook” for a UE supporting three transmission antennas, for the sake of non-codebook-based PUSCH transmission, as described above. In addition, the base station may configure an SRS resource set, the usage (higher layer signaling) of which is configured as “non-codebook”, for the UE supporting three transmission antennas, and a maximum of three SRS resources may be configured for the UE in the configured SRS resource set. Each SRS resource in the SRS resource set may be configured by (may include) one antenna port.

According to an embodiment of the disclosure, the UE may receive an SRI field from the base station, the received SRI field may be configured by

$$⌈ {log}_{2} ( {\sum }_{k = 1}^{min \{ {L}_{max} , {N}_{S R S} \}} ( \begin{matrix}{N}_{SRS} \\ k\end{matrix} ) ) ⌉ bits ,$$

and N_{SRS} may refer to the number of SRS resources configured in the SRS resource set and may be a maximum of three, as described above.

In case that the UE has maxMIMO-Layers configured in PUSCH-ServingCellConfig (higher layer signaling), the Lₘₐₓ may follow a value configured by maxMIMO-Layers. Otherwise, the Lₘₐₓ may follow the maximum number of layers which may be applied during non-codebook usage PUSCH operation reported by the UE.

In addition to 1, 2, and 4 as the maximum number of layers for uplink transmission, the UE may additionally report a combination of at least one of 3, 5, 6, 7, and 8. The UE may report the maximum number of layers which can be supported individually with regard to codebook-based PUSCH transmission and non-codebook-based PUSCH transmission. That is, information regarding the maximum number of layers which can be supported with regard to codebook-based PUSCH transmission and information regarding the maximum number of layers which can be supported with regard to non-codebook-based PUSCH transmission may be reported, respectively.

According to an embodiment of the disclosure, in case that reportQuantity in CSI-ReportConfig (higher layer signaling) is configured as one of cri-RSRP-Index, ssb-Index-RSRP-Index, cri-SINR-Index, and ssb-Index-SINR-Index for the UE, the UE may report capabilityIndex in addition to an L1-RSRP or L1-SINR report. capabilityIndex may refer to the maximum number of SRS antenna ports supported by the UE, and the value of capabilityIndex may be associated with a specific panel of the UE (that is, an association may be configured). Through being associated/association between the value of capabilityIndex reported together with the L1-RSRP or L1-SINR report and a specific panel of the UE, the base station may assume that the L1-RSRP or L1-SINR value reported by the UE has been measured based on a reference signal received by a specific panel of the UE. As an example, in case that a specific panel of the UE supports a maximum of two SRS antenna ports, the UE reports L1-RSRP received through the panel that supports a maximum of two SRS antenna ports, and reportQuantity is configured as cri-RSRP-Index for the UE as described above, the UE may report that the capabilityIndex value is 2.

According to an embodiment of the disclosure, the UE may report UE capability regarding UE capability value reporting to the base station. The UE capability report regarding UE capability value reporting may be related to candidate values that may be used as the value of capabilityIndex indicating the maximum number of SRS antenna ports supported by the UE. That is, in case that {X, Y} has been reported according to UE capability value reporting, and in case that the UE reports capabilityIndex, capabilityIndex may be reported as one value among X or Y. The UE may report, to the base station, a maximum of four values as the UE capability report regarding UE capability value reporting, and each reported value may be selected as different values among {1, 2, 4}. As an example, the UE may report three values to the base station, and the reported value may be 1, 2, and 4, respectively. As another example, the UE may report two values to the base station, and the reported value may be 2 and 4, respectively (or {1 and 2} or {1 and 4}). In addition, the UE capability report regarding UE capability value reporting may be reported with regard to each frequency band. Particularly, the UE may report a maximum of four values to the base station as the UE capability report regarding UE capability value reporting, but in case that each reported value may be selected as different values among {1, 2, 4}, a maximum of three different values may be substantially reported. In this case, the UE capability (capability to report a maximum of four values) may not be used to the maximum.

According to an embodiment of the disclosure, in case that the UE supporting three transmission antennas reports UE capability regarding UE capability value reporting to the base station, the UE may use a method corresponding to a combination of at least one of the embodiments described below:

### Method 3-1

According to an embodiment of the disclosure, when the UE supporting three transmission antennas reports UE capability regarding UE capability value reporting to the base station, a maximum of four values may be reported to the base station, and each reported value may be selected as different values among {1, 2, 3}. As an example, the UE may report three values of 1, 2, and 3 to the base station, and the base station, upon receiving the report of three values including 1, 2, and 3 from the UE, may expect that, during capabilityIndex reporting, the UE will report one of the three values by using two bits. As an example, two-bit codepoint “00” may correspond to 1, codepoint “01” may correspond to 2, codepoint “10” may correspond to 3, and codepoint “11” may be reserved. The value of 3 reported by the UE may mean that the maximum number of SRS ports of the UE is 3. In case that 3 is reported as the maximum number of SRS ports, the UE supporting three transmission antennas may use a method in which one of antenna ports of an SRS resource configured by four SRS resources is not transmitted, as in [Method 1-1] described above, for SRS transmission, or may use an SRS resource configured by one antenna port and an SRS resource configured by two antenna ports together, as in [Method 1-2] described above, or may use an SRS resource configured by three antenna ports, as in [Method 1-3] and [Method 1-4] described above, or may use a method based on a combination of at least one of [Method 1-1] to [Method 1-4] described above.

### Method 3-2

According to an embodiment of the disclosure, when the UE supporting three transmission antennas reports UE capability regarding UE capability value reporting to the base station, a maximum of four values may be reported to the base station, and each reported value may be selected as different values among {1, 2, 4}. As an example, the UE may report three values of 1, 2, and 4 to the base station, and the base station may expect that, during capabilityIndex reporting, the UE will report one of the three values by using two bits. As an example, two-bit codepoint “00” may correspond to 1, codepoint “01” may correspond to 2, codepoint “10” may correspond to 4, and codepoint “11” may be reserved. The value of 4 reported by the UE may mean that the maximum number of SRS ports is 3. That is, even if the UE has reported 4, the base station may consider that the reported value 4 is 3 with regard to the UE supporting three transmission antennas. Such interpretation may be applied to a case in which the UE supporting three transmission antennas, particularly, uses a method in which one of antenna ports of an SRS resource configured by four SRS resources is not transmitted, as in [Method 1-1] described above.

Additionally, when a UE supporting four transmission antennas reports UE capability regarding UE capability value reporting to the base station, a maximum of four values may be reported to the base station, and each reported value may be selected as different values among {1, 2, 3, 4}. As an example, the UE may report four values of 1, 2, 3, and 4 to the base station, and the base station may expect that, during capabilityIndex reporting, the UE will report one of the four values by using two bits. As an example, two-bit codepoint “00” may correspond to 1, codepoint “01” may correspond to 2, codepoint “10” may correspond to 3, and codepoint “11” may correspond to 4. The value of 4 reported by the UE may mean that the maximum number of SRS ports is 4, and the value of 3 reported by the UE may mean that the maximum number of SRS ports is 3.

Additionally, when a UE supporting four transmission antennas reports UE capability regarding UE capability value reporting to the base station, a maximum of four values may be reported to the base station, each reported value may be selected as different values among {1, 2, 4}, and 4 may be reported up to twice. As an example, the UE may report four values of 1, 2, 4, and 4 to the base station, and the base station may expect that, during capabilityIndex reporting, the UE will report one of the four values by using two bits. As an example, two-bit codepoint “00” may correspond to 1, codepoint “01” may correspond to 2, codepoint “10” may correspond to 4, and codepoint “11” may also correspond to 4. In case that the UE has reported a codepoint mapped to 4, the value of 4 mapped to a codepoint having a smaller value (that is, “10”), among the codepoints mapped to 4, may mean that the maximum number of SRS ports is 3, and the value of 4 mapped to a codepoint having a larger value may mean that the maximum number of SRS ports is 4.

Additionally, when a UE supporting four transmission antennas reports UE capability regarding UE capability value reporting to the base station, a maximum of four values may be reported to the base station, and each reported value may be selected as different values among {1, 2, 4}. As an example, the UE may report three values of 1, 2, 4 to the base station, and the base station may expect that, during capabilityIndex reporting, the UE will report one of the three values by using two bits. As an example, two-bit codepoint “00” may correspond to 1, codepoint “01” may correspond to 2, codepoint “10” may correspond to 4, and codepoint “11” may also correspond to 4. The value of 4 reported by the UE may mean that the maximum number of SRS ports is 4. That is, the UE supporting four transmission antennas may not support the value of 3 when reporting UE capability regarding UE capability value reporting, and the description that the UE does not support the value of 3 when reporting UE capability regarding UE capability value reporting may mean that the UE does not perform SRS transmission expressed by three antenna ports.

According to an embodiment of the disclosure, in case that a UE has a maximum of eight transmission antennas, the UE may also report a combination of at least one of 5, 6, 7, and 8 during UE capability value reporting, in addition to 1, 2, 3, and 4 described above. In case that the candidate value is larger than 4, the capabilityindex value reported by the UE may be expressed by three bits.

According to an embodiment of the disclosure, the UE may report a reduced number of MIMO layers preferred by the UE to the base station, in order to solve the heating problem or to reduce the UE's power consumption, through reducedMIMO-LayersFR1-DL, reducedMIMO-LayersFR1-UL, reducedMIMO-LayersFR2-DL, reducedMIMO-LayersFR2-UL, reducedMIMO-LayersFR2-2-DL, or reducedMIMO-LayersFR2-2-UL in UEAssistanceInformation (higher layer signaling) which the UE may transmit. In case that the UE has three transmission antennas, the UE may report one natural number value among 1 to 3 to the base station with regard to reducedMIMO-LayersFR1-UL, reducedMIMO-LayersFR2-UL, or reducedMIMO-LayersFR2-2-UL. In case that a UE has three transmission antennas, the base station may not expect that the UE will report the value of 4 to the base station through reducedMIMO-LayersFR1-UL, reducedMIMO-LayersFR2-UL, or reducedMIMO-LayersFR2-2-UL. In case that a UE has eight transmission antennas, the UE may report one natural number value among 1 to 8 to the base station with regard to reducedMIMO-LayersFR1-UL, reducedMIMO-LayersFR2-UL, or reducedMIMO-LayersFR2-2-UL.

According to an embodiment of the disclosure, the base station may notify the UE of a combination of at least one of [Method 3-1] and [Method 3-2] described above through a combination of at least one of higher layer signaling, MAC-CE signaling, and L1 signaling, or the UE may expect that a combination of at least one of [Method 3-1] and [Method 3-2] described above is fixedly defined in specifications. Additionally, a case in which the base station notifies the UE of a combination of one or more specific methods through a combination of at least one of higher layer signaling, MAC-CE signaling, and L1 signaling may mean that the UE cannot support another combination of one or more specific methods. As an example, the UE may expect that [Method 3-1] described above will be fixedly defined in specifications, and the UE may assume that [Method 3-1] described above is used for UE capability value reporting. As another example, the base station may notify the UE of [Method 3-2] described above through a combination of at least one of higher layer signaling, MAC-CE signaling, and L1 signaling, and the UE may consider, in such a case, that the base station has notified that [Method 3-1] described above is not supported.

According to an embodiment of the disclosure, the UE may report, to the base station, whether or not a combination of at least one of [Method 3-1] and [Method 3-2] described above can be supported, as UE capability. In case that the UE has reported, to the base station, that a combination of one or more specific methods can be supported, as UE capability, it may be considered that the UE has reported that the UE cannot support another combination of one or more specific methods. As an example, the UE may report, to the base station, whether or not [Method 3-1] described above can be supported. As another example, the UE may report, to the base station, that [Method 3-2] described above can be supported, and such a UE capability report may mean that the UE cannot support [Method 3-1].

### Fourth Embodiment: A Method for Supporting an Antenna Switching Usage SRS for a UE Supporting Three Transmission Antennas

In an embodiment of the disclosure, a method for supporting an antenna switching usage SRS for a UE supporting three transmission antennas will be described. This embodiment may operate in combination with at least one other embodiment described in the disclosure.

When configuring an SRS resource set and an SRS resource corresponding to 3T4R, 3T6R, 3T8R, the UE may support the same by using a combination of at least one of the following methods:

### Method 4-1

According to an embodiment of the disclosure, in case that an SRS resource set and an SRS resource corresponding to 3T4R, 3T6R, 3T8R are configured for the UE, an SRS resource configured by three antenna ports may be included in the configuration.

According to an embodiment of the disclosure, for 3T4R, an SRS resource set including a first SRS resource configured by three antenna ports and a second SRS resource configured by one antenna port may be configured/set for the UE. Therefore, three antenna ports of the first SRS resource and one antenna port of the second SRS resource may be connected to different antenna ports of the UE such that antenna switching is performed, and an RF chain (which may be referred to as an RF module, a TX chain, or the like, and may be configured by a low noise amplifier (LNA)/filter/power amplifier (PA) or the like) may be connected to a total of four reception antennas such that an SRS is transmitted.

According to an embodiment of the disclosure, for 3T6R, a first SRS resource and a second SRS resource, each configured by three antenna ports, may be used to configure/set an SRS resource set for the UE. Therefore, three antenna ports of the first SRS resource and three antenna ports of the second SRS resource may be connected to different antenna ports of the UE such that antenna switching is performed, and an RF chain may be connected to a total of six reception antennas such that an SRS is transmitted.

According to an embodiment of the disclosure, for 3T8R, a first SRS resource and a second SRS resource, each configured by three antenna ports, and a third SRS resource configured by two antenna ports may be used to configure/set an SRS resource set for the UE. Therefore, three antenna ports of the first SRS resource, three antenna ports of the second SRS, and two antenna ports of the third SRS resource may be connected to different antenna ports of the UE such that antenna switching is performed, and an RF chain may be connected to a total of eight reception antennas such that an SRS is transmitted.

### Method 4-2

According to an embodiment of the disclosure, in case that an SRS resource set and an SRS resource corresponding to 3T4R, 3T6R, 3T8R are configured for the UE, an SRS resource configured by one antenna port and an SRS resource configured by two antenna ports may be included in the configuration.

According to an embodiment of the disclosure, for 3T4R, an SRS resource set including a first SRS resource and a second SRS resource, each configured by one antenna port, and a third SRS resource configured by two antenna ports may be configured/set for the UE. Therefore, one antenna port of the first SRS resource, one antenna port of the second SRS resource, and two antenna ports of the third SRS resource may be connected to different antenna ports of the UE such that antenna switching is performed, and an RF chain may be connected to a total of four reception antennas such that an SRS is transmitted. One antenna port of the first SRS resource and two antenna ports of the third SRS resource may be transmitted at the same symbol through different comb offsets and cyclic shifts, or one antenna port of the first SRS resource and two antenna ports of the third SRS resource may be transmitted at different symbols.

According to an embodiment of the disclosure, for 3T6R, an SRS resource set including a first SRS resource and a second SRS resource, each configured by one antenna port, and a third SRS resource and a fourth SRS resource, each configured by two antenna ports, may be configured/set for the UE. Therefore, one antenna port of the first SRS resource, one antenna port of the second SRS resource, two antenna ports of the third SRS resource, and two antenna ports of the fourth SRS resource may be connected to different antenna ports of the UE such that antenna switching is performed, and an RF chain may be connected to a total of six reception antennas such that an SRS is transmitted. One antenna port of the first SRS resource and two antenna ports of the third SRS resource may be transmitted at the same symbol through different comb offsets and cyclic shifts, or one antenna port of the first SRS resource and two antenna ports of the third SRS resource may be transmitted at different symbols. In addition, one antenna port of the second SRS resource and two antenna ports of the fourth SRS resource may be transmitted at the same symbol through different comb offsets and cyclic shifts, or one antenna port of the second SRS resource and two antenna ports of the fourth SRS resource may be transmitted at different symbols.

According to an embodiment of the disclosure, for 3T8R, an SRS resource set including a first SRS resource and a second SRS resource, each configured by one antenna port, and a third SRS resource, a fourth SRS resource, and a fifth SRS resource, each configured by two antenna ports, may be configured/set for the UE. Therefore, one antenna port of the first SRS resource, one antenna port of the second SRS resource, two antenna ports of the third SRS resource, two antenna ports of the fourth SRS resource, and two antenna ports of the fifth SRS resource may be connected to different antenna ports of the UE such that antenna switching is performed, and an RF chain may be connected to a total of eight reception antennas such that an SRS is transmitted. One antenna port of the first SRS resource and two antenna ports of the third SRS resource may be transmitted at the same symbol through different comb offsets and cyclic shifts, or one antenna port of the first SRS resource and two antenna ports of the third SRS resource may be transmitted at different symbols. In addition, one antenna port of the second SRS resource and two antenna ports of the fourth SRS resource may be transmitted at the same symbol through different comb offsets and cyclic shifts, or one antenna port of the second SRS resource and two antenna ports of the fourth SRS resource may be transmitted at different symbols.

### Method 4-3

According to an embodiment of the disclosure, in case that an SRS resource set and an SRS resource corresponding to 3T4R, 3T6R, 3T8R are configured for the UE, an SRS resource configured by two antenna ports may be included in the configuration.

According to an embodiment of the disclosure, for 3T4R, an SRS resource set including a first SRS resource and a second SRS resource, each configured by two antenna ports, may be configured/set for the UE. Therefore, two antenna ports of the first SRS resource and two antenna ports of the second SRS resource may be connected to different antenna ports of the UE such that antenna switching is performed, and an RF chain may be connected to a total of four reception antennas such that an SRS is transmitted.

According to an embodiment of the disclosure, for 3T6R, an SRS resource set including a first SRS resource, a second SRS resource, and a third SRS resource, each configured by two antenna ports, may be configured/set for the UE. Therefore, two antenna ports of the first SRS resource, two antenna ports of the second SRS resource, and two antenna ports of the third SRS resource may be connected to different antenna ports of the UE such that antenna switching is performed, and an RF chain may be connected to a total of six reception antennas such that an SRS is transmitted.

According to an embodiment of the disclosure, for 3T8R, an SRS resource set including a first SRS resource, a second SRS resource, a third SRS resource, and a fourth SRS resource, each configured by two antenna ports, may be configured for the UE. Therefore, two antenna ports of the first SRS resource, two antenna ports of the second SRS resource, two antenna ports of the third SRS resource, and two antenna ports of the fourth SRS resource may be connected to different antenna ports of the UE such that antenna switching is performed, and an RF chain may be connected to a total of eight reception antennas such that an SRS is transmitted.

According to an embodiment of the disclosure, the base station may notify the UE of a combination of at least one of [Method 4-1] to [Method 4-3] described above through a combination of at least one of higher layer signaling, MAC-CE signaling, and L1 signaling, or the UE may expect that a combination of at least one of [Method 1-1] to [Method 1-5] described above is fixedly defined in specifications. Additionally, a case in which the base station notifies the UE of a combination of one or more specific methods through a combination of at least one of higher layer signaling, MAC-CE signaling, and L1 signaling may mean that the UE cannot support another combination of one or more specific methods. As an example, the UE may expect that [Method 4-1] described above will be fixedly defined in specifications, and the UE may assume that [Method 4-1] described above is used when configuring an SRS resource set and an SRS resource for supporting 3T4R, 3T6R, 3T8R. As another example, the base station may notify the UE of [Method 4-3] described above through a combination of at least one of higher layer signaling, MAC-CE signaling, and L1 signaling, and the UE may consider, in such a case, that the base station has notified that [Method 4-1] described above is not supported.

According to an embodiment of the disclosure, the UE may report, to the base station, whether or not a combination of at least one of [Method 4-1] to [Method 4-3] described above can be supported, as UE capability. In case that the UE has reported, to the base station, that a combination of one or more specific methods can be supported, as UE capability, it may be considered that the UE has reported that the UE cannot support another combination of one or more specific methods. As an example, the UE may report, to the base station, whether or not [Method 4-1] described above can be supported. As another example, the UE may report, to the base station, that [Method 4-3] described above can be supported, and such a UE capability report may mean that the UE cannot support [Method 1-1].

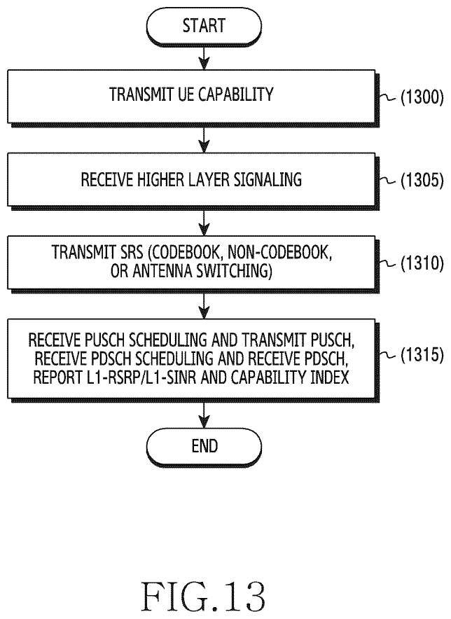

FIG. 13 illustrates operations of a UE according to an embodiment of the disclosure.

In operation 1300, the UE may transmit UE capability to a base station. The UE capability that may be reported may include the uplink transmission function by a UE supporting three transmission antennas, the method for supporting a codebook usage SRS for a UE supporting three transmission antennas, the uplink codebook definition method, the non-codebook usage SRS support method, and the antenna switching usage SRS support method, defined in first to fourth embodiments, and may be related to [Method 1-1] to [Method 1-4], [Method 3-1] and [Method 3-2], [Method 4-1] to [Method 4-3] described above. Operation 1300 may be omitted.

In operation 1305, the UE may receive higher layer signaling from the base station according to the reported UE capability. The UE may define and use higher layer signaling regarding a combination of at least one of higher layer signaling related to [Method 1-1] to [Method 1-4], [Method 3-1] and [Method 3-2], [Method 4-1] to [Method 4-3] described above, including the method for supporting a codebook usage SRS for a UE supporting three transmission antennas, the uplink codebook definition method, the non-codebook usage SRS support method, and the antenna switching usage SRS support method, defined in first to fourth embodiments, from the base station.

In operation 1310, the UE may transmit an SRS to the base station. The UE may transmit an SRS, the usage of which is configured as a codebook, non-codebook, or antenna switching, based on [Method 1-1] to [Method 1-4], [Method 3-1] and [Method 3-2], [Method 4-1] to [Method 4-3] described above, including the method for supporting a codebook usage SRS for a UE supporting three transmission antennas, the uplink codebook definition method, the non-codebook usage SRS support method, and the antenna switching usage SRS support method, defined in first to fourth embodiments, to the base station.

In operation 1315, the UE may receive PUSCH transmission scheduling from the base station and may perform PUSCH transmission, based on the methods mentioned in the first to third embodiments (for example, a combination of at least one of [Method 1-1] to [Method 1-4], [Method 3-1] and [Method 3-2], [Method 4-1] to [Method 4-3] described above). Alternatively, the UE may receive an SRS for antenna switching, may thereby receive PDSCH scheduling information from the base station which has acquired downlink channel information and downlink precoding information, and may receive a PDSCH corresponding thereto. Alternatively, the UE may report L1-RSRP or L1-SINR together with capabilityIndex, based on the methods mentioned in the third embodiment (for example, a combination of at least one of [Method 3-1] and [Method 3-2] described above), based on reference signals received from the base station.

The above-described flowchart illustrates methods that may be implemented according to principles of the disclosure, and the method illustrated in the flowchart of the specification may be variously changed. For example, although illustrated as a series of steps, various steps in respective drawings may overlap, may occur in parallel, may occur in different orders, or may occur multiple times. In another example, steps may be omitted or replaced with other steps.

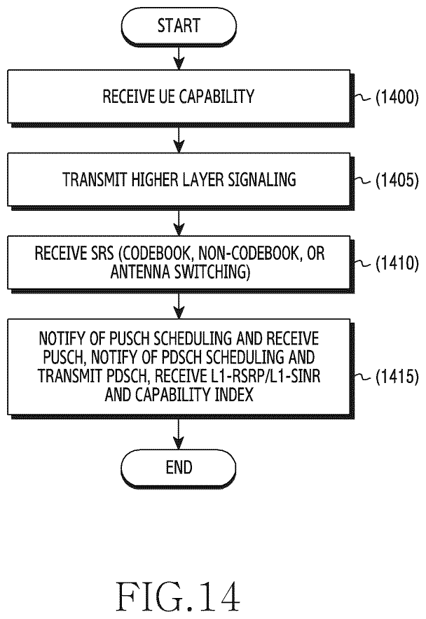

FIG. 14 illustrates operations of a base station according to an embodiment of the disclosure.

In operation 1400, the base station may receive UE capability from a UE. The UE capability that may be reported may include the uplink transmission function by a UE supporting three transmission antennas, the method for supporting a codebook usage SRS for a UE supporting three transmission antennas, the uplink codebook definition method, the non-codebook usage SRS support method, and the antenna switching usage SRS support method, defined in first to fourth embodiments, and may be related to [Method 1-1] to [Method 1-4], [Method 3-1] and [Method 3-2], [Method 4-1] to [Method 4-3] described above. Operation 1400 may be omitted.

In operation 1405, the base station may transmit higher layer signaling to the UE according to the UE capability reported by the UE. The base station may define higher layer signaling regarding a combination of at least one of higher layer signaling related to [Method 1-1] to [Method 1-4], [Method 3-1] and [Method 3-2], [Method 4-1] to [Method 4-3] described above, including the method for supporting a codebook usage SRS for a UE supporting three transmission antennas, the uplink codebook definition method, the non-codebook usage SRS support method, and the antenna switching usage SRS support method, defined in first to fourth embodiments, and may configure the defined higher layer signaling for the UE.

In operation 1410, the base station may receive an SRS from the UE. The base station may receive an SRS from the UE, based on a method, the usage of which is configured for the UE as a codebook, non-codebook, or antenna switching, based on [Method 1-1] to [Method 1-4], [Method 3-1] and [Method 3-2], [Method 4-1] to [Method 4-3] described above, including the method for supporting a codebook usage SRS for a UE supporting three transmission antennas, the uplink codebook definition method, the non-codebook usage SRS support method, and the antenna switching usage SRS support method, defined in first to fourth embodiments.

In operation 1415, the base station may transfer PUSCH transmission scheduling to the UE and may notify the UE so as to perform PUSCH transmission, based on the methods mentioned in the first to third embodiments (for example, a combination of at least one of [Method 1-1] to [Method 1-4], [Method 3-1] and [Method 3-2], [Method 4-1] to [Method 4-3] described above). Alternatively, the base station may receive an SRS for antenna switching, may acquire downlink channel information and downlink precoding information, may transfer PDSCH scheduling information to the UE, and may transmit a PDSCH corresponding thereto. Alternatively, the base station may receive reports of L1-RSRP or L1-SINR together with capabilityIndex from the UE, based on the methods mentioned in the third embodiment (for example, a combination of at least one of [Method 3-1] and [Method 3-2] described above), based on reference signals transmitted to the UE.

The above-described flowchart illustrates methods that may be implemented according to principles of the disclosure, and the method illustrated in the flowchart of the specification may be variously changed. For example, although illustrated as a series of steps, various steps in respective drawings may overlap, may occur in parallel, may occur in different orders, or may occur multiple times. In another example, steps may be omitted or replaced with other steps.

### Fifth Embodiment: A Method for Transmitting an SRS for a UE Supporting Three Transmission Antennas

Hereinafter, a method for supporting an SRS for a UE supporting three transmission antennas according to an embodiment of the disclosure will be described. This embodiment may operate in combination with at least one other embodiment described in the disclosure.

As described above, for codebook-based PUSCH transmission, “codebook” may be configured for the UE with regard to txConfig (higher layer signaling). In addition, the base station may configure an SRS resource set, the usage (higher layer signaling) of which is configured as “codebook”, for the UE, and a maximum of two SRS resources may be configured in the configured SRS resource set for the UE. SRS resources that may be configured for a UE supporting three transmission antennas, in order to transmit a codebook-based PUSCH, may follow a combination of at least one of methods described below:

In case that “codebook” is configured with regard to txConfig (higher layer signaling) for a UE supporting three transmission antennas, in order to transmit a codebook-based PUSCH, and in case that the UE has a maximum of two SRS resources configured in an SRS resource set, the usage of which is “codebook”, the UE may support the following SRS-related transmission schemes according to UE capability. To this end, the UE may have higher layer signaling in Table 54 below configured with regard to each SRS resource.

TABLE 54
SRS-Resource ::= SEQUENCE {
...
combOffsetHopping-r18 SEQUENCE {
hoppingId-r18 INTEGER (0..1023) OPTIONAL, -- Need R
hoppingSubset-r18 CHOICE {
transmissionComb-n4 BIT STRING (SIZE (4)),
transmissionComb-n8 BIT STRING (SIZE (8))
} OPTIONAL, -- Need R
hoppingWithRepetition-r18 ENUMERATED {symbol, repetition}
OPTIONAL -- Need R
} OPTIONAL, -- Need R
cyclicShiftHopping-r18 SEQUENCE {
hoppingId-r18 INTEGER (0..1023) OPTIONAL, -- Need R
hoppingSubset-r18 CHOICE {
transmissionComb-n2 BIT STRING (SIZE (8)),
transmissionComb-n4 BIT STRING (SIZE (12)),
transmissionComb-n8 BIT STRING (SIZE (6))
} OPTIONAL, -- Need R
hoppingFinerGranularity-r18 ENUMERATED {enable} OPTIONAL -- Need R
} OPTIONAL, -- Need R
...
}

### Comb Offset Hopping

In case that the UE has combOffsetHopping (higher layer signaling) configured in a specific SRS resource, the UE may transmit the SRS resource in which combOffsetHopping (higher layer signaling) is configured according to comb offset hopping. In case that the UE supports comb offset hopping, the UE may determine the offset from the comb currently transmitted by the UE to the next comb according to a pseudo random sequence, and the initialization ID regarding such a pseudo random sequence may be configured for the UE through hoppingId in the combOffsetHopping. That is, the hoppingId configured in the combOffsetHopping may be used as the initialization ID regarding the pseudo random sequence.
According to a configuration value from the base station regarding hopping WithRepetition which may be configured in combOffsetHopping (higher layer signaling), the UE may determine whether to perform comb offset hopping with regard to each SRS symbol or to perform the same with regard to each symbol corresponding to the repetitionFactor value. In case that the UE has hopping WithRepetition configured as a symbol, the UE may perform comb offset hopping with regard to each SRS symbol regardless of the repetitionFactor value configured by higher layer signaling. In case that the UE has hopping WithRepetition configured as repetition, the UE may transmit an SRS at the same comb location during an SRS symbol corresponding to the repetitionFactor value configured by higher layer signaling, and may perform comb offset hopping with regard to each repetitionFactor symbol, thereby performing SRS transmission at a comb offset at a location different from the previous one.
The UE may have hoppingSubset configured therefor, which may be configured in combOffsetHopping (higher layer signaling), such that, when performing comb offset hopping, the UE may limit comb offset hopping to be performed in a specific subset (a subset of comb offsets that the UE may hop is defined). The function of limiting comb offset hopping to be performed in a specific subset may be introduced for the purpose of distinguishing a UE capable of supporting comb offset hopping and a UE incapable of supporting the same such that the UE capable of supporting comb offset hopping does not interfere with the UE incapable of supporting comb offset hopping. The UE may have transmissionComb-n4 (a comb the size of which is 4) or transmissionComb-n8 (a comb the size of which is 8) configured therefor, which is bitmap higher layer signaling corresponding to a comb size configured in an SRS resource. In case that the bit value at each bit location in the configured bitmap is 1, the UE may define the comb offset value corresponding to the bit location, the bit value of which is 1, as a subset, thereby performing comb offset hopping in the subset.
The UE may perform comb offset hopping together with group hopping and/or sequence hopping. The UE may be enabled to perform comb offset hopping together with group hopping and/or sequence hopping by both having combOffsetHopping (higher layer signaling) configured in a specific SRS resource and having groupOrSequenceHopping configured therefor. The comb offset hopping and group hopping and/or sequence hopping may operate independently of each other.

### Cyclic Shift Hopping

In case that the UE has cyclicShiftHopping (higher layer signaling) configured in a specific SRS resource, the UE may transmit the SRS resource in which cyclicShiftHopping (higher layer signaling) is configured according to cyclic shift hopping. In case that the UE supports cyclic shift hopping, the UE may determine the offset from the cyclic shift currently transmitted by the UE to the next cyclic shift according to a pseudo random sequence, and the initialization ID regarding such a pseudo random sequence may be configured for the UE through hoppingId in the cyclicShiftHopping. That is, the hoppingId configured in the cyclicShiftHopping may be used as the initialization ID regarding the pseudo random sequence.
The UE may have hoppingSubset configured therefor, which may be configured in cyclicShiftHopping (higher layer signaling), such that, when performing cyclic shift hopping, the UE may limit cyclic shift hopping to be performed in a specific subset (a subset of cyclic shifts that the UE may hop is defined). The function of limiting cyclic shift hopping to be performed in a specific subset may be introduced for the purpose of distinguishing a UE capable of supporting cyclic shift hopping and a UE incapable of supporting the same such that the UE capable of supporting cyclic shift hopping does not interfere with the UE incapable of supporting cyclic shift hopping. The UE may have transmissionComb-n2 (a cyclic shift, the size of which is 8, corresponding to a comb, the size of which is 2), transmissionComb-n4 (a cyclic shift, the size of which is 12, corresponding to a comb, the size of which is 4), or transmissionComb-n8 (a cyclic shift, the size of which is 6, corresponding to a comb, the size of which is 8) configured therefor, which is bitmap higher layer signaling corresponding to a cyclic shift size configured in an SRS resource. In case that the bit value at each bit location in the configured bitmap is 1, the UE may define the cyclic shift value corresponding to the bit location, the bit value of which is 1, as a subset, thereby performing cyclic shift hopping in the subset.
The UE may have hoppingFinerGranularity configured therefor, which may be configured in cyclicShiftHopping (higher layer signaling), such that, when performing cyclic shift hopping, the UE can perform hopping by using a smaller unit of cyclic shift. In case that the UE has hoppingFinerGranularity (higher layer signaling) configured as “enabled”, the UE may use the unit of cyclic shift hopping with double the degree of fineness. As an example, in case that the UE has a comb size configured to be 2 and thus has a corresponding cyclic shift size configured to be 8, the UE may not use a value obtained by equally dividing 2π by 8 as the unit of cyclic shift hopping, but may use a value obtained by equally dividing 2π by 16, which has double the degree of fineness, when performing cyclic shift hopping, in consideration of 16 which is double the cyclic shift size of 8. In case that the UE has hoppingSubset configured therefor, which may be configured in cyclicShiftHopping (higher layer signaling), the UE cannot have hoppingFinerGranularity configured therefor.
The UE may perform cyclic shift hopping together with group hopping and/or sequence hopping. The UE may be enabled to perform cyclic shift hopping together with group hopping and/or sequence hopping by both having cyclicShiftHopping (higher layer signaling) configured in a specific SRS resource and having groupOrSequenceHopping configured therefor. The cyclic shift hopping and group hopping and/or sequence hopping may operate independently of each other.
The UE may have comb offset hopping and cyclic shift hopping configured simultaneously in one SRS resource. In such a case, comb offset hopping and cyclic shift hopping may operate independently of each other.

The above description that the UE can support the above details according to UE capability may mean that the UE may report, to the base station, that the above details are supported by reporting new UE capability. In another method, in case that the UE reports, to the base station, previously defined UE capability, UE capability meaning that three antenna ports are supported, and/or UE capability meaning that codebook-based PUSCH transmission and/or codebook usage SRS transmission are possible, based on three antenna ports, the same may be supported. The previously defined UE capability described above may be a combination of at least one of the following details:

### Feature Group (FG) 40-5-1: SRS Comb Offset Hopping

The UE may report, per band, that comb offset hopping can be supported.

### FG 40-5-2: SRS Cyclic Shift Hopping

The UE may report, per band, that cyclic shift hopping can be supported.

### FG 40-5-2a: Smaller Cyclic Shift Granularity for Cyclic Shift Hopping

The UE may report, per band, that, during cyclic shift hopping, the hopping can be supported at a minute unit.
   FG 40-5-1c: Comb Offset Hopping within a Subset
The UE may report, per band, that comb offset hopping can be supported in a subset.
   FG 40-5-2c: Cyclic Shift Hopping within a Subset
The UE may report, per band, that cyclic shift hopping can be supported in a subset.
   FG 40-5-1b: SRS Comb Offset Hopping Combined with Legacy Group/Sequence Hopping
The UE may report, per band, that comb offset hopping and sequence and/or group hopping can be supported together.
   FG 40-5-2b: SRS Cyclic Shift Hopping Combined with Legacy Group/Sequence Hopping
The UE may report, per band, that cyclic shift hopping and sequence and/or group hopping can be supported together.
   FG 40-5-3: SRS Cyclic Shift Hopping Combined with SRS Comb Offset Hopping
The UE may report, per band, that comb offset hopping and cyclic shift hopping can be supported together.
   FG 40-5-1a: Comb Offset Hopping Time-Domain Behavior when Repetition Factor R>1

In case that repetitionFactor is configured to be larger than 1, the UE may report, per band, the scheme in which comb offset hopping can be supported. The UE may select one from “per SRS symbol”, “per R SRS symbols”, and “both” as the corresponding UE capability reporting value. For example, a case in which the UE reports “per SRS symbol”, and in which the repetitionFactor value is configured to be larger than 1 may mean that the UE can perform comb offset hopping with regard to each SRS symbol. A case in which the UE reports “per R SRS symbol”, and in which the repetitionFactor value is configured to be larger than R>1 may mean that the UE can perform comb offset hopping with regard to every R SRS symbols. A case in which the UE reports “both” may mean that the UE can support both operations above.

In an embodiment of the disclosure, the UE may define various detailed methods in [Method 1-1] described above as follows:

As a detailed method in [Method 1-1] described above, [detailed method 1] may be defined such that the UE determines not to perform transmission in the last antenna port (for example, antenna port 1003) among four antenna ports which constitutes (is included in) an SRS resource.

As another detailed method in [Method 1-1] described above, [detailed method 2] may be defined such that the UE determines not to perform transmission in the first antenna port (for example, antenna port 1000) among four antenna ports which constitutes (is included in) an SRS resource.

As another detailed method in [Method 1-1] described above, [detailed method 3] may be defined such that the UE determines not to perform transmission in any antenna port that may be defined by specifications (for example, antenna port 1002 or any among antenna ports 1000 to 1003) among four antenna ports which constitutes (is included in) an SRS resource.

As another detailed method in [Method 1-1] described above, [detailed method 4] may be defined such that the UE determines not to perform transmission in an antenna port determined according a notification from the base station (a combination of a least one of higher layer signaling, MAC-CE signaling, and L1 signaling) among four antenna ports which constitutes (is included in) an SRS resource (for example, the base station may determine that antenna port 1002 is not to be transmitted through higher layer signaling).

The UE may report a combination of at least one of [detailed method 1] to [detailed method 4] described above, as UE capability (through UE capability). Such UE capability may be reported in one type among per feature set per component carrier (FSPC), per feature set (FS), per band, per cell, per UE, and per band combination.
As an example, the UE may report that [detailed method 1] can be supported, as UE capability. UE capability indicating that [detailed method 1] can be supported may be reported implicitly through basic UE capability of a UE supporting three transmission antennas (for example, corresponding UE capability may include methods supporting codebook-based PUSCH transmission, methods supporting only three antenna ports, based on an SRS resource configured by four antenna ports), or may be reported explicitly as individual UE capability. In case that individual UE capability is not reported, the base station may understand that the UE supports [detailed method 1] described above.
As another example, the UE may report that a combination of at least one of [detailed method 1] and [detailed method 4] can be supported, as UE capability. UE capability indicating that a combination of at least one of [detailed method 1] and [detailed method 4] can be supported may report one of the following three: “[detailed method 1] supported”, “[detailed method 4] supported”, and “[detailed method 1] and [detailed method 4] both supported”, or may report one of the following two: “[detailed method 1] supported” and “[detailed method 1] and [detailed method 4] both supported”, or may report one of the following two: “[detailed method 4] supported” and “[detailed method 1] and [detailed method 4] both supported”, through basic UE capability of a UE supporting three transmission antennas (for example, corresponding UE capability may include methods supporting codebook-based PUSCH transmission, methods supporting only three antenna ports, based on an SRS resource configured by four antenna ports). In addition, The UE may report individual UE capability regarding each of [detailed method 1] and [detailed method 4]. In case that individual UE capability is not reported all, the base station may understand that the UE supports [detailed method 1] described above. In addition, the UE may report that [detailed method 1] is supported through the basic UE capability, and may report that [detailed method 4] is supported, as additional UE capability.

The UE may be notified of a combination of at least one of [detailed method 1] to [detailed method 4] by the base station through combination of a least one of higher layer signaling, MAC-CE signaling, and L1 signaling, or may expect that a support will be provided through a method fixed in specifications.
As an example, with regard to the method in which transmission is not performed with regard to one of four antenna ports constituting an SRS resource, the UE may expect that [detailed method 1] described above will be defined fixedly in specifications.
As another example, with regard to the method in which transmission is not performed with regard to one of four antenna ports constituting an SRS resource, the UE may expect that [detailed method 4] described above will be defined fixedly in specifications. Therefore, the UE may not perform SRS transmission with regard to a specific antenna port indicated by a specific higher layer signaling configuration, and the UE may perform transmission regarding only three SRS ports with regard to the SRS resource having four ports. Higher layer signaling for indicating the antenna port regarding which SRS transmission is not performed may be configured individually with regard to each SRS resource, or may be configured in an SRS resource set to make restrictions such that not all SRS resources in the SRS resource set are transmitted in the same antenna port. In case that specific higher layer signaling for indicating the antenna port regarding which SRS transmission is not performed is not configured for the UE, the UE may support one of [detailed method 1], [detailed method 2], and [detailed method 3] described above.

In addition, in case that the UE has reported specific UE capability to the base station, the UE may be notified of a combination of at least one of [detailed method 1] to [detailed method 4] by the base station through combination of a least one of higher layer signaling, MAC-CE signaling, and L1 signaling, or may define the same fixedly in specifications and operate accordingly. Otherwise (in case that the UE has reported no specific UE capability to the base station), the UE may be notified of a combination of at least one of [detailed method 1] to [detailed method 4] by the base station through combination of a least one of higher layer signaling, MAC-CE signaling, and L1 signaling, or may define the same fixedly in specifications and operate accordingly.
As an example, in case that the UE has reported UE capability supporting at least one of comb offset hopping and/or cyclic shift hopping to the base station, and in case that the base station makes a specific higher layer signaling configuration, the UE may perform SRS transmission according to [detailed method 4]. Otherwise, the UE may perform SRS transmission according to [detailed method 1].
As another example, in case that the UE has reported UE capability supporting at least one of comb offset hopping and/or cyclic shift hopping to the base station, and in case that the base station makes a specific higher layer signaling configuration, the UE may perform SRS transmission according to [detailed method 1]. Otherwise, the UE may perform SRS transmission according to [detailed method 4].
As another example, in case that the UE has reported UE capability supporting at least one of comb offset hopping and/or cyclic shift hopping to the base station, the UE may perform SRS transmission according to [detailed method 1] without a specific higher layer signaling configuration from the base station. In case that the UE has reported no UE capability regarding the comb offset hopping and/or cyclic shift hopping, the UE may perform SRS transmission according to [detailed method 4] without a specific higher layer signaling configuration from the base station.
As another example, in case that the UE has reported UE capability supporting at least one of comb offset hopping and/or cyclic shift hopping to the base station, the UE may perform SRS transmission according to [detailed method 4] without a specific higher layer signaling configuration from the base station. In case that the UE has reported no UE capability regarding the comb offset hopping and/or cyclic shift hopping, the UE may perform SRS transmission according to [detailed method 1] without a specific higher layer signaling configuration from the base station.
The above-described UE capability regarding comb offset hopping and/or cyclic shift hopping may be a combination of at least one of existing UE capability or new UE capability, which may express functions denoted by FG 40-5-1, FG 40-5-2, FG 40-5-2a, FG 40-5-1c, FG 40-5-2c, FG 40-5-1b, FG 40-5-2b, FG 40-5-3, FG 40-5-1a described above.

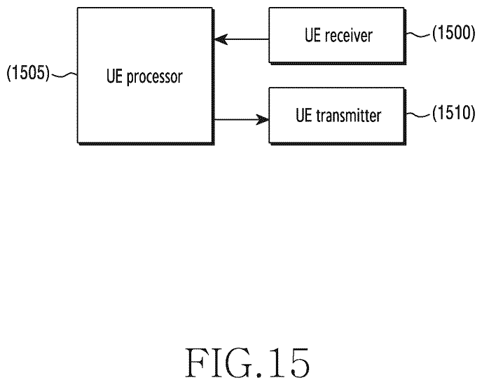

FIG. 15 illustrates a structure of a UE in a wireless communication system according to an embodiment of the disclosure.

Referring to FIG. 15, the UE may include a transceiver, which refers to a UE receiver 1500 and a UE transmitter 1510 as a whole, a memory (not illustrated), and a UE processor 1505 (or UE controller or processor). The UE transceiver 1500 and 1510, the memory, and the UE processor 1505 may operate according to the above-described communication methods of the UE. Components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

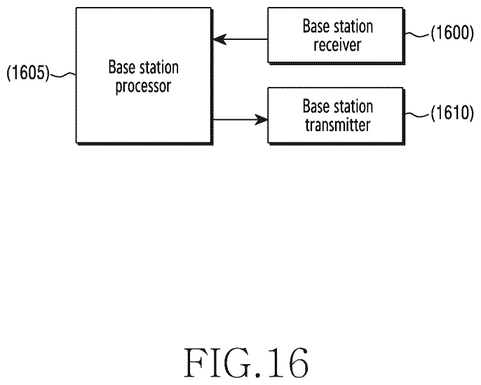

FIG. 16 illustrates a structure of a base station in a wireless communication system according to an embodiment of the disclosure.

Referring to FIG. 16, the base station may include a transceiver, which refers to a base station receiver 1600 and a base station transmitter 1610 as a whole, a memory (not illustrated), and a base station processor 1605 (or base station controller or processor). The base station transceiver 1600 and 1610, the memory, and the base station processor 1605 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a read only memory (ROM), a random access memory (RAM), a hard disk, a compact disc (CD)-ROM, and a digital versatile disc (DVD), or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, configuration information related to sounding reference signal (SRS) transmission related to codebook-based uplink transmission, the configuration information comprising an SRS resource set comprising an SRS resource configured by four ports; and
transmitting, to the base station, an SRS by using three ports on the SRS resource,
wherein transmission of the SRS is not performed with regard to a port having the largest port index among the four ports configuring the SRS resource.

2. The method of claim 1,
wherein transmission power of the SRS is evenly divided with regard to remaining three ports other than one port regarding which transmission of the SRS is not performed, and
wherein the SRS resource set comprises a maximum of two SRS resources.

3. The method of claim 1,
wherein a rank 1 codebook for the codebook-based uplink transmission is configured based on the following table,
TABLE

| TPMI | W | | |
|---|---|---|---|
| index | (TPMI index allocated in ascending order from left to right) | | |
| 0-2 | $\frac{1}{\sqrt{3}} [ \begin{matrix}1 \\ 0 \\ 0\end{matrix} ]$ | $\frac{1}{\sqrt{3}} [ \begin{matrix}0 \\ 1 \\ 0\end{matrix} ]$ | $\frac{1}{\sqrt{3}} [ \begin{matrix}0 \\ 0 \\ 1\end{matrix} ]$ |

wherein a rank 2 codebook for the codebook-based uplink transmission is configured based on the following table,
TABLE

| TPMI | W | | |
|---|---|---|---|
| index | (TPMI index allocated in ascending order from left to right) | | |
| 0-2 | $\frac{1}{\sqrt{3}} [ \begin{matrix}1 & 0 \\ 0 & 1 \\ 0 & 0\end{matrix} ]$ | $\frac{1}{\sqrt{3}} [ \begin{matrix}1 & 0 \\ 0 & 0 \\ 0 & 1\end{matrix} ]$ | $\frac{1}{\sqrt{3}} [ \begin{matrix}0 & 0 \\ 1 & 0 \\ 0 & 1\end{matrix} ]$ |

and
wherein a rank 3 codebook for the codebook-based uplink transmission is configured based on the following table,
TABLE

| TPMI index | W |
|---|---|
| 0 | $\frac{1}{\sqrt{3}} [ \begin{matrix}1 & 0 & 0 \\ 0 & 1 & 0 \\ 0 & 0 & 1\end{matrix} ] .$ |

4. The method of claim 3,
wherein the SRS resource set comprises a first SRS resource set and a second SRS resource set,
wherein the method comprises:
receiving, from the base station, information regarding the maximum transmission rank of the terminal, and
receiving, from the base station, downlink control information comprising a first transmission precoding matrix indicator (TPMI) field associated with the first SRS resource set and a second TPMI field associated with the second SRS resource set,
wherein the first TPMI field has a bit field configured to be mapped to a TPMI index of a precoding matrix included in a codebook corresponding to a transmission rank equal to/less than the maximum transmission rank value configured based on information regarding the maximum transmission rank of the terminal,
wherein the second TPMI field has a bit field having a size configured such that codepoints of the bit field of the second TPMI field can be mapped to all TPMI indices of a codebook including the most precoding matrices among the rank 1 codebook, the rank 2 codebook, and the rank 3 codebook, and
wherein a TPMI index mapped to a codepoint of the second TPMI field has a transmission rank configured to be identical to a transmission rank of a TPMI index indicated by the first TPMI field.

5. A method performed by a base station in a wireless communication system, the method comprising:
transmitting, to a terminal, configuration information related to sounding reference signal (SRS) transmission related to codebook-based uplink transmission, the configuration information comprising an SRS resource set comprising an SRS resource configured by four ports; and
receiving, from the terminal, an SRS by using three ports on the SRS resource,
wherein reception of the SRS is not performed with regard to a port having the largest port index among the four ports configuring the SRS resource.

6. The method of claim 5,
wherein transmission power of the SRS is evenly divided with regard to remaining three ports other than one port regarding which transmission of the SRS is not performed, and
wherein the SRS resource set comprises a maximum of two SRS resources.

7. The method of claim 5,
wherein a rank 1 codebook for the codebook-based uplink transmission is configured based on the following table,
TABLE

| TPMI | W | | |
|---|---|---|---|
| index | (TPMI index allocated in ascending order from left to right) | | |
| 0-2 | $\frac{1}{\sqrt{3}} [ \begin{matrix}1 \\ 0 \\ 0\end{matrix} ]$ | $\frac{1}{\sqrt{3}} [ \begin{matrix}0 \\ 1 \\ 0\end{matrix} ]$ | $\frac{1}{\sqrt{3}} [ \begin{matrix}0 \\ 0 \\ 1\end{matrix} ]$ |

wherein a rank 2 codebook for the codebook-based uplink transmission is configured based on the following table,
TABLE

| TPMI | W | | |
|---|---|---|---|
| index | (TPMI index allocated in ascending order from left to right) | | |
| 0-2 | $\frac{1}{\sqrt{3}} [ \begin{matrix}1 & 0 \\ 0 & 1 \\ 0 & 0\end{matrix} ]$ | $\frac{1}{\sqrt{3}} [ \begin{matrix}1 & 0 \\ 0 & 0 \\ 0 & 1\end{matrix} ]$ | $\frac{1}{\sqrt{3}} [ \begin{matrix}0 & 0 \\ 1 & 0 \\ 0 & 1\end{matrix} ]$ |

and
wherein a rank 3 codebook for the codebook-based uplink transmission is configured based on the following table,
TABLE

| TPMI index | W |
|---|---|
| 0 | $\frac{1}{\sqrt{3}} [ \begin{matrix}1 & 0 & 0 \\ 0 & 1 & 0 \\ 0 & 0 & 1\end{matrix} ] .$ |

8. The method of claim 7,
wherein the SRS resource set comprises a first SRS resource set and a second SRS resource set,
wherein the method comprises:
receiving, from the base station, information regarding the maximum transmission rank of the terminal, and
receiving, from the base station, downlink control information comprising a first transmission precoding matrix indicator (TPMI) field associated with the first SRS resource set and a second TPMI field associated with the second SRS resource set,
wherein the first TPMI field has a bit field configured to be mapped to a TPMI index of a precoding matrix included in a codebook corresponding to a transmission rank equal to/less than the maximum transmission rank value configured based on information regarding the maximum transmission rank of the terminal,
wherein the second TPMI field has a bit field having a size configured such that codepoints of the bit field of the second TPMI field can be mapped to all TPMI indices of a codebook including the most precoding matrices among the rank 1 codebook, the rank 2 codebook, and the rank 3 codebook, and
wherein a TPMI index mapped to a codepoint of the second TPMI field has a transmission rank configured to be identical to a transmission rank of a TPMI index indicated by the first TPMI field.

9. A terminal in a wireless communication system, the terminal comprising:
a transceiver; and
a controller connected to the transceiver,
wherein the controller is configured to:
receive, from a base station, configuration information related to sounding reference signal (SRS) transmission related to codebook-based uplink transmission, the configuration information comprising an SRS resource set comprising an SRS resource configured by four ports, and
transmit, to the base station, an SRS by using three ports on the SRS resource,
wherein transmission of the SRS is not performed with regard to a port having the largest port index among the four ports configuring the SRS resource.

10. The terminal of claim 9,
wherein transmission power of the SRS is evenly divided with regard to remaining three ports other than one port regarding which transmission of the SRS is not performed, and
wherein the SRS resource set comprises a maximum of two SRS resources.

11. The terminal of claim 9,
wherein a rank 1 codebook for the codebook-based uplink transmission is configured based on the following table,
TABLE

| TPMI | W | | |
|---|---|---|---|
| index | (TPMI index allocated in ascending order from left to right) | | |
| 0-2 | $\frac{1}{\sqrt{3}} [ \begin{matrix}1 \\ 0 \\ 0\end{matrix} ]$ | $\frac{1}{\sqrt{3}} [ \begin{matrix}0 \\ 1 \\ 0\end{matrix} ]$ | $\frac{1}{\sqrt{3}} [ \begin{matrix}0 \\ 0 \\ 1\end{matrix} ]$ |

wherein a rank 2 codebook for the codebook-based uplink transmission is configured based on the following table,
TABLE

| TPMI | W | | |
|---|---|---|---|
| index | (TPMI index allocated in ascending order from left to right) | | |
| 0-2 | $\frac{1}{\sqrt{3}} [ \begin{matrix}1 & 0 \\ 0 & 1 \\ 0 & 0\end{matrix} ]$ | $\frac{1}{\sqrt{3}} [ \begin{matrix}1 & 0 \\ 0 & 0 \\ 0 & 1\end{matrix} ]$ | $\frac{1}{\sqrt{3}} [ \begin{matrix}0 & 0 \\ 1 & 0 \\ 0 & 1\end{matrix} ]$ |

and
wherein a rank 3 codebook for the codebook-based uplink transmission is configured based on the following table,
TABLE

| TPMI index | W |
|---|---|
| 0 | $\frac{1}{\sqrt{3}} [ \begin{matrix}1 & 0 & 0 \\ 0 & 1 & 0 \\ 0 & 0 & 1\end{matrix} ] .$ |

12. The terminal of claim 11,
wherein the SRS resource set comprises a first SRS resource set and a second SRS resource set,
wherein the controller is further configured to:
receive, from the base station, information regarding the maximum transmission rank of the terminal, and
receive, from the base station, downlink control information comprising a first transmission precoding matrix indicator (TPMI) field associated with the first SRS resource set and a second TPMI field associated with the second SRS resource set,
wherein the first TPMI field has a bit field configured to be mapped to a TPMI index of a precoding matrix included in a codebook corresponding to a transmission rank equal to/less than the maximum transmission rank value configured based on information regarding the maximum transmission rank of the terminal,
wherein the second TPMI field has a bit field having a size configured such that codepoints of the bit field of the second TPMI field can be mapped to all TPMI indices of a codebook including the most precoding matrices among the rank 1 codebook, the rank 2 codebook, and the rank 3 codebook, and
wherein a TPMI index mapped to a codepoint of the second TPMI field has a transmission rank configured to be identical to a transmission rank of a TPMI index indicated by the first TPMI field.

13. A base station in a wireless communication system, the base station comprising:
a transceiver; and
a controller connected to the transceiver,
wherein the controller is configured to:
transmit, to a terminal, configuration information related to sounding reference signal (SRS) transmission related to codebook-based uplink transmission, the configuration information comprising an SRS resource set comprising an SRS resource configured by four ports, and
receive, from the terminal, an SRS by using three ports on the SRS resource,
wherein reception of the SRS is not performed with regard to a port having the largest port index among the four ports configuring the SRS resource.

14. The base station of claim 13,
wherein transmission power of the SRS is evenly divided with regard to remaining three ports other than one port regarding which transmission of the SRS is not performed, and
wherein the SRS resource set comprises a maximum of two SRS resources.

15. The base station of claim 13,
wherein a rank 1 codebook for the codebook-based uplink transmission is configured based on the following table,
TABLE

| TPMI | W | | |
|---|---|---|---|
| index | (TPMI index allocated in ascending order from left to right) | | |
| 0-2 | $\frac{1}{\sqrt{3}} [ \begin{matrix}1 \\ 0 \\ 0\end{matrix} ]$ | $\frac{1}{\sqrt{3}} [ \begin{matrix}0 \\ 1 \\ 0\end{matrix} ]$ | $\frac{1}{\sqrt{3}} [ \begin{matrix}0 \\ 0 \\ 1\end{matrix} ]$ |

wherein a rank 2 codebook for the codebook-based uplink transmission is configured based on the following table,
TABLE

| TPMI | W | | |
|---|---|---|---|
| index | (TPMI index allocated in ascending order from left to right) | | |
| 0-2 | $\frac{1}{\sqrt{3}} [ \begin{matrix}1 & 0 \\ 0 & 1 \\ 0 & 0\end{matrix} ]$ | $\frac{1}{\sqrt{3}} [ \begin{matrix}1 & 0 \\ 0 & 0 \\ 0 & 1\end{matrix} ]$ | $\frac{1}{\sqrt{3}} [ \begin{matrix}0 & 0 \\ 1 & 0 \\ 0 & 1\end{matrix} ]$ |

and
wherein a rank 3 codebook for the codebook-based uplink transmission is configured based on the following table,
TABLE

| TPMI index | W |
|---|---|
| 0 | $\frac{1}{\sqrt{3}} [ \begin{matrix}1 & 0 & 0 \\ 0 & 1 & 0 \\ 0 & 0 & 1\end{matrix} ] .$ |

16. The base station of claim 15,
wherein the SRS resource set comprises a first SRS resource set and a second SRS resource set,
wherein the controller is further configured to:
transmit, to the terminal, information regarding the maximum transmission rank of the terminal, and
transmit, to the terminal, downlink control information comprising a first transmission precoding matrix indicator (TPMI) field associated with the first SRS resource set and a second TPMI field associated with the second SRS resource set,
wherein the first TPMI field has a bit field configured to be mapped to a TPMI index of a precoding matrix included in a codebook corresponding to a transmission rank equal to/less than the maximum transmission rank value configured based on information regarding the maximum transmission rank of the terminal,
wherein the second TPMI field has a bit field having a size configured such that codepoints of the bit field of the second TPMI field can be mapped to all TPMI indices of a codebook including the most precoding matrices among the rank 1 codebook, the rank 2 codebook, and the rank 3 codebook, and
wherein a TPMI index mapped to a codepoint of the second TPMI field has a transmission rank configured to be identical to a transmission rank of a TPMI index indicated by the first TPMI field.
